(19) United States
(12) Patent Application Publication
(10) Pub. No.: US 2026/0321502 A1
(43) Pub. Date: Oct. 15, 2026

(54) ELECTRONIC COMPONENT

(71) Applicant: TDK CORPORATION, Tokyo (JP)

(72) Inventors: Yuichi NAGAI, Tokyo (JP); Ken MORITA, Tokyo (JP); Kazuhiro KUSAKA, Tokyo (JP); Yasuhiro OKUI, Tokyo (JP)

(73) Assignee: TDK CORPORATION, Tokyo (JP)

(21) Appl. No.: 19/351,434

(22) Filed: Oct. 7, 2025

(30) Foreign Application Priority Data
Oct. 17, 2024 (JP) 2024-182188

(51) Int. Cl. H01G 4/232; H01G 2/06; H01G 4/248; H01G 4/30

(52) U.S. Cl. CPC H01G 4/2325; H01G 2/06; H01G 4/248; H01G 4/30

(57) ABSTRACT

Each of a pair of external electrodes includes a second electrode layer in which migration is relatively prone to occur. Each of a pair of external conductors includes a conductor layer in which migration is less prone to occur than in the second electrode layer. An internal electrode is connected to the other external electrode. One external conductor of the pair of external conductors is located between one external electrode and the other external conductor of the pair of external conductors and is electrically connected one external electrode. The other external conductor is located between the other external electrode and one external conductor and is electrically connected to the other external electrode. An internal conductor is disposed between a main surface and an internal electrode closest to the main surface, and is electrically connected to one external electrode and one external conductor.

### CROSS-REFERENCE TO RELATED APPLICATIONS

This application is based upon and claims the benefit of priority from Japanese Patent Application No. 2024-182188, filed on Oct. 17, 2024, the entire contents of which are incorporated herein by reference.

### BACKGROUND

### Field

The present disclosure relates to an electronic component.

### Description of the Related Art

Known electronic components include an element body, a plurality of internal electrodes disposed in the element body, and a plurality of external electrodes disposed on the element body (see, for example, Japanese Unexamined Patent Publication No. H5-144666). Each of the plurality of internal electrodes is connected to a corresponding external electrode of the plurality of external electrodes. Each of the plurality of external electrodes includes an electrode layer.

### SUMMARY

The electrode layer includes, for example, a plurality of metal particles and a resin. In a configuration in which the electrode layer includes the plurality of metal particles and the resin, migration may occur in the external electrode. Migration is considered to occur, for example, due to the following events.

An electric field acts on the electrode layer, and metal included in the electrode layer is ionized. Generated metal ion is attracted by an electric field between the external electrodes and migrates from the electrode layer. The electric field acting on the metal includes, for example, an electric field generated between the external electrodes or an electric field generated between the external electrode and an internal electrode in the element body. The metal ions migrating from the electrode layer react with, for example, an electron supplied from the internal electrode or the external electrode, and is deposited as metal on a surface of the element body.

An object of one aspect of the present disclosure is to provide an electronic component controlling proceeding of migration.

An electronic component according to one aspect of the present disclosure includes an element body, a first external electrode and a second external electrode, a first external conductor and a second external conductor, a plurality of internal electrodes, and a first internal conductor and a second internal conductor. The element body includes a first end surface and a second end surface that oppose each other, and a first side surface and a second side surface that couple the first end surface and the second end surface and are adjacent to each other. Each of the first external electrode and the second external electrode includes an electrode layer in which migration is relatively prone to occur. The first external electrode is disposed on the first end surface, the first side surface, and the second side surface. The second external electrode is disposed on the second end surface, the first side surface, and the second side surface. The first external conductor and the second external conductor are separated from each other on the first side surface in a direction in which the first end surface and the second end surface oppose each other and are separated from the first external electrode and the second external electrode. Each of the first external conductor and the second external conductor includes a conductor layer in which migration is less prone to occur than in the electrode layer. The plurality of internal electrodes are disposed in the element body to oppose each other in a direction orthogonal to the second side surface. Each of the plurality of internal electrodes includes an end exposed to a corresponding end surface of the first end surface and the second end surface and is connected to a corresponding external electrode of the first external electrode and the second external electrode at the end included in each of the plurality of internal electrodes. The first internal conductor and the second internal conductor are disposed in the element body between the second side surface and an internal electrode that is closest to the second side surface among the plurality of internal electrodes, and are separated from each other in a direction in which the first end surface and the second end surface oppose each other. The first external conductor is located between the first external electrode and the second external conductor and is electrically connected to the first external electrode. The second external conductor is located between the second external electrode and the first external conductor and is electrically connected to the second external electrode. The first internal conductor is located closer to the first end surface than the second internal conductor and is electrically connected to the first external electrode and the first external conductor. The second internal conductor is located closer to the second end surface than the first internal conductor and is electrically connected to the second external electrode and the second external conductor.

When an electric field acts on the electrode layer, the electric field acts not only on the electrode layer but also on a conductor layer electrically connected to the electrode layer. The electric field tends not to be concentrated on the electrode layer, and the conductor layer reduces the electric field acting on the electrode layer. Therefore, even when the electric field acts on the electrode layer, metal included in the electrode layer tends not to be ionized. Migration tends not to occur in the electrode layer.

Migration is less prone to occur in the conductor layer than in the electrode layer. Therefore, even when the electric field acts on the conductor layer, migration tends not to occur in the conductor layer.

In the one aspect, the first external conductor is located between the first external electrode and the second external conductor on the first side surface. The conductor layer included in the first external conductor and the electrode layer included in the first external electrode are electrically connected to each other. Therefore, even when migration occurs in the electrode layer of the first external electrode located on the first side surface, the first external conductor prevents the proceeding of migration. In the one aspect, the second external conductor is located between the second external electrode and the first external conductor on the first side surface. The conductor layer included in the second external conductor and the electrode layer included in the second external electrode are electrically connected to each other. Therefore, even when migration occurs in the electrode layer of the second external electrode located on the first side surface, the second external conductor prevents the proceeding of migration.

In the one aspect, the first internal conductor electrically connected to the first external electrode and the first external conductor is disposed between the second side surface and an internal electrode closest to the second side surface. Therefore, even in a configuration in which the internal electrode closest to the second side surface is electrically connected to the first external electrode, the internal electrode and the electrode layer of the second external electrode located on the second side surface are not electrically connected to each other, but tend not to oppose each other in the direction orthogonal to the second side surface. In the one aspect, the second internal conductor electrically connected to the second external electrode and the second external conductor is disposed between the second side surface and an internal electrode closest to the second side surface. Therefore, even in a configuration in which the internal electrode closest to the second side surface is electrically connected to the second external electrode, the internal electrode and the electrode layer of the first external electrode located on the second side surface are not electrically connected to each other, but tend not to oppose each other in the direction orthogonal to the second side surface. For the above reasons, the first internal conductor and the second internal conductor prevent generation of the electric field between the electrode layer and the internal electrode closest to the second side surface that are not electrically connected to each other.

As a result, the one aspect controls the proceeding of migration.

In the one aspect, an internal electrode that is connected to the first external electrode among the plurality of internal electrodes may include an end that is exposed to the first side surface and connected to the first external conductor. An internal electrode that is connected to the second external electrode among the plurality of internal electrodes may include an end that is exposed to the first side surface and connected to the second external conductor. The first internal conductor may include an end that is exposed to the first end surface and connected to the first external electrode. The second internal conductor may include an end that is exposed to the second end surface and connected to the second external electrode.

In the configuration in which the first internal conductor is exposed to the first end surface and includes an end connected to the first external electrode, even in a configuration in which an internal electrode closest to the second side surface is electrically connected to the first external electrode, the internal electrode and the electrode layer of the second external electrode located on the second side surface further tend not to oppose each other in the direction orthogonal to the second side surface. In the configuration in which the second internal conductor is exposed to the second end surface and includes an end connected to the second external electrode, even in a configuration in which an internal electrode closest to the second side surface is electrically connected to the second external electrode, the internal electrode and the electrode layer of the first external electrode located on the second side surface further tend not to oppose each other in the direction orthogonal to the second side surface. For the above reasons, the first internal conductor and the second internal conductor further prevent the generation of the electric field between the electrode layer and the internal electrode closest to the second side surface that are not electrically connected to each other.

As a result, this configuration further controls the proceeding of migration.

In the one aspect, an internal electrode that is connected to the first external electrode among the plurality of internal electrodes may include an end that is exposed to the first side surface and connected to the first external conductor. An internal electrode that is connected to the second external electrode among the plurality of internal electrodes may include an end that is exposed to the first side surface and connected to the second external conductor. The first internal conductor may include an end that is exposed to the first side surface and connected to the first external conductor. The second internal conductor may include an end that is exposed to the first side surface and connected to the second external conductor.

The configuration in which the first internal conductor includes the end that is exposed to the first side surface and connected to the first external conductor controls the occurrence of cracks at the interface between the above end of the first internal conductor and the element body on the first side surface. The configuration in which the second internal conductor includes the end that is exposed to the first side surface and connected to the second external conductor controls the occurrence of cracks at the interface between the above end of the second internal conductor and the element body on the first side surface.

As a result, this configuration controls the occurrence of cracks in the element body.

In the one aspect, the electrode layer may include a layer portion located on the second side surface. When viewed from the direction orthogonal to the second side surface, an internal conductor of the first internal conductor and the second internal conductor that is not electrically connected to the internal electrode closest to the second side surface may overlap an end of the layer portion of an external electrode of the first external electrode and the second external electrode that is not electrically connected to the internal electrode closest to the second side surface, and an end of the internal electrode closest to the second side surface.

In the configuration in which the internal conductor of the first internal conductor and the second internal conductor that is not electrically connected to the internal electrode closest to the second side surface overlaps the end of the layer portion of the external electrode described above and the end of the internal electrode closest to the second side surface, the internal electrode and the electrode layer of the external electrode that is located on the second side surface further tend not to oppose each other in a direction orthogonal to the second side surface. For the above reasons, the internal conductor that is not electrically connected to the internal electrode closest to the second side surface, further prevent the generation of the electric field between the electrode layer and the internal electrode closest to the second side surface that are not electrically connected to each other.

As a result, this configuration further controls the proceeding of migration.

In the one aspect, an electrode layer of the first external electrode may be disposed on a part of the first end surface and on a part of each of the first side surface and the second side surface. An electrode layer of the second external electrode may be disposed on a part of the second end surface and on a part of each of the first side surface and the second side surface. The second side surface may include a mounting surface.

In the one aspect, an electrode layer of the first external electrode may be disposed on a part of the first end surface and on a part of each of the first side surface and the second side surface. An electrode layer of the second external electrode may be disposed on a part of the second end surface and on a part of each of the first side surface and the second side surface. The first side surface may include a mounting surface.

In the one aspect, the element body may include a third side surface that opposes the first side surface and a fourth side surface that opposes the second side surface as well. Each of the first external electrode and the second external electrode may be disposed on the third side surface and the fourth side surface. The electronic component may include a third external conductor and a fourth external conductor, and a third internal conductor and a fourth internal conductor. The third external conductor and the fourth external conductor may be separated from each other on the third side surface in the direction in which the first end surface and the second end surface oppose each other and be separated from the first external electrode and the second external electrode. Each of the third external conductor and the fourth external conductor includes a conductor layer in which migration is less prone to occur than in the electrode layer. The third internal conductor and the fourth internal conductor may be disposed in the element body between the fourth side surface and an internal electrode that is closest to the fourth side surface among the plurality of internal electrodes, and be separated from each other in the direction in which the first end surface and the second end surface oppose each other. The third external conductor may be separated from the first external conductor on the second side surface and the fourth side surface, be located between the first external electrode and the fourth external conductor, and be electrically connected to the first external electrode. The fourth external conductor may be separated from the second external conductor on the second side surface and the fourth side surface, be located between the second external electrode and the third external conductor, and be electrically connected to the second external electrode. The third internal conductor may be located closer to the first end surface than the fourth internal conductor and be electrically connected to the first external electrode and the third external conductor. The fourth internal conductor may be located closer to the second end surface than the third internal conductor and be electrically connected to the second external electrode and the fourth external conductor.

The configuration in which the third external conductor described above is located between the first external electrode and the fourth external conductor controls the proceeding of migration even when migration occurs in the electrode layer of the first external electrode located on the third side surface. The configuration in which the fourth external conductor described above is located between the second external electrode and the third external conductor controls the proceeding of migration even when migration occurs in the electrode layer of the second external electrode located on the third side surface.

In the configuration in which the third internal conductor described above is disposed between the fourth side surface and the internal electrode closest to the fourth side surface, even in a configuration in which the internal electrode closest to the fourth side surface is electrically connected to the first external electrode, the internal electrode and the electrode layer of the second external electrode located on the fourth side surface are not electrically connected to each other, but tend not to oppose each other in the direction orthogonal to the second side surface. In the configuration in which the fourth internal conductor described above is disposed between the fourth side surface and the internal electrode closest to the fourth side surface, even in a configuration in which the internal electrode closest to the fourth side surface is electrically connected to the second external electrode, the internal electrode and the electrode layer of the first external electrode located on the fourth side surface are not electrically connected to each other, but tend not to oppose each other in the direction orthogonal to the second side surface. For the above reasons, the third internal conductor prevent generation of the electric field between the electrode layer and the internal electrode closest to the fourth side surface that are not electrically connected to each other.

As a result, this configuration further controls the proceeding of migration.

In the one aspect, an internal electrode that is connected to the first external electrode among the plurality of internal electrodes may include an end that is exposed to the first side surface and connected to the first external conductor, and an end that is exposed to the third side surface and connected to the third external conductor. An internal electrode that is connected to the second external electrode among the plurality of internal electrodes may include an end that is exposed to the first side surface and connected to the second external conductor, and an end that is exposed to the third side surface and connected to the fourth external conductor. Each of the first internal conductor and the third internal conductor may include an end that is exposed to the first end surface and connected to the first external electrode. Each of the second internal conductor and the fourth internal conductor may include an end that is exposed to the second end surface and connected to the second external electrode.

In the configuration in which the first internal conductor and the third internal conductor each include the end that is exposed to the first end surface and connected to the first external electrode, even in a configuration in which the internal electrode closest to the second side surface and the internal electrode closest to the fourth side surface are electrically connected to the first external electrode, the two internal electrodes and the electrode layer of the second external electrode located on the second side surface further tend not to oppose each other in the direction orthogonal to the second side surface. In the configuration in which the second internal conductor and the fourth internal conductor each include an end which is exposed to the second end surface and connected to the second external electrode, even in a configuration in which the internal electrode closest to the second side surface and the internal electrode closest to the fourth side surface are electrically connected to the second external electrode, the two internal electrodes and the electrode layer of the first external electrode located on the second side surface further tend not to oppose each other in the direction orthogonal to the second side surface. For the above reasons, the first internal conductor, the second internal conductor, the third internal conductor, and the fourth internal conductor further prevent generation of the electric field between the electrode layer and the internal electrode closest to the second side surface that are not electrically connected to each other, and between the electrode layer and the internal electrode closest to the fourth side surface that are not electrically connected to each other.

As a result, this configuration further controls the proceeding of migration.

In the one aspect, an internal electrode that is connected to the first external electrode among the plurality of internal electrodes may include an end that is exposed to the first side surface and connected to the first external conductor, and an end that is exposed to the third side surface and connected to the third external conductor. An internal electrode that is connected to the second external electrode among the plurality of internal electrodes may include an end that is exposed to the first side surface and connected to the second external conductor, and an end that is exposed to the third side surface and connected to the fourth external conductor. Each of the first internal conductor and the third internal conductor may include an end that is exposed to the first side surface and connected to the first external conductor, and an end that is exposed to the third side surface and connected to the third external conductor. Each of the second internal conductor and the fourth internal conductor may include an end that is exposed to the first side surface and connected to the second external conductor, and an end that is exposed to the third side surface and connected to the fourth external conductor.

The configuration in which the first internal conductor and the third internal conductor each include the end that is exposed to the first side surface and connected to the first external conductor controls the occurrence of cracks at the interface between the element body and the above end of the first internal conductor and the above end of the third internal conductor on the first side surface. The configuration in which the second internal conductor and the fourth internal conductor each include the end that is exposed to the first side surface and connected to the second external conductor controls the occurrence of cracks at the interface between the element body and the above end of the second internal conductor and the above end of the fourth internal conductor on the first side surface.

As a result, this configuration controls the occurrence of cracks in the element body.

In the one aspect, the electrode layer may include a first layer portion located on the second side surface and a second layer portion located on the fourth side surface. When viewed from the direction orthogonal to the second side surface, an internal conductor of the first internal conductor and the second internal conductor that is not electrically connected to the internal electrode closest to the second side surface may overlap an end of the first layer portion of an external electrode of the first external electrode and the second external electrode that is not electrically connected to the internal electrode closest to the second side surface, and an end of the internal electrode closest to the second side surface. When viewed from the direction orthogonal to the fourth side surface, an internal conductor of the third internal conductor and the fourth internal conductor that is not electrically connected to the internal electrode closest to the fourth side surface may overlap an end of the second layer portion of an external electrode of the first external electrode and the second external electrode that is not electrically connected to the internal electrode closest to the fourth side surface, and an end of the internal electrode closest to the fourth side surface.

In the configuration in which the internal conductor of the first internal conductor and the second internal conductor that is not electrically connected to the internal electrode closest to the second side surface overlaps the end of the first layer portion and the end of the internal electrode closest to the second side surface, the internal electrode and the electrode layer of the external electrode located on the second side surface further tend not to oppose each other in the direction orthogonal to the second side surface. For the above reasons, the internal conductor that is not electrically connected to the internal electrode closest to the second side surface, further prevent generation of the electric filed between the electrode layer and the internal electrode closest to the second side surface that are not electrically connected to each other. In the configuration in which the internal conductor of the third internal conductor and the fourth internal conductor that is not electrically connected to the internal electrode closest to the fourth side surface overlaps the end of the second layer portion and the end of the internal electrode closest to the fourth side surface, the internal electrode and the electrode layer of the external electrode located on the fourth side surface further tend not to oppose each other in the direction orthogonal to the second side surface. For the above reasons, the internal conductor that is not electrically connected to the internal electrode closest to the fourth side surface, prevent generation of the electric field between the electrode layer and the internal electrode closest to the fourth side surface that are not electrically connected to each other.

As a result, this configuration further controls the proceeding of migration.

In the one aspect, the electrode layer may include a conductive resin layer including a plurality of silver particles. The conductor layer may include a metal layer in which migration is less prone to occur than in silver.

The configuration in which the conductor layer includes the metal layer in which migration is less prone to occur than in silver reliably controls the proceeding of migration even in the configuration in which the conductive resin layer included in the electrode layer includes the plurality of silver particles.

The present disclosure will become more fully understood from the detailed description given hereinafter and the accompanying drawings that are given by way of illustration only, and thus are not to be considered as limiting the present disclosure.

Further scope of applicability of the present disclosure will become apparent from the detailed description given hereinafter. However, it should be understood that the detailed description and specific examples, while indicating examples of the disclosure, are given by way of illustration only, since various changes and modifications within the spirit and scope of the disclosure will become apparent to those skilled in the art from this detailed description.

### BRIEF DESCRIPTION OF THE DRAWINGS

FIG. 1 is a perspective view of a multilayer capacitor according to a first example.

FIG. 2 is a perspective view of the multilayer capacitor according to the first example.

FIG. 3 is a diagram illustrating a cross-sectional configuration of the multilayer capacitor according to the first example.

FIG. 4 is a diagram illustrating a cross-sectional configuration of the multilayer capacitor according to the first example.

FIG. 5 is a diagram illustrating a cross-sectional configuration of the multilayer capacitor according to the first example.

FIG. 6 is a diagram illustrating a cross-sectional configuration of the multilayer capacitor according to the first example.

FIG. 7 is a diagram illustrating a cross-sectional configuration of the multilayer capacitor according to the first example.

FIG. 8 is a diagram illustrating a cross-sectional configuration of a multilayer capacitor according to one modification example of the first example.

FIG. 9 is a diagram illustrating a cross-sectional configuration of the multilayer capacitor according to one modification example of the first example.

FIG. 10 is a diagram illustrating a cross-sectional configuration of the multilayer capacitor according to one modification example of the first example.

FIG. 11 is a diagram illustrating a cross-sectional configuration of the multilayer capacitor according to one modification example of the first example.

FIG. 12 is a diagram illustrating a cross-sectional configuration of the multilayer capacitor according to one modification example of the first example.

FIG. 13 is a perspective view of a multilayer capacitor according to a second example.

FIG. 14 is a perspective view of the multilayer capacitor according to the second example.

FIG. 15 is a diagram illustrating a cross-sectional configuration of the multilayer capacitor according to the second example.

FIG. 16 is a diagram illustrating a cross-sectional configuration of the multilayer capacitor according to the second example.

FIG. 17 is a diagram illustrating a cross-sectional configuration of the multilayer capacitor according to the second example.

FIG. 18 is a diagram illustrating a cross-sectional configuration of a multilayer capacitor according to one modification example of the second example.

FIG. 19 is a diagram illustrating a cross-sectional configuration of the multilayer capacitor according to one modification example of the second example.

FIG. 20 is a diagram illustrating a cross-sectional configuration of the multilayer capacitor according to one modification example of the second example.

FIG. 21 is a perspective view of a multilayer capacitor according to another modification example of the second example.

FIG. 22 is a perspective view of the multilayer capacitor according to another modification example of the second example.

FIG. 23 is a diagram illustrating a cross-sectional configuration of the multilayer capacitor according to another modification example of the second example.

FIG. 24 is a diagram illustrating a cross-sectional configuration of the multilayer capacitor according to another modification example of the second example.

FIG. 25 is a diagram illustrating a cross-sectional configuration of the multilayer capacitor according to another modification example of the second example.

FIG. 26 is a diagram illustrating a cross-sectional configuration of the multilayer capacitor according to another modification example of the second example.

FIG. 27 is a diagram illustrating a cross-sectional configuration of the multilayer capacitor according to another modification example of the second example.

FIG. 28 is a diagram illustrating a cross-sectional configuration of a multilayer capacitor according to still another modification example of the second example.

FIG. 29 is a diagram illustrating a cross-sectional configuration of the multilayer capacitor according to still another modification example of the second example.

FIG. 30 is a diagram illustrating a cross-sectional configuration of the multilayer capacitor according to still another modification example of the second example.

FIG. 31 is a diagram illustrating a cross-sectional configuration of the multilayer capacitor according to still another modification example of the second example.

FIG. 32 is a diagram illustrating a cross-sectional configuration of the multilayer capacitor according to still another modification example of the second example.

### DETAILED DESCRIPTION

Hereinafter, examples of the present disclosure will be described in detail with reference to the accompanying drawings. In the following description, the same elements or elements having the same functions are denoted with the same reference numerals and overlapped explanation is omitted.

### First example

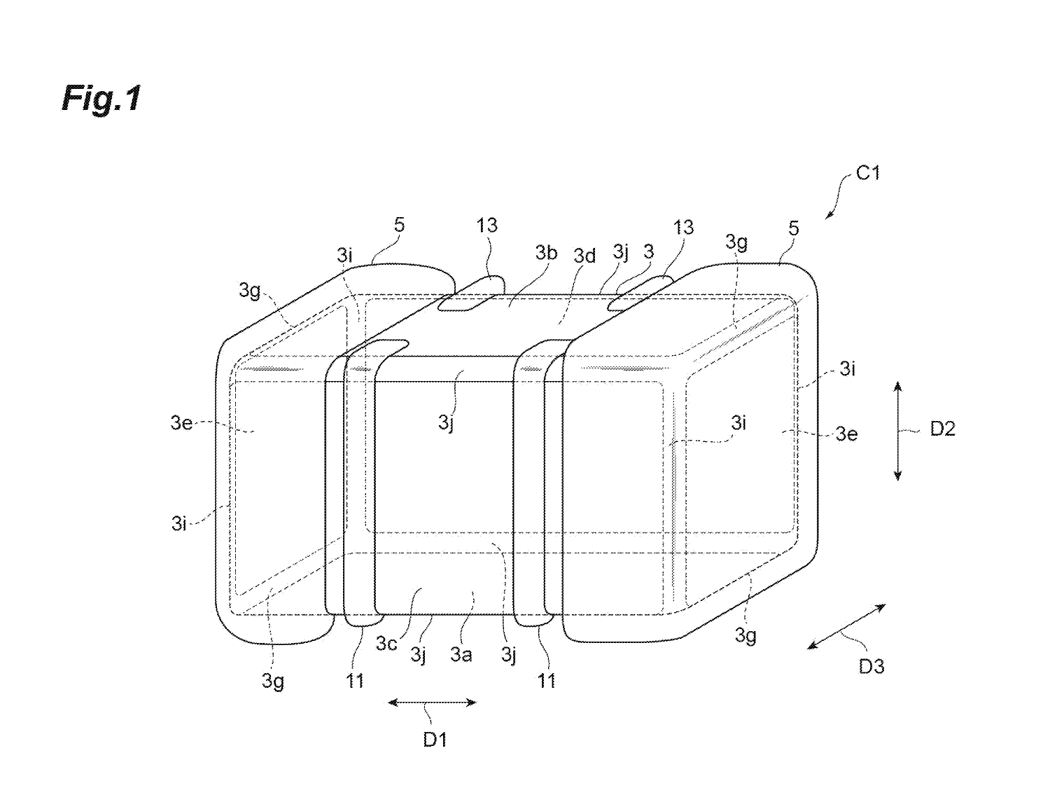

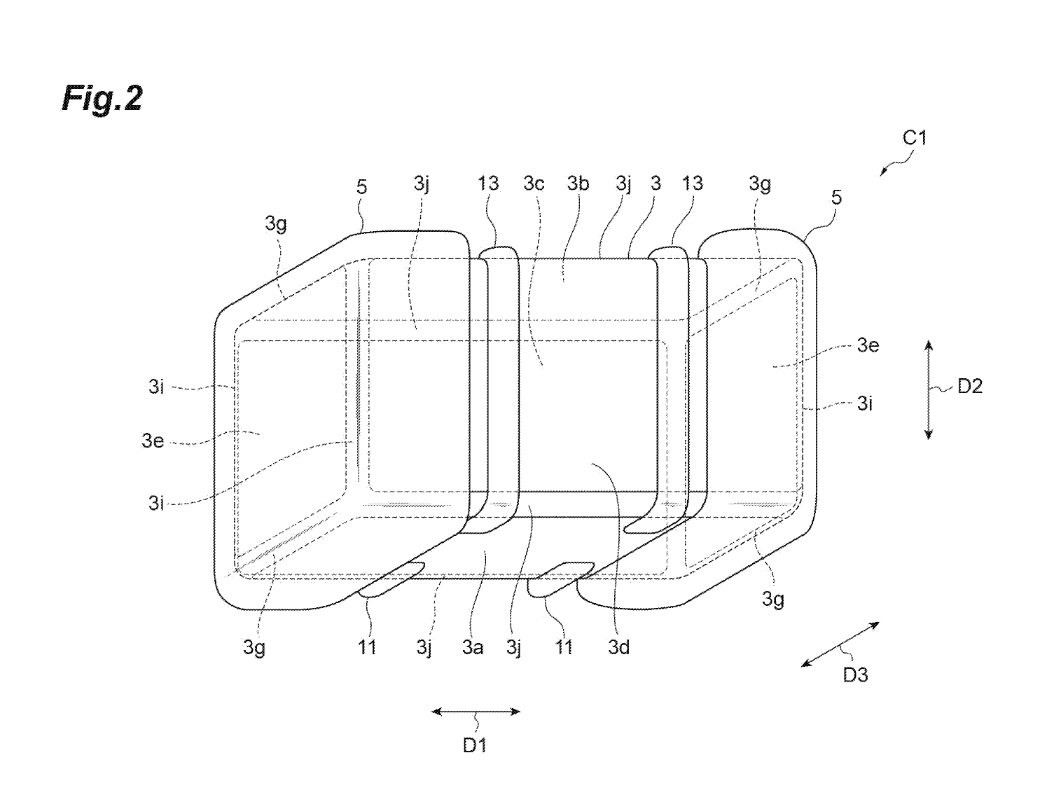

A configuration of a multilayer capacitor C1 according to the first example will be described with reference to FIGS. 1-7. FIG. 1 is a perspective view of a multilayer capacitor according to the first example. FIGS. 2, 3, 4, 5, 6 and 7 are diagrams illustrating cross-sectional configurations of the multilayer capacitor according to the first example. In the first example, an electronic component is, for example, the multilayer capacitor C1.

As shown in FIGS. 1 and 2, the multilayer capacitor C1 includes an element body 3, a plurality of external electrodes 5, a plurality of external conductors 11, and a plurality of external conductors 13. In the present example, the multilayer capacitor C1 includes a pair of external electrodes 5. The pair of external electrodes 5 are disposed on the outer surface of the element body 3. The pair of external electrodes 5 are separated from each other. The rectangular parallelepiped shape includes a rectangular parallelepiped shape with chamfered corner portions and ridge portions, or a rectangular parallelepiped shape with rounded corner portions and ridge portions.

The element body 3 has, for example, a rectangular parallelepiped shape. In this specification, the rectangular parallelepiped shape includes a rectangular parallelepiped shape with chamfered corner portions and ridge portions, or a rectangular parallelepiped shape with rounded corner portions and ridge portions.

The element body 3 includes a pair of main surfaces 3a and 3b facing each other, a pair of side surfaces 3c and 3d facing each other, and a pair of end surfaces 3e facing each other. The pair of main surfaces 3a and 3b, the pair of side surfaces 3c and 3d, and the pair of end surfaces 3e each have a rectangular parallelepiped shape. In the present example, the direction in which the pair of end surfaces 3e oppose each other includes a first direction D1. The direction in which the pair of main surfaces 3a and 3b oppose each other includes a second direction D2. The direction in which the pair of side surfaces 3c and 3d oppose each other includes a third direction D3. The multilayer capacitor C1 is solder-mounted onto an electronic device. The electronic device includes, for example, a circuit substrate or an electronic component. In the multilayer capacitor C1, for example, one of the main surfaces 3a and 3b and the side surfaces 3c and 3d opposes the electronic device. In a configuration where one of the main surfaces 3a and 3b and the side surfaces 3c and 3d opposes the electronic device, the one of the main surfaces 3a and 3b and the side surfaces 3c and 3d is disposed to include a mounting surface. The one of the main surfaces 3a and 3b and the side surfaces 3c and 3d is a mounting surface.

The first direction D1, the second direction D2, and the third direction D3 intersect each other. In the present example, the first direction D1, the second direction D2, and the third direction D3 are orthogonal to each other. The first direction D1 includes a direction parallel to the pair of main surfaces 3a and 3b and the pair of side surfaces 3c and 3d. The second direction D2 includes a direction orthogonal to the main surface 3a and the main surface 3b. The third direction D3 includes a direction orthogonal to the side surface 3c and the side surface 3d.

In the element body 3, as shown in FIG. 1, the main surface 3b and the side surface 3c are adjacent to each other. The main surface 3b and the side surface 3c couple the pair of end surfaces 3e. In the element body 3, as shown in FIG. 2, the main surface 3a and the side surface 3d are adjacent to each other. The main surface 3a and the side surface 3d couple the pair of end surfaces 3e. That is, in the element body 3, the pair of end surfaces 3e are coupled by the pair of main surfaces 3a and 3b and the pair of side surfaces 3c and 3d. The pair of main surfaces 3a and 3b couple the pair of end surfaces 3e and extend in the second direction D2. The pair of main surfaces 3a and 3b also extend in the first direction D1. The pair of side surfaces 3c and 3d couple the pair of end surfaces 3e and extend in the second direction D2. The pair of side surfaces 3c and 3d also extend in the third direction D3.

For example, in a configuration in which one end surface 3e includes a first end surface, the other end surface 3e includes a second end surface. The pair of main surfaces 3a and 3b are also side surfaces included in the element body 3. The side surface of the element body 3 includes the pair of main surfaces 3a and 3b and the pair of side surfaces 3c and 3d. For example, in a configuration in which the side surface 3c includes a first side surface, the main surface 3b may include a second side surface, the side surface 3d may include a third side surface, and the main surface 3a may include a fourth side surface.

The element body 3 includes four ridge portions 3g, four ridge portions 3i, and four ridge portions 3j.

The ridge portions 3g are located between the end surface 3e and the main surface 3a and between the end surface 3e and the main surface 3b. The ridge portions 3i are located between the end surface 3e and the side surface 3c and between the end surface 3e and the side surface 3d. The ridge portions 3j are located between the main surface 3a and the side surface 3c, between the main surface 3a and the side surface 3d, between the main surface 3b and the side surface 3c, and between the main surface 3b and the side surface 3d. In the present example, each of the ridge portions 3g, 3i, and 3j is rounded to be curved. The element body 3 has undergone so-called R chamfering. The end surface 3e and the main surface 3a, and the end surface 3e and the main surface 3b are indirectly adjacent to each other through the ridge portion 3g. The end surface 3e and the side surface 3c, and the end surface 3e and the side surface 3d are indirectly adjacent to each other through the ridge portion 3i. The main surface 3a and the side surface 3c, the main surface 3a and the side surface 3d, the main surface 3b and the side surface 3c, and the main surface 3b and the side surface 3d are indirectly adjacent to each other through the ridge portion 3j.

The element body 3 is configured through laminating a plurality of dielectric layers in the second direction D2. The element body 3 includes a plurality of laminated dielectric layers. In the element body 3, the lamination direction of the plurality of dielectric layers includes the second direction D2. Each dielectric layer includes, for example, a sintered body of a ceramic green sheet including a dielectric material. The dielectric material includes dielectric ceramics such as, for example, BaTiO₃-based, Ba(Ti, Zr)O₃-based, or (Ba, Ca)TiO₃-based materials. In the actual element body 3, the dielectric layers are integrated to such an extent that the boundaries between the dielectric layers are not visible.

The height of the element body 3 includes the length of the element body 3 in the second direction D2. The width of the element body 3 includes the length of the element body 3 in the third direction D3. The length of the element body 3 includes the length of the element body 3 in the first direction D1. In the present example, the height of the element body 3 is 0.1 to 2. 5 mm, the width of the element body 3 is 0.1 to 5.0 mm, and the length of the element body 3 is 0.2 to 5.7 mm. For example, the height of the element body 3 is 2.5 mm, the width of the element body 3 is 2.5 mm, and the length of the element body 3 is 3.2 mm.

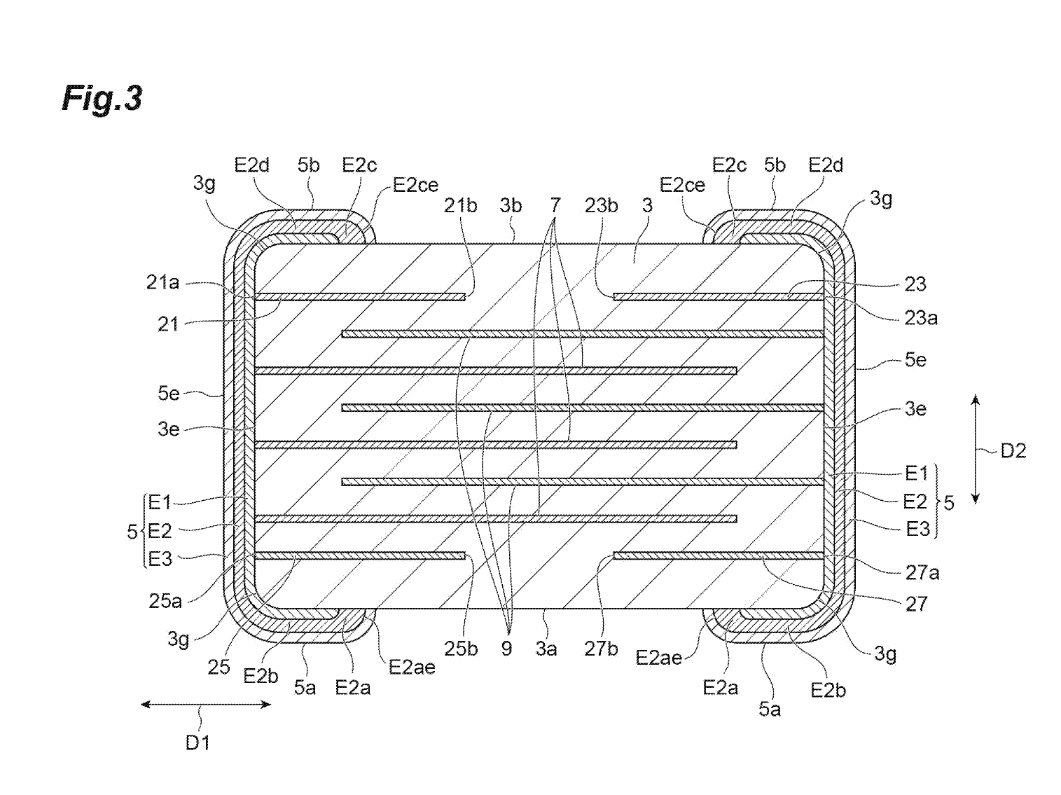

As shown in FIGS. 1 and 2, the pair of external electrodes 5 are respectively disposed on both ends of the element body 3 in the first direction D1. Each of the external electrodes 5 is disposed on a corresponding end surface 3e of the pair of end surfaces 3e. In the present example, each of the external electrodes 5 is disposed on the pair of main surfaces 3a and 3b, the pair of side surfaces 3c and 3d, and one end surface 3e. As shown in FIGS. 3-5, the external electrode 5 includes a plurality of electrode portions 5a, 5b, 5c, 5d, and 5e.

The electrode portion 5a is disposed on the main surface 3a. The electrode portion 5b is disposed on the main surface 3b. The electrode portion 5a and the electrode portion 5b may be disposed on the ridge portion 3g. The electrode portion 5c is disposed on the side surface 3c. The electrode portion 5d is disposed on the side surface 3d. The electrode portion 5c and the electrode portion 5d may be disposed on the ridge portion 3i. The electrode portion 5e is disposed on the end surface 3e. The external electrode 5 also includes an electrode portion disposed on the ridge portion 3j.

The external electrode 5 is formed on five surfaces, that is, the pair of main surfaces 3a and 3b, the pair of side surfaces 3c and 3d, and one end surface 3e, as well as the ridge portions 3g, 3i, and 3j. The electrode portions 5a, 5b, 5c, 5d, and 5e that are adjacent to each other are physically and electrically connected to each other. Each of the external electrodes 5 includes a first electrode layer E1, a second electrode layer E2, and a third electrode layer E3. The third electrode layer E3 includes the outermost layer of the external electrode 5. Each of the electrode portions 5a, 5b, 5c, 5d, and 5e includes the first electrode layer E1, the second electrode layer E2, and the third electrode layer E3.

The first electrode layer E1 of the electrode portion 5a is disposed on the main surface 3a and on the ridge portion 3g. The first electrode layer E1 of the electrode portion 5a covers a part of the main surface 3a and the entirety of the ridge portion 3g. The first electrode layer E1 of the electrode portion 5a is in contact with the part of the main surface 3a and the entirety of the ridge portion 3g. In the electrode portion 5a, the first electrode layer E1 is in direct contact with the element body 3. The part of the main surface 3a includes a partial region of the main surface 3a located close to the end surface 3e. The first electrode layer E1 of the electrode portion 5a is located on the main surface 3a. The first electrode layer E1 may not be formed on the main surface 3a. The first electrode layer E1 may not be disposed on the main surface 3a.

The second electrode layer E2 of the electrode portion 5a is disposed on the first electrode layer E1 and on the main surface 3a. The second electrode layer E2 of the electrode portion 5a includes a layer portion E2a located on the main surface 3a and a layer portion E2b located on the first electrode layer E1. Each layer portion E2a includes an end E2ae. On the main surface 3a, the end E2ae of one layer portion E2a opposes the end E2ae of the other layer portion E2a in the first direction D1. In the electrode portion 5a, the second electrode layer E2 covers the first electrode layer E1 and a part of the main surface 3a. In the electrode portion 5a, the second electrode layer E2 disposed on the first electrode layer E1 and the part of the main surface 3a. In the electrode portion 5a, the second electrode layer E2 is in direct contact with the first electrode layer E1 and the main surface 3a. In the present example, the layer portion E2a directly covers the main surface 3a, and the layer portion E2b directly covers the first electrode layer E1. In the electrode portion 5a, the layer portion E2a indirectly covers the main surface 3a. The second electrode layer E2 of the electrode portion 5a is located on the main surface 3a. The second electrode layer E2 of the electrode portion 5a positioned on the main surface 3a. The main surface 3a includes a region covered with the second electrode layer E2 and a region exposed from the second electrode layer E2.

The third electrode layer E3 of the electrode portion 5a is disposed on the second electrode layer E2. In the electrode portion 5a, the third electrode layer E3 covers the second electrode layer E2. In the electrode portion 5a, the third electrode layer E3 is in contact with the second electrode layer E2. In the electrode portion 5a, the third electrode layer E3 is in direct contact with the second electrode layer E2. The third electrode layer E3 of the electrode portion 5a is located on the main surface 3a.

The first electrode layer E1 of the electrode portion 5b is disposed on the main surface 3b and on the ridge portion 3g. The first electrode layer E1 of the electrode portion 5b covers a part of the main surface 3b and the entirety of the ridge portion 3g. The first electrode layer E1 of the electrode portion 5b is in contact with the part of the main surface 3b and the entirety of the ridge portion 3g. In the electrode portion 5b, the first electrode layer E1 is in direct contact with the element body 3. The part of the main surface 3b includes a partial region of the main surface 3b located close to the end surface 3e. The first electrode layer E1 of the electrode portion 5b is located on the main surface 3b. The first electrode layer E1 may not be formed on the main surface 3b. The first electrode layer E1 may not be disposed on the main surface 3b.

The second electrode layer E2 the electrode portion 5b is disposed on the first electrode layer E1 and on the main surface 3b. The second electrode layer E2 of the electrode portion 5b includes a layer portion E2c located on the main surface 3b and a layer portion E2d located on the first electrode layer E1. Each layer portion E2c includes an end E2ce. On the main surface 3b, the end E2ce of one layer portion E2c opposes the end E2ce of the other layer portion E2c in the first direction D1. In the electrode portion 5b, the second electrode layer E2 covers the first electrode layer E1 and a part of the main surface 3b. In the electrode portion 5b, the second electrode layer E2 disposed on the first electrode layer E1 and the part of the main surface 3b. In the electrode portion 5b, the second electrode layer E2 is in direct contact with the first electrode layer E1 and the main surface 3b. In the present example, the layer portion E2c directly covers the main surface 3b, and the layer portion E2d directly covers the first electrode layer E1. In the electrode portion 5b, the layer portion E2d indirectly covers the main surface 3b. The second electrode layer E2 of the electrode portion 5b is located on the main surface 3b. The second electrode layer E2 of the electrode portion 5b positioned on the main surface 3b. The main surface 3b includes a region covered with the second electrode layer E2 and a region exposed from the second electrode layer E2.

For example, in a configuration in which the layer portion E2a included in the second electrode layer E2 of the electrode portion 5a includes a first layer portion, the layer portion E2c included in the second electrode layer E2 of the electrode portion 5b includes a second layer portion.

The third electrode layer E3 of the electrode portion 5b is disposed on the second electrode layer E2. In the electrode portion 5b, the third electrode layer E3 covers the second electrode layer E2. In the electrode portion 5b, the third electrode layer E3 is in contact with the second electrode layer E2. In the electrode portion 5b, the third electrode layer E3 is in direct contact with the second electrode layer E2. The third electrode layer E3 of the electrode portion 5b is located on the main surface 3b.

The first electrode layer E1 of the electrode portion 5c is disposed on the side surface 3c and on the ridge portion 3i. The first electrode layer E1 of the electrode portion 5c covers a part of the side surface 3c and the entirety of the ridge portion 3i. The first electrode layer E1 of the electrode portion 5c is in contact with the part of the side surface 3c and the entirety of the ridge portion 3i. In the electrode portion 5c, the first electrode layer E1 is in direct contact with the element body 3. The part of the side surface 3c includes a partial region of the side surface 3c located close to the end surface 3e. The first electrode layer E1 of the electrode portion 5c is located on the side surface 3c. The first electrode layer E1 may not be formed on the side surface 3c. The first electrode layer E1 may not be disposed on the side surface 3c.

The second electrode layer E2 of the electrode portion 5c is disposed on the first electrode layer E1 and on the side surface 3c. In the electrode portion 5c, the second electrode layer E2 covers the first electrode layer E1 and a part of the side surface 3c. In the electrode portion 5c, the second electrode layer E2 disposed on the first electrode layer E1 and the part of the side surface 3c. In the electrode portion 5c, the second electrode layer E2 is in direct contact with the first electrode layer E1 and the side surface 3c. The second electrode layer E2 of the electrode portion 5c includes a part that directly covers the first electrode layer E1 and a part that directly covers the side surface 3c. In the electrode portion 5c, the part that is included in the second electrode layer E2 and that directly covers the first electrode layer E1 indirectly covers the side surface 3c. The second electrode layer E2 of the electrode portion 5c is located on the side surface 3c. The second electrode layer E2 of the electrode portion 5c positioned on the side surface 3c. The side surface 3c and the side surface 3d include a region covered with the second electrode layer E2 and a region exposed from the second electrode layer E2.

The third electrode layer E3 of the electrode portion 5c is disposed on the second electrode layer E2. In the electrode portion 5c, the third electrode layer E3 covers the second electrode layer E2. In the electrode portion 5c, the third electrode layer E3 is in contact with the second electrode layer E2. In the electrode portion 5c, the third electrode layer E3 is in direct contact with the second electrode layer E2. The third electrode layer E3 of the electrode portion 5c is located on the side surface 3c.

The first electrode layer E1 of the electrode portion 5d is disposed on the side surface 3d and on the ridge portion 3i. The first electrode layer E1 of the electrode portion 5d covers a part of the side surface 3d and the entirety of the ridge portion 3i. The first electrode layer E1 of the electrode portion 5d is in contact with the part of the side surface 3d and the entirety of the ridge portion 3i. In the electrode portion 5d, the first electrode layer E1 is in direct contact with the element body 3. The part of the side surface 3d includes a partial region of the side surface 3d located close to the end surface 3e. The first electrode layer E1 of the electrode portion 5d is located on the side surface 3d. The first electrode layer E1 may not be formed on the side surface 3d. The first electrode layer E1 may not be disposed on the side surface 3d.

The second electrode layer E2 of the electrode portion 5d is disposed on the first electrode layer E1 and on the side surface 3d. In the electrode portion 5d, the second electrode layer E2 covers the first electrode layer E1 and a part of the side surface 3d. In the electrode portion 5d, the second electrode layer E2 disposed on the first electrode layer E1 and the part of the side surface 3d. In the electrode portion 5d, the second electrode layer E2 is in direct contact with the first electrode layer E1 and the side surface 3d. The second electrode layer E2 of the electrode portion 5d includes a part that directly covers the first electrode layer E1 and a portion that directly covers the side surface 3d. In the electrode portion 5d, the part that is included in the second electrode layer E2 and that directly covers the first electrode layer E1 indirectly covers the side surface 3d. The second electrode layer E2 of the electrode portion 5d is located on the side surface 3d. The second electrode layer E2 of the electrode portion 5d positioned on the side surface 3d. The side surface 3d includes a region covered with the second electrode layer E2 and a region exposed from the second electrode layer E2.

The third electrode layer E3 of the electrode portion 5d is disposed on the second electrode layer E2. In the electrode portion 5d, the third electrode layer E3 covers the second electrode layer E2. In the electrode portion 5d, the third electrode layer E3 is in contact with the second electrode layer E2. In the electrode portion 5d, the third electrode layer E3 is in direct contact with the second electrode layer E2. The third electrode layer E3 of the electrode portion 5d is located on the side surface 3d.

The first electrode layer E1 of the electrode portion 5e is disposed on the end surface 3e. The first electrode layer E1 of the electrode portion 5e covers the entirety of the end surface 3e. The first electrode layer E1 of the electrode portion 5e is in contact with the entirety of the end surface 3e. In the electrode portion 5e, the first electrode layer E1 is in direct contact with the end surface 3e.

The second electrode layer E2 of the electrode portion 5e is disposed on the first electrode layer E1. In the electrode portion 5e, the second electrode layer E2 covers the entirety of the first electrode layer E1. In the electrode portion 5e, the second electrode layer E2 is in direct contact with the first electrode layer E1. The second electrode layer E2 of the electrode portion 5e directly covers the first electrode layer E1 and indirectly covers the end surface 3e. The second electrode layer E2 of the electrode portion 5e is located on the end surface 3e. The second electrode layer E2 of the electrode portion 5e positioned on the end surface 3e. In the electrode portion 5e, the second electrode layer E2 disposed on the end surface 3e.

The third electrode layer E3 of the electrode portion 5e is disposed on the second electrode layer E2. In the electrode portion 5e, the third electrode layer E3 covers the entirety of the second electrode layer E2. In the electrode portion 5e, the third electrode layer E3 is in contact with the entirety of the second electrode layer E2. In the electrode portion 5e, the third electrode layer E3 is in direct contact with the second electrode layer E2. The third electrode layer E3 of the electrode portion 5e is located on the end surface 3e.

The first electrode layer E1 is formed by baking a conductive paste applied to the surface of the element body 3. The first electrode layer E1 is formed to cover the part of each main surface 3a, the part of each side surface 3c, one end surface 3e, and the ridge portions 3g, 3i, and 3j. The first electrode layer E1 is formed through sintering metal components (metal particles) included in a conductive paste. The first electrode layer E1 includes a sintered metal layer. The first electrode layer E1 includes a sintered metal layer formed on the element body 3. In the present example, the first electrode layer E1 includes a sintered metal layer including Cu. The first electrode layer E1 may include a sintered metal layer including Ni. The first electrode layer E1 includes a base metal. The conductive paste includes, for example, particles including Cu or Ni, a glass component, an organic binder, and an organic solvent. The first electrode layer E1 included in each of the electrode portions 5a, 5c, and 5e is integrally formed.

The second electrode layer E2 is formed through curing a conductive resin paste applied onto the first electrode layer E1. The second electrode layer E2 is formed over the first electrode layer E1 and over the element body 3. The first electrode layer E1 includes a base metal layer for forming the second electrode layer E2. The second electrode layer E2 includes a conductive resin layer that covers the first electrode layer E1. The conductive resin paste includes, for example, a resin, a conductive material, and an organic solvent. The resin includes, for example, a thermosetting resin. The conductive material includes, for example, metal particles. The metal particles include, for example, silver particles. In the present example, the second electrode layer E2 includes a plurality of silver particles. The thermosetting resin includes, for example, a phenolic resin, an acrylic resin, a silicone resin, an epoxy resin, or a polyimide resin. The second electrode layer E2 is in contact with a part of the ridge portion 3j. The second electrode layer E2 included in each of the electrode portions 5a, 5c, and 5e is integrally formed.

The third electrode layer E3 is formed on the second electrode layer E2 using a plating method. The third electrode layer E3 may have a multi-layer structure. In a configuration in which the third electrode layer E3 has a multi-layer structure, the third electrode layer E3 includes, for example, a Ni plating layer and a solder plating layer. The Ni plating layer is formed on the second electrode layer E2. The solder plating layer is formed on the Ni plating layer. The solder plating layer covers the Ni plating layer. The Ni plating layer has better solder erosion resistance than the metal included in the second electrode layer E2. The third electrode layer E3 may include a Sn plating layer, a Cu plating layer, or an Au plating layer instead of the Ni plating layer. The solder plating layer includes, for example, a Sn plating layer, a Sn-Ag alloy plating layer, a Sn-Bi alloy plating layer, or a Sn-Cu alloy plating layer. The third electrode layer E3 included in each of the electrode portions 5a, 5c, and 5e is integrally formed.

As shown in FIGS. 1-7, the multilayer capacitor C1 includes a pair of external conductors 11 and a pair of external conductors 13. The pair of external conductors 11 are disposed on the outer surface of the element body 3. As shown in FIG. 1, the pair of external conductors 11 are lined up on the side surface 3c of the element body 3 in the first direction D1. The pair of external conductors 11 are separated from each other in the first direction D1 on the side surface 3c of the element body 3. The pair of external conductors 11 separated from each external electrode 5. The pair of external conductors 11 are located between the pair of external electrodes 5 in the first direction D1.

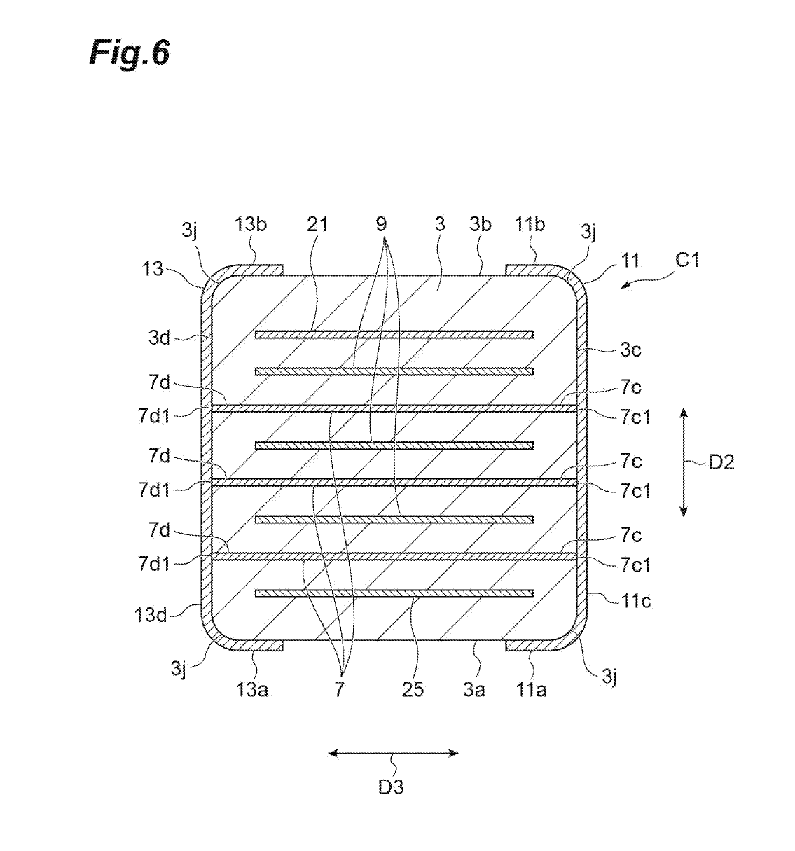

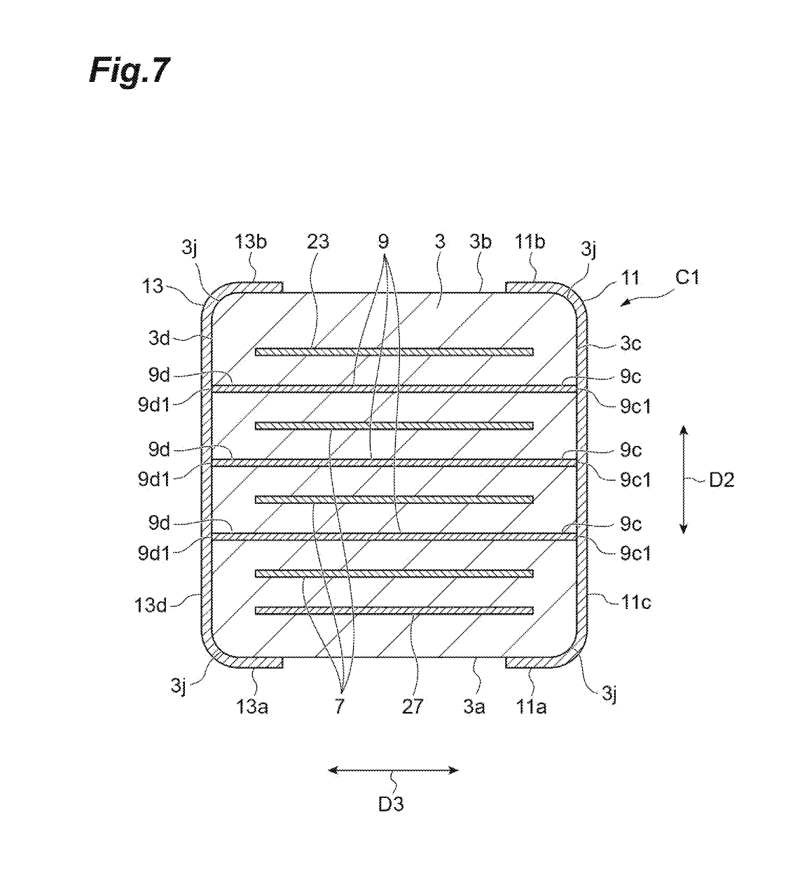

Each external conductor 11 is disposed on the pair of main surfaces 3a and 3b and on the side surface 3c. As shown in FIGS. 6 and 7, each external conductor 11 includes a portion 11a disposed on the main surface 3a, a portion 11b disposed on the main surface 3b, and a portion 11c disposed on the side surface 3c. Each external conductor 11 includes one portion 11a, one portion 11b, and one portion 11c. In the present example, the portion 11a, the portion 11b, and the portion 11c are formed integrally with each other. Each external conductor 11 is also disposed on each ridge portion 3j. The portion 11a, the portion 11b, and the portion 11c are not only physically connected to each other, but also electrically connected to each other.

The external conductor 11 may not be disposed on the main surface 3a, and may not be disposed on the main surface 3b. The external conductor 11 may not include the portion 11a, and may not include the portion 11b. That is, the external conductor 11 may be disposed only on the side surface 3c, and may include only the portion 11c.

One external conductor 11 and one external electrode 5 (electrode portions 5a, 5b, and 5c) are adjacent to each other in the first direction D1. The other external conductor 11 and the other external electrode 5 (electrode portions 5a, 5b, and 5c) are adjacent to each other in the first direction D1. One external conductor 11 is located between one external electrode 5 and the other external conductor 11. One external conductor 11 positioned between one external electrode 5 and the other external conductor 11. The other external conductor 11 is located between the other external electrode 5 and one external conductor 11. The other external conductor 11 positioned between the other external electrode 5 and one external conductor 11.

The portion 11a is disposed between the electrode portions 5a located on the main surface 3a on which the portion 11a is disposed, and is separated from the electrode portion 5a. The portion 11a extends along the end edge of the electrode portion 5a. The portion 11a extends in the third direction D3.

The portion 11b is disposed between the electrode portions 5b located on the main surface 3b on which the portion 11b is disposed, and is separated from the electrode portions 5b. The portion 11b extends along the end edge of the electrode portion 5b. The portion 11b extends in the third direction D3.

The portion 11c is disposed between the electrode portions 5c located on the side surface 3c on which the portion 11c is disposed, and is separated from the electrode portions 5c. The portion 11c extends along the end edge of the electrode portion 5c. The portion 11c extends in the second direction D2.

The pair of external conductors 13 is disposed on the outer surface of the element body 3. As shown in FIG. 2, the pair of external conductors 13 is lined up in the first direction D1 on the side surface 3d of the element body 3. The pair of external conductors 13 is separated from each other in the first direction D1 on the side surface 3d of the element body 3. The pair of external conductors 13 is separated from each external electrode 5. The pair of external conductors 13 is located between the pair of external electrodes 5 in the first direction D1.

Each external conductor 13 is disposed on the pair of main surfaces 3a and 3b and on the side surface 3d. As shown in FIGS. 6 and 7, each external conductor 13 includes a portion 13a disposed on the main surface 3a, a portion 13b disposed on the main surface 3b, and a portion 13d disposed on the side surface 3d. Each external conductor 13 includes one portion 13a, one portion 13b, and one portion 13d. In the present example, the portion 13a, the portion 13b, and the portion 13d are formed integrally with each other. Each external conductor 13 is also disposed on each ridge portion 3j. The portion 13a, the portion 13b, and the portion 13d are not only physically connected to each other, but also electrically connected to each other.

The external conductor 13 may not be disposed on the main surface 3a, and may not be disposed on the main surface 3b. The external conductor 13 may not include the portion 13a, and may not include the portion 13b. That is, the external conductor 13 may be disposed only on the side surface 3d, and may include only the portion 13d.

One external conductor 13 and one external electrode 5 (electrode portions 5a, 5b, and 5d) are adjacent to each other in the first direction D1. The other external conductor 13 and the other external electrode 5 (electrode portions 5a, 5b, and 5d) are adjacent to each other in the first direction D1. One external conductor 13 is located between one external electrode 5 and the other external conductor 13. One external conductor 13 positioned between one external electrode 5 and the other external conductor 13. The other external conductor 13 is located between the other external electrode 5 and one external conductor 13. The other external conductor 13 positioned between the other external electrode 5 and one external conductor 13.

The portion 13a is disposed between the electrode portions 5a located on the main surface 3a on which the portion 13a is disposed, and is separated from the electrode portions 5a. The portion 13a extends along the end edge of the electrode portion 5a. The portion 13a extends in the third direction D3. On the main surface 3a, the portion 13a is separated from the portion 11a. As shown in FIG. 2, in the present example, on the main surface 3a, the portion 13a is separated from the portion 11a in the third direction D3. That is, in the present example, the external conductor 13 is separated from the external conductor 11 in the main surface 3a. The portion 13a and the portion 11a are not physically connected to each other.

The portion 13b is disposed between the electrode portions 5b located on the main surface 3b on which the portion 13b is disposed, and is separated from the electrode portion 5b. The portion 13b extends along the end edge of the electrode portion 5b. The portion 13b extends in the third direction D3. On the main surface 3b, the portion 13b is separated from the portion 11b. As shown in FIG. 1, in the present example, on the main surface 3b, the portion 13b is separated from the portion 11b in the third direction D3. That is, in the present example, the external conductor 13 is separated from the external conductor 11 on the main surface 3b. The portion 13b and the portion 11b are not physically connected to each other.

The portion 13d is disposed between the electrode portions 5d located on the side surface 3d on which the portion 13d is disposed, and is separated from the electrode portion 5d. The portion 13d extends along the end edge of the electrode portion 5d. The portion 13d extends in the second direction D2.

The external conductor 11 and the external conductor 13 includes a conductor layer 15. The conductor layer 15 includes the portion 11a, the portion 11b, the portion 11c, the portion 13a, the portion 13b, and the portion 13d. The conductor layer 15 includes, for example, a sintered metal layer. In a configuration in which the conductor layer 15 includes a sintered metal layer, the conductor layer 15 includes a metal layer. The conductor layer 15 including the sintered metal layer is formed through baking a conductive paste applied to the surface of the element body 3. The conductor layer 15 includes a sintered metal layer formed on the element body 3. In the present example, the conductor layer 15 includes a sintered metal layer including Cu. The conductive paste includes, for example, particles including Cu, a glass component, an organic binder, and an organic solvent. The conductor layer 15 may include a sintered metal layer made of Ni.

For example, Cu and Ni are conductive materials in which migration is less prone to occur than in silver. The silver includes silver particles included in the second electrode layer E2. Silver is generally a material in which migration is relatively prone to occur. The external electrode 5 includes the second electrode layer E2 in which migration is relatively prone to occur. The external conductor 11 and the external conductor 13 include the conductor layer 15 in which migration is less prone to occur than in the second electrode layer E2. The conductor layer 15 does not substantially include silver.

A plating layer may be formed on the surface of the external conductor 11 and the surface of the external conductor 13. The plating layer may include, for example, the same configuration as the third electrode layer E3.

The conductor layer 15 may include a conductive resin layer. In the configuration in which the conductor layer 15 includes a conductive resin layer, the conductor layer 15 is formed through curing a conductive resin applied onto the element body 3. The conductive resin includes, for example, a resin, a plurality of conductive particles, and an organic solvent. The resin includes, for example, a thermosetting resin. The conductive particles include, for example, metal particles. The metal particles include, for example, copper particles. In the configuration in which the conductor layer 15 includes a conductive resin layer, the conductor layer 15 includes a plurality of copper particles. The thermosetting resin includes, for example, a phenolic resin, an acrylic resin, a silicone resin, an epoxy resin, or a polyimide resin. The conductor layer 15 including the conductive resin layer may include carbon particles as conductive particles. Even in the configuration in which the conductor layer 15 includes the conductive resin layer, the external conductor 11 and the external conductor 13 include the conductor layer 15 in which migration is less prone to occur than in the second electrode layer E2. The conductor layer 15 does not substantially include silver particles.

As shown in FIGS. 3-7, the multilayer capacitor C1 includes a plurality of internal electrodes 7 and a plurality of internal electrodes 9.

Each of the internal electrodes 7 and 9 includes a conductive material that is typically used as an internal conductor of a multilayer electronic component. The conductive material includes, for example, a base metal. The conductive material includes, for example, Ni or Cu. Each of the internal electrodes 7 and 9 is configured as a sintered body of a conductive paste including the above conductive material. In the present example, each of the internal electrodes 7 and 9 is made of Ni.

The internal electrode 7 and the internal electrode 9 are disposed within the element body 3. The internal electrode 7 and the internal electrode 9 are disposed at different positions in the second direction D2. The internal electrode 7 and the internal electrode 9 are disposed in different layers within the element body 3. The internal electrode 7 and the internal electrode 9 are disposed within the element body 3 to oppose each other in the second direction D2. The internal electrode 7 and the internal electrode 9 are alternately disposed within the element body 3 to oppose each other at an interval in the second direction D2. The plurality of internal electrodes 7 and the plurality of internal electrodes 9 are alternately lined up in the second direction D2. The plurality of internal electrodes 7 and 9 are disposed within the element body 3 to be lined up in the second direction D2.

The internal electrode 7 and the internal electrode 9 have polarities different from each other. One of the two ends of each of the internal electrodes 7 and 9 is exposed to a corresponding end surface 3e of the pair of end surfaces 3e. In the present example, each of the internal electrodes 7 includes an end 7a exposed to one end surface 3e of the pair of end surfaces 3e and an end 7b located on the opposite side of the end 7a. Each of the internal electrodes 9 includes an end 9a exposed to the other end surface 3e of the pair of end surfaces 3e and an end 9b located on the opposite side of the end 9a. Each electrode portion 5e covers all corresponding ends of the plurality of ends 7a and 9a. Each electrode portion 5e is directly connected to the corresponding internal electrodes 7 and 9. Each external electrode 5 is electrically connected to the corresponding internal electrodes 7 and 9. In the present example, the plurality of internal electrodes 7 are physically and electrically connected to one external electrode 5. The plurality of internal electrodes 9 are physically and electrically connected to the other external electrode 5.

The internal electrode 7 and the internal electrode 9 are connected to a corresponding external conductor 11 of the pair of external conductors 11 and a corresponding external conductor 13 of the pair of external conductors 13.

The internal electrode 7 is electrically connected to one external conductor 11 and one external conductor 13 that are adjacent to one external electrode 5 to which the internal electrode 7 is physically and electrically connected in the first direction D1. The second electrode layer E2 included in one external electrode 5 is electrically connected to one external conductor 11 and one external conductor 13 through the internal electrode 7.

The internal electrode 9 is electrically connected to the other external conductor 11 and the other external conductor 13 that are adjacent to the other external electrode 5 to which the internal electrode 9 is physically and electrically connected in the first direction D1. The second electrode layer E2 included in the other external electrode 5 is electrically connected to the other external conductor 11 and the other external conductor 13 through the internal electrode 9.

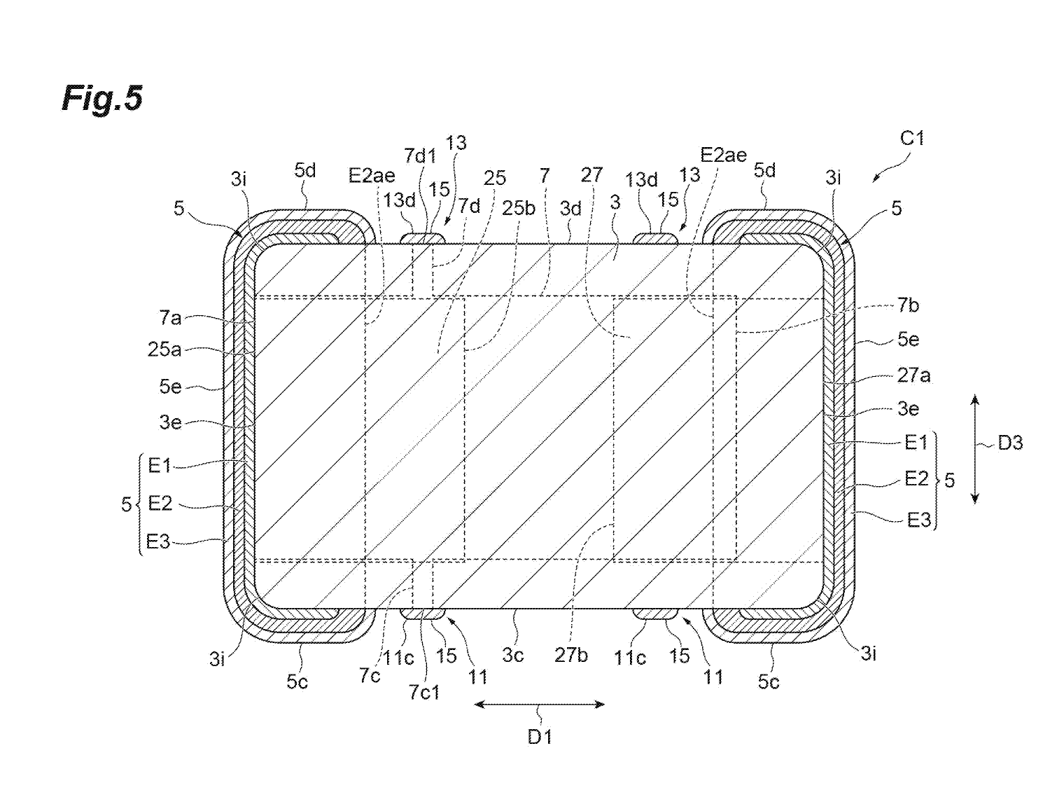

The internal electrode 7 includes a connecting portion 7c and a connecting portion 7d. The connecting portion 7c is exposed to the side surface 3c. The connecting portion 7c includes an end 7c1 exposed to the side surface 3c. As shown in FIGS. 5 and 6, the connecting portion 7c is physically and electrically connected to the portion 11c at the end 7c1 exposed to the side surface 3c. Thereby, the internal electrode 7 is connected to one external conductor 11. That is, the internal electrode 7 includes the end 7c1 that is exposed to the side surface 3c and connected to one external conductor 11.

The connecting portion 7d is exposed to the side surface 3d. The connecting portion 7d includes an end 7d1 exposed to the side surface 3d. The connecting portion 7d is physically and electrically connected to a portion 13c at the end 7d1 exposed to the side surface 3d. Thereby, the internal electrode 7 is connected to one external conductor 13. That is, the internal electrode 7 includes the end 7d1 that is exposed to the side surface 3d and connected to one external conductor 13.

The internal electrodes 7 are physically connected to a corresponding external conductor 11 and a corresponding external conductor 13 at a plurality of locations. In the present example, all the internal electrodes 7 are physically connected to the corresponding external conductor 11 and the corresponding external conductor 13. However, not all the internal electrodes 7 need to be physically connected to the corresponding external conductor 11 and the corresponding external conductor 13. At least one internal electrode 7 of the plurality of internal electrodes 7 need only be physically connected to the corresponding external conductor 11 and the corresponding external conductor 13.

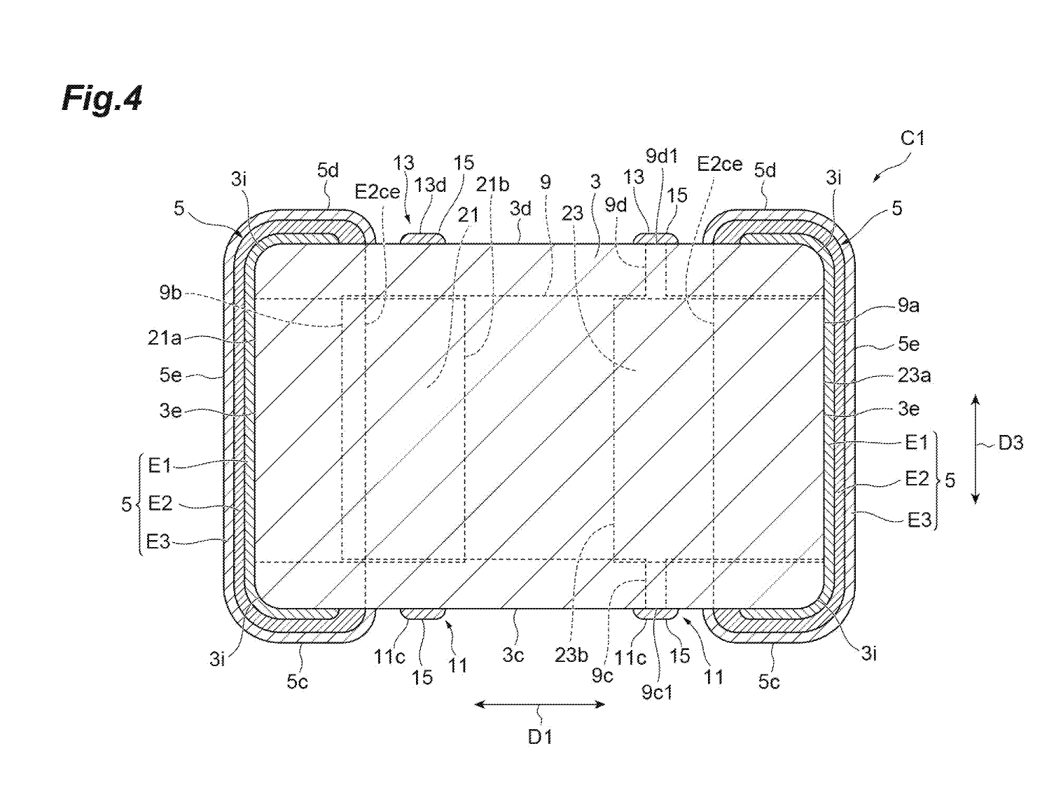

The internal electrode 9 includes a connecting portion 9c and a connecting portion 9d. The connecting portion 9c is exposed to the side surface 3c. The connecting portion 9c includes an end 9c1 exposed to the side surface 3c. As shown in FIGS. 4 and 7, the connecting portion 9c is physically and electrically connected to the portion 11c at the end 9c1 exposed on the side surface 3c. Thereby, the internal electrode 9 is connected to the other external conductor 11. That is, the internal electrode 9 includes the end 9c1 that is exposed to the side surface 3c and connected to the other external conductor 11.

The connecting portion 9d is exposed to the side surface 3d. The connecting portion 9d includes an end 9d1 exposed to the side surface 3d. The connecting portion 9d is physically and electrically connected to the portion 13c at the end 9d1 exposed to the side surface 3d. Thereby, the internal electrode 9 is connected to the other external conductor 13. That is, the internal electrode 9 includes the end 9d1 that is exposed to the side surface 3d and connected to the other external conductor 13.

The internal electrodes 9 are physically connected to a corresponding external conductor 11 and a corresponding external conductor 13 at a plurality of locations. In the present example, all the internal electrodes 9 are physically connected to the corresponding external conductor 11 and the corresponding external conductor 13. However, not all the internal electrodes 9 need to be physically connected to the corresponding external conductor 11 and the corresponding external conductor 13. At least one internal electrode 9 of the plurality of internal electrodes 9 need only be physically connected to the corresponding external conductor 11 and the corresponding external conductor 13.

As shown in FIGS. 3-5, the multilayer capacitor C1 includes a plurality of internal conductors 21, 23, 25, and 27. In FIGS. 4 and 5, for the purpose of description, the internal electrodes 7 and 9 and the internal conductors 21, 23, 25, and 27 are intentionally illustrated shifted from one another in the third direction D3.

Each of the internal conductors 21, 23, 25, and 27 includes, for example, the same conductive material as the conductive material included in the internal electrodes 7 and 9. Each of the internal conductors 21, 23, 25, and 27 is configured as a sintered body of a conductive paste including the above conductive material. In the present example, each of the internal conductors 21, 23, 25, and 27 includes Ni.

The internal conductors 21, 23, 25, and 27 are disposed within the element body 3. In the present example, as shown in FIG. 3, the internal conductors 21 and 23 are disposed between the internal electrode 9 closest to the main surface 3b and the main surface 3b, and the internal conductors 25 and 27 are disposed between the internal electrode 7 closest to the main surface 3a and the main surface 3a.

The internal conductor 21 and the internal conductor 23 are disposed at the same position in the second direction D2 between the main surface 3b and the internal electrode 9 closest to the main surface 3b. The internal conductor 21 and the internal conductor 23 are disposed in the same layer within the element body 3. The internal conductor 21 and the internal conductor 23 are separated from each other in the second direction D2. The internal conductor 21 is located closer to one end surface 3e than the internal conductor 23, and the internal conductor 23 is located closer to the other end surface 3e than the internal conductor 21. The internal conductor 21 positioned closer to one end surface 3e than the internal conductor 23, and the internal conductor 23 positioned closer to the other end surface 3e than the internal conductor 21. The internal conductor 21 and the internal conductor 23 oppose the internal electrode 9 closest to the main surface 3b in the second direction D2. The internal electrode 9 closest to the main surface 3b includes a portion opposing the internal conductor 21 and a portion opposing the internal conductor 23.

The length of the internal conductors 21 and 23 in the first direction D1 is smaller than the length of internal electrodes 7 and 9 in the first direction D1. The distance between the internal conductors 21 and 23 and the main surface 3b in the second direction D2 is, for example, equal to or greater than 0.01 mm and equal to or less than 0.32 mm. The above distance between the internal conductors 21 and 23 and the main surface 3b may be smaller than the distance between the internal conductors 21 and 23 and the internal electrode 9 closest to the main surface 3b in the second direction D2. The above distance between the internal conductors 21 and 23 and the main surface 3b may be smaller than the interval between the internal electrode 7 and the internal electrode 9 in the second direction D2.

The internal conductor 25 and the internal conductor 27 are disposed at the same position in the second direction D2 between the main surface 3a and the internal electrode 7 closest to the main surface 3a. The internal conductor 25 and the internal conductor 27 are disposed in the same layer within the element body 3. The internal conductor 25 and the internal conductor 27 are separated from each other in the second direction D2. The internal conductor 25 is located closer to one end surface 3e than the internal conductor 27, and the internal conductor 27 is located closer to the other end surface 3e than the internal conductor 25. The internal conductor 25 positioned closer to one end surface 3e than the internal conductor 27, and the internal conductor 27 positioned closer to the other end surface 3e than the internal conductor 25. The internal conductor 25 and the internal conductor 27 oppose the internal electrode 7 closest to the main surface 3a in the second direction D2. The internal electrode 7 closest to the main surface 3a includes a portion opposing the internal conductor 25 and a portion opposing the internal conductor 27.

The length of the internal conductors 25 and 27 in the first direction D1 is smaller than the length of the internal electrodes 7 and 9 in the first direction D1. The distance between the internal conductors 25 and 27 and the main surface 3a in the second direction D2 is, for example, equal to or greater than 0.01 mm and equal to or less than 0.32 mm. The above distance between the internal conductors 25 and 27 and the main surface 3a may be smaller than the distance between the internal conductors 25 and 27 and the internal electrode 7 closest to the main surface 3a in the second direction D2. The above distance between the internal conductors 25 and 27 and the main surface 3a may be smaller than the interval between the internal electrode 7 and the internal electrode 9 in the second direction D2.

In the present example, one of the two ends of the internal conductor 21 is exposed to a corresponding end surface out of the pair of end surfaces 3e. The internal conductor 21 includes an end 21a and an end 21b. In the present example, the end 21a is exposed to an end surface 3e of the pair of end surfaces 3e on which the end 9a of the internal electrode 9 closest to the main surface 3b is not exposed. The end 21b is located on the opposite side of the end 21a, and is not exposed to the surface of the element body 3. The electrode portion 5e entirely covers the end 21a. The electrode portion 5e is directly connected to the internal conductor 21. The electrode portion 5e is electrically connected to the internal conductor 21. In the present example, the internal conductor 21 is physically and electrically connected to one external electrode 5. The internal conductor 21 is also electrically connected to one external conductor 11 and one external conductor 13 through the one external electrode 5 and the internal electrode 7 connected to the external electrode 5. The one external electrode 5 is an external electrode to which the internal electrode 9 closest to the main surface 3b is not electrically connected. That is, the internal conductor 21 and the internal electrode 9 adjacent to the internal conductor 21 are connected to the external electrodes 5 different from each other. The internal conductor 21 and the internal electrode 9 closest to the main surface 3b are not electrically connected to each other.

In the present example, one of the two ends of the internal conductor 23 is exposed to a corresponding end surface of the pair of end surfaces 3e. The internal conductor 23 includes an end 23a and an end 23b. In the present example, the end 23a is exposed to an end surface 3e of the pair of end surfaces 3e on which the end 9a of the internal electrode 9 closest to the main surface 3b is exposed. The end 23b is located on the opposite side of the end 23a and is not exposed to the surface of the element body 3. The electrode portion 5e entirely covers the end 23a. The electrode portion 5e is directly connected to the internal conductor 23. The electrode portion 5e is electrically connected to the internal conductor 23. In the present example, the internal conductor 23 is physically and electrically connected to the other external electrode 5. The internal conductor 23 is also electrically connected to the other external conductor 11 and the other external conductor 13 through the other external electrode 5 and the internal electrode 9 connected to the external electrode 5. The other external electrode 5 is an external electrode to which the internal electrode 9 closest to the main surface 3b is electrically connected. That is, the internal conductor 23 and the internal electrode 9 adjacent to the internal conductor 23 are connected to the same external electrode 5. Therefore, the internal conductor 23 tends not to contribute to the formation of capacitance.

In the present example, one of the two ends of the internal conductor 25 is exposed to a corresponding end surface of the pair of end surfaces 3e. The internal conductor 25 includes an end 25a and an end 25b. In the present example, the end 25a is exposed to an end surface 3e of the pair of end surfaces 3e on which the end 7a of the internal electrode 7 closest to the main surface 3a is exposed. The end 25b is located on the opposite side of the end 25a and is not exposed to the surface of the element body 3. The electrode portion 5e entirely covers the end 25a. The electrode portion 5e is directly connected to the internal conductor 25. The electrode portion 5e is electrically connected to the internal conductor 25. In the present example, the internal conductor 25 is physically and electrically connected to one external electrode 5. The internal conductor 25 is also electrically connected to one external conductor 11 and one external conductor 13 through the one external electrode 5 and the internal electrode 7 connected to the external electrode 5. The one external electrode 5 is an external electrode to which the internal electrode 7 closest to the main surface 3a is electrically connected. That is, the internal conductor 25 and the internal electrode 7 adjacent to the internal conductor 25 are connected to the same external electrode 5. Therefore, the internal conductor 25 tends not to contribute to the formation of capacitance.

In the present example, one of the two ends of the internal conductor 27 is exposed to a corresponding end surface of the pair of end surfaces 3e. The internal conductor 27 includes an end 27aand an end 27b. In the present example, the end 27a is exposed to an end surface 3e of the pair of end surfaces 3e on which the end 7a of the internal electrode 7 closest to the main surface 3a is not exposed. The end 27b is located on the opposite side of the end 27a and is not exposed to the surface of the element body 3. The electrode portion 5e entirely covers the end 27a. The electrode portion 5e is directly connected to the internal conductor 27. The electrode portion 5e is electrically connected to the internal conductor 27. In the present example, the internal conductor 27 is physically and electrically connected to the other external electrode 5. The internal conductor 27 is also electrically connected to the other external conductor 11 and the other external conductor 13 through the other external electrode 5 and the internal electrode 9 connected to the external electrode 5. The other external electrode 5 is an external electrode to which the internal electrode 7 closest to the main surface 3a is not electrically connected. That is, the internal conductor 27 and the internal electrode 7 adjacent to the internal conductor 27 are connected to the external electrodes 5 different from each other. The internal conductor 27 and the internal electrode 7 closest to the main surface 3a are not electrically connected to each other.

When viewed from the second direction D2, the internal conductor 21 overlaps the external electrode 5 that is not electrically connected to the internal electrode 9 closest to the main surface 3b and the internal electrode 9 closest to the main surface 3a. As shown in FIG. 4, in the present example, when viewed from the second direction D2, the internal conductor 21 overlaps the end E2ce of the layer portion E2c of the external electrode 5 that is not electrically connected to the internal electrode 9 closest to the main surface 3b and the end 9b of the internal electrode 9 closest to the main surface 3b. When viewed from the second direction D2, the end 21b of the internal conductor 21 is located closer to the end surface 3e on which the end 9a is exposed than the end E2ce and the end 9b. When viewed from the second direction D2, the end 9b of the internal electrode 9 closest to the main surface 3b is located closer to the end surface 3e on which the end 9a is not exposed than the end E2ce of the layer portion E2c of the external electrode 5 that is not electrically connected to the internal electrode 9.

When viewed from the second direction D2, the internal conductor 27 overlaps the external electrode 5 that is not electrically connected to the internal electrode 7 closest to the main surface 3a and the internal electrode 7 closest to the main surface 3a. As shown in FIG. 5, in the present example, when viewed from the second direction D2, the internal conductor 27 overlaps the end E2ae of the layer portion E2a of the external electrode 5 that is not electrically connected to the internal electrode 7 closest to the main surface 3a and the end 7b of the internal electrode 7 closest to the main surface 3a. When viewed from the second direction D2, the end 27b of the internal conductor 27 is located closer to the end surface 3e on which the end 7a is exposed than the end E2ae and the end 7b. When viewed from the second direction D2, the end 7b of the internal electrode 7 closest to the main surface 3a is located closer to the end surface 3e on which the end 7a is not exposed than the end E2ae of the layer portion E2a of the external electrode 5 that is not electrically connected to the internal electrode 7.

In the multilayer capacitor C1, the second electrode layer E2 included in the external electrode 5 and the conductor layer 15 included in the external conductor 11 adjacent to the external electrode 5 in the first direction D1 are electrically connected to each other. When an electric field acts on the second electrode layer E2, the electric field acts not only on the second electrode layer E2 but also the conductor layer 15 electrically connected to the second electrode layer E2. The electric field tends not to be concentrated on the second electrode layer E2, and the conductor layer 15 reduces the electric field acting on the second electrode layer E2. Therefore, even when the electric field acts on the second electrode layer E2, the metal included in the second electrode layer E2 tends not to be ionized. Migration tend not to occur in the second electrode layer E2.

Migration is less prone to occur in the conductor layer 15 than in the second electrode layer E2. Therefore, even when the electric field acts on the conductor layer 15, migration tends not to occur in the conductor layer 15.

In the multilayer capacitor C1, one external conductor 11 is located between one external electrode 5 and the other external conductor 11 on the side surface 3c. The conductor layer 15 included in one external conductor 11 and the second electrode layer E2 included in one external electrode 5 are electrically connected to each other. Therefore, even when migration occurs in the second electrode layer E2 of the electrode portion 5c included in one external electrode 5, one external conductor 11 prevents the proceeding of migration. In the multilayer capacitor C1, the other external conductor 11 is located between the other external electrode 5 and one external conductor 11 on the side surface 3c. The conductor layer 15 included in the other external conductor 11 and the second electrode layer E2 included in the other external electrode 5 are electrically connected to each other. Therefore, even when migration occurs in the second electrode layer E2 of the electrode portion 5c included in the other external electrode 5, the other external conductor 11 prevents the proceeding of migration.

In the multilayer capacitor C1, the internal conductor 21 electrically connected to one external electrode 5 and one external conductor 11 is disposed between the main surface 3b and the internal electrode 9 closest to the main surface 3b. Therefore, the internal electrode 9 closest to the main surface 3b and the second electrode layer E2 of the electrode portion 5b included in the other external electrode 5 are not electrically connected to each other, but tend not to oppose each other in the second direction D2. For the above reasons, the internal conductor 21 prevents generation of the electric field between the second electrode layer E2 and the internal electrode 9 closest to the main surface 3b that are not electrically connected to each other.

As a result, the multilayer capacitor C1 controls the proceeding of migration.

In the multilayer capacitor C1, one external conductor 13 is located between one external electrode 5 and the other external conductor 13 on the side surface 3d. The conductor layer 15 included in one external conductor 13 and the second electrode layer E2 included in one external electrode 5 are electrically connected to each other. Therefore, even when migration occurs in the second electrode layer E2 of the electrode portion 5d included in one external electrode 5, one external conductor 13prevents the proceeding of migration. In the multilayer capacitor C1, the other external conductor 13 is located between the other external electrode 5 and one external conductor 13 on the side surface 3c. The conductor layer 15 included in the other external conductor 13 and the second electrode layer E2 included in the other external electrode 5 are electrically connected to each other. Therefore, even when migration occurs in the second electrode layer E2 of the electrode portion 5d included in the other external electrode 5, the other external conductor 13 prevents the proceeding of migration.

In the multilayer capacitor C1, the internal conductor 27 electrically connected to the other external electrode 5 and the other external conductor 11 is disposed between the main surface 3a and the internal electrode 7 closest to the main surface 3a. Therefore, the internal electrode 7 closest to the main surface 3a and the second electrode layer E2 of the electrode portion 5a included in one external electrode 5 are not electrically connected to each other, but tend not to oppose each other in the second direction D2. For the above reasons, the internal conductor 27 prevents generation of the electric field generated between the second electrode layer E2 and the internal electrode 7 closest to the main surface 3a that are not electrically connected to each other.

As a result, the multilayer capacitor C1 further controls the proceeding of migration.

In the multilayer capacitor C1, the external conductor 11 may be disposed only on the side surface 3c, and the external conductor 13 disposed only on the side surface 3d. In the configuration in which the external conductor 11 is disposed only on the side surface 3c and the external conductor 13 is disposed only on the side surface 3d, the external conductor 11 and the external conductor 13 are formed through applying the conductive paste or a conductive resin to the side surface 3c and the side surface 3d. Therefore, the configuration in which the external conductor 11 is disposed only on the side surface 3c and the external conductor 13 is disposed only on the side surface 3d makes it possible to easily form the external conductor 11 and the external conductor 13.

In the multilayer capacitor C1, the internal conductor 21 includes the end 21a that is exposed to one end surface 3e and connected to one external electrode 5.

In the multilayer capacitor C1, the internal electrode 9 that is electrically connected to one external electrode 5 and closest to the main surface 3b, and the second electrode layer E2 of the electrode portion 5b included in the other external electrode 5 further tend not to oppose each other in the second direction D2. For the above reasons, the internal conductor 21 further prevents generation of the electric field between the second electrode layer E2 and the internal electrode 9 closest to the main surface 3b that are not electrically connected to each other. As a result, the multilayer capacitor C1 further controls the proceeding of migration.

In the multilayer capacitor C1, the internal conductor 27 includes the end 27a that is exposed to the other end surface 3e and connected to the other external electrode 5.

In the multilayer capacitor C1, the internal electrode 7 closest to the main surface 3a and the second electrode layer E2 of the electrode portion 5a included in the other external electrode 5 that is not electrically connected to the internal electrode 7 closest to the main surface 3a further tend not to oppose each other in the second direction D2. For the above reasons, the internal conductor 27 further prevents generation of the electric field between the second electrode layer E2 and the internal electrode 7 closest to the main surface 3a that are not electrically connected to each other. As a result, the multilayer capacitor C1 further controls the proceeding of migration.

In the multilayer capacitor C1, when viewed from the second direction D2, the internal conductor 21 that is not electrically connected to the internal electrode 9 closest to the main surface 3b overlaps the end E2ce of the layer portion E2c of one external electrode 5 that is not electrically connected to the internal electrode 9 closest to the main surface 3b and the end 9b of the internal electrode 9 closest to the main surface 3b.

In the multilayer capacitor C1, the internal electrode 9 closest to the main surface 3b and the second electrode layer E2 of the electrode portion 5b included in one external electrode 5 that is not electrically connected to the internal electrode 9 closest to the main surface 3b further tend not to oppose each other in the second direction D2. For the above reasons, the internal conductor 21 that is not electrically connected to the internal electrode 9 closest to the main surface 3b further prevents generation of the electric field between the second electrode layer E2 and the internal electrode 9 closest to the main surface 3b that are not electrically connected to each other. As a result, the multilayer capacitor C1 further controls the proceeding of migration.

In the multilayer capacitor C1, when viewed from the second direction D2, the internal conductor 27 that is not electrically connected to the internal electrode 7 closest to the main surface 3a overlaps the end E2ae of the layer portion E2a of the other external electrode 5 that is not electrically connected to the internal electrode 7 closest to the main surface 3a and the end 7b of the internal electrode 7 closest to the main surface 3a.

In the multilayer capacitor C1, the internal electrode 7 closest to the main surface 3a and the second electrode layer E2 of the electrode portion 5a included in the other external electrode 5 that is not electrically connected to the internal electrode 7 closest to the main surface 3a further tends not to oppose each other in the second direction D2. For the above reasons, the internal conductor 27 that is not electrically connected to the internal electrode 7 closest to the main surface 3a further prevents generation of the electric field between the electrode layer and the internal electrode closest to the main surface 3a that are not electrically connected to each other. As a result, the multilayer capacitor C1 further controls the proceeding of migration.

In the multilayer capacitor C1, the second electrode layer E2 includes a conductive resin layer including a plurality of silver particles, and the conductor layer 15 includes a metal layer in which migration is less prone to occur than in silver.

The multilayer capacitor C1 reliably controls the proceeding of migration even in the configuration in which the conductive resin layer included in the second electrode layer E2 includes a plurality of silver particles.

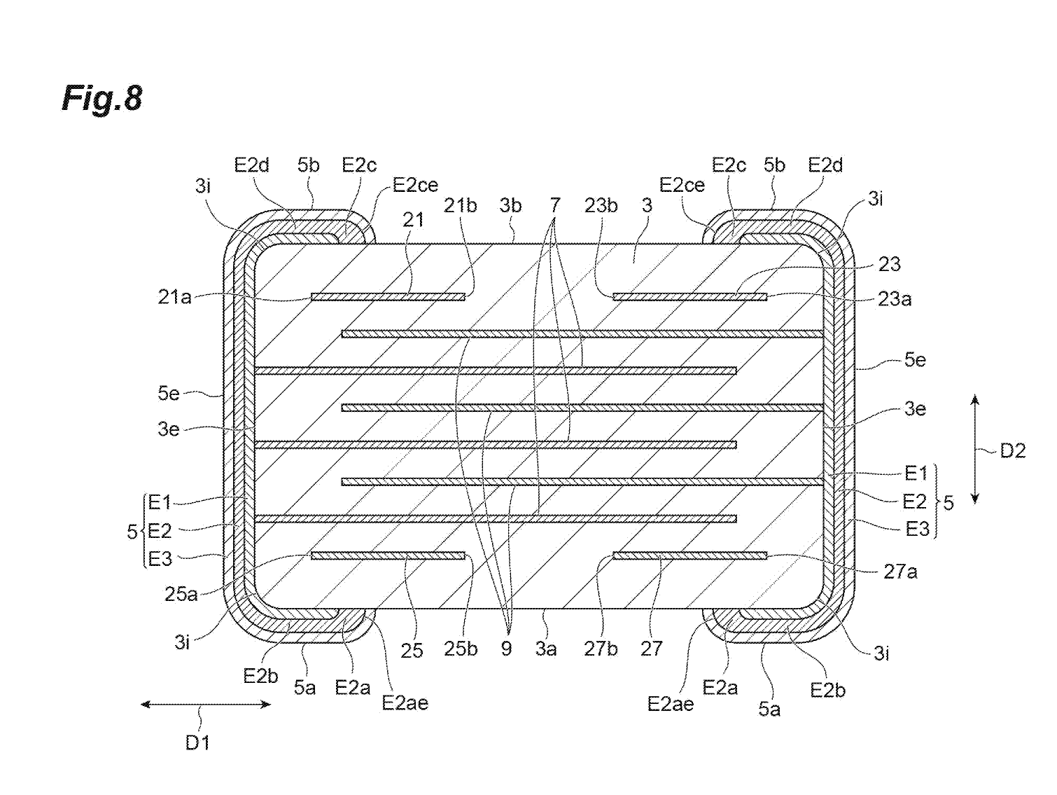

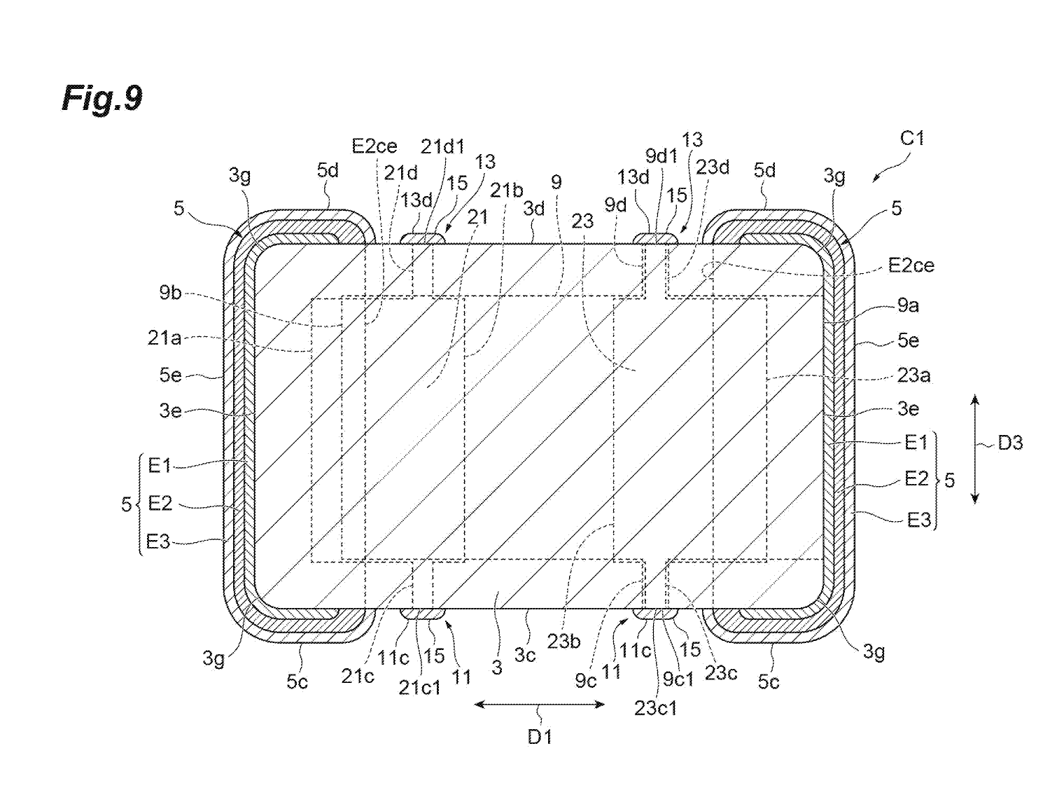

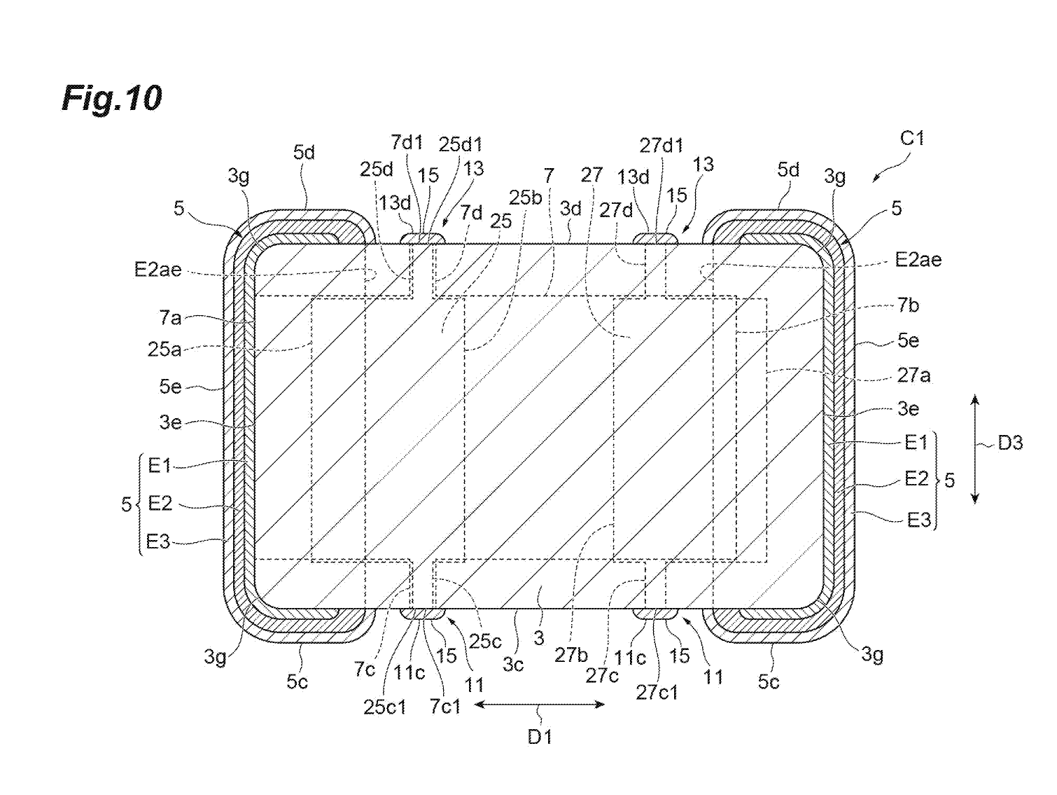

Next, the configuration of a multilayer capacitor C1 according to one modification example of the first example will be described with reference to FIGS. 8-12. FIGS. 8, 9, 10, 11 and 12 are diagrams illustrating cross-sectional configurations of a multilayer capacitor according to one modification example of the first example. The multilayer capacitor C1 according to the present modification example is generally similar to or the same as the multilayer capacitor C1 according to the first example described above, but the present modification example differs from the first example described above in terms of the configurations of the internal conductors 21, 23, 25, and 27. Hereinafter, differences between the first example described above and the present modification example will be mainly described. In FIGS. 9 and 10, for the purpose of description, the internal electrodes 7 and 9 and the internal conductors 21, 23, 25, and 27 are intentionally shown shifted from one another in the third direction D3.

As shown in FIG. 8, in the present modification example, the end 21a of the internal conductor 21 is located within the element body 3 and is not exposed to the surface of the element body 3. In the present modification example, the internal conductor 21 is not directly connected to the electrode portion 5e. That is, in the present modification example, the internal conductor 21 is not physically connected to the external electrode 5.

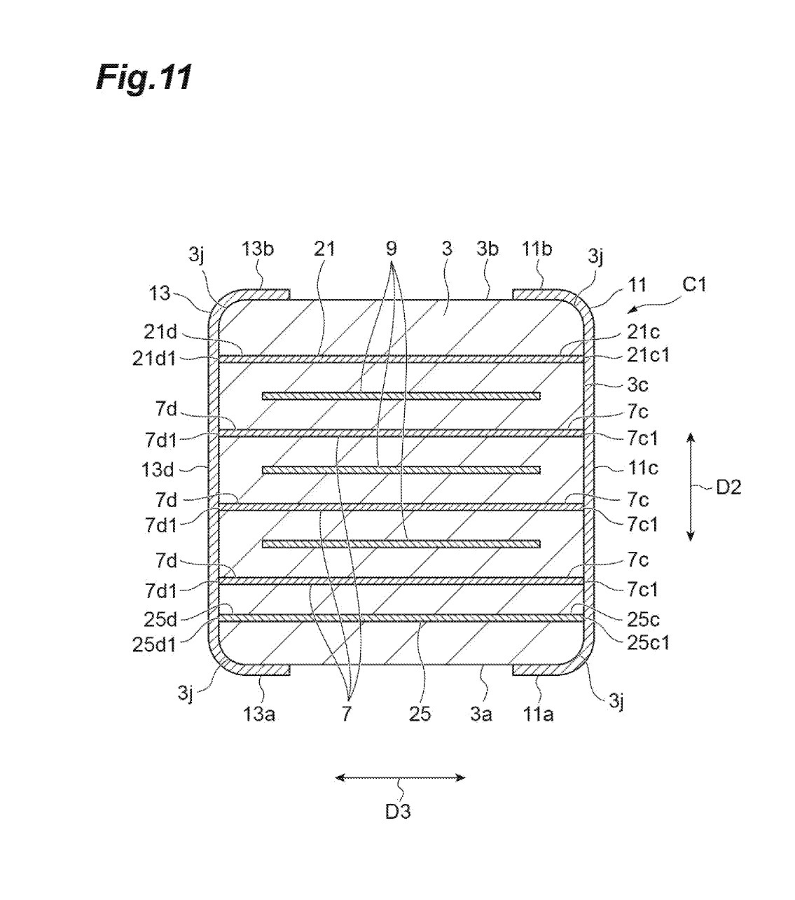

In the present modification example, the internal conductor 21 includes a connecting portion 21c and a connecting portion 21d. The connecting portion 21c is exposed to the side surface 3c. The connecting portion 21c includes an end 21c1 exposed to the side surface 3c. As shown in FIGS. 9 and 11, the connecting portion 21c is physically and electrically connected to the portion 11c at the end 21c1 exposed to the side surface 3c. That is, in the present modification example, the internal conductor 21 is physically and electrically connected to one external conductor 11. Thereby, the internal conductor 21 is connected to one external conductor 11. That is, the internal conductor 21 includes the end 21c1 that is exposed to the side surface 3c and connected to one external conductor 11.

The connecting portion 21d is exposed to the side surface 3d. The connecting portion 21d is exposed to, for example, the side surface 3d at the same position as the position where the connecting portion 21c is exposed to the side surface 3c in the first direction D1. The connecting portion 21d includes an end 21d1 exposed to the side surface 3d. The connecting portion 21d is physically and electrically connected to the portion 13d at the end 21d1 exposed to the side surface 3d. That is, in the present modification example, the internal conductor 21 is physically and electrically connected to one external conductor 13. Thereby, the internal conductor 21 is connected to one external conductor 13. That is, the internal conductor 21 includes the end 21d1 that is exposed to the side surface 3d and connected to one external conductor 13.

In the present modification example, the internal conductor 21 is also electrically connected to one external electrode 5 through the external conductors 11 and 13 and the internal electrode 7 connected to the external conductors 11 and 13. The one external electrode 5 is an external electrode to which the internal electrode 9 closest to the main surface 3b is not electrically connected.

In the present modification example, the end 23a of the internal conductor 23 is located within the element body 3 and is not exposed to the surface of the element body 3. In the present modification example, the internal conductor 23 is not directly connected to the electrode portion 5e. That is, in the present modification example, the internal conductor 23 is not physically connected to the external electrode 5.

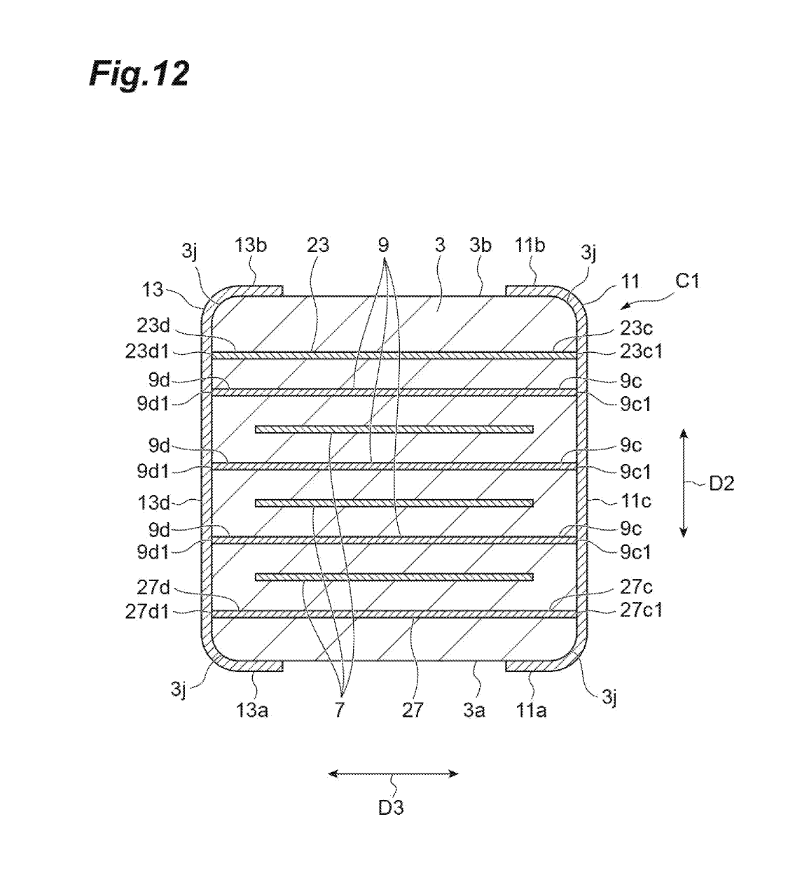

In the present modification example, the internal conductor 23 includes a connecting portion 23c and a connecting portion 23d. The connecting portion 23c is exposed to the side surface 3c. The connecting portion 23c includes an end 23c1 exposed to the side surface 3c. As shown in FIGS. 9 and 12, the connecting portion 23c is physically and electrically connected to the portion 11c at the end 23c1 exposed to the side surface 3c. That is, in the present modification example, the internal conductor 23 is physically and electrically connected to the other external conductor 11. Thereby, the internal conductor 23 is connected to the other external conductor 11. That is, the internal conductor 23 includes the end 23c1 that is exposed to the side surface 3c and connected to the other external conductor 11.

The connecting portion 23d is exposed to the side surface 3d. The connecting portion 23d is exposed to, for example, the side surface 3d at the same position as the position where the connecting portion 23c is exposed to the side surface 3c in the first direction D1. The connecting portion 23d includes an end 23d1 exposed to the side surface 3d. The connecting portion 23d is physically and electrically connected to the portion 13d at the end 23d1 exposed to the side surface 3d. That is, in the present modification example, the internal conductor 23 is physically and electrically connected to the other external conductor 13. Thereby, the internal conductor 23 is connected to the other external conductor 13. That is, the internal conductor 23 includes the end 23d1 that is exposed to the side surface 3d and connected to the other external conductor 13.

In the present modification example, the internal conductor 23 is also electrically connected to the other external electrode 5 through the external conductors 11 and 13 and the internal electrode 9 connected to the external conductors 11 and 13. The other external electrode 5 is an external electrode to which the internal electrode 9 closest to the main surface 3b is electrically connected.

In the present modification example, the end 25a of the internal conductor 25 is located within the element body 3 and is not exposed to the surface of the element body 3. In the present modification example, the internal conductor 25 is not directly connected to the electrode portion 5e. That is, in the present modification example, the internal conductor 25 is not physically connected to the external electrode 5.

In the present modification example, the internal conductor 25 includes a connecting portion 25c and a connecting portion 25d. The connecting portion 25c is exposed to the side surface 3c. The connecting portion 25c includes an end 25c1 exposed to the side surface 3c. As shown in FIGS. 10 and 11, the connecting portion 25c is physically and electrically connected to the portion 11c at the end 25c1 exposed to the side surface 3c. That is, in the present modification example, the internal conductor 25 is physically and electrically connected to one external conductor 11. Thereby, the internal conductor 25 is connected to one external conductor 11. That is, the internal conductor 25 includes the end 25c1 that is exposed to the side surface 3c and connected to one external conductor 11.

The connecting portion 25d is exposed to the side surface 3d. The connecting portion 25d is exposed to, for example, the side surface 3d at the same position as the position where the connecting portion 25c is exposed to the side surface 3c in the first direction D1. The connecting portion 25d includes an end 25d1 exposed to the side surface 3d. The connecting portion 25d is physically and electrically connected to the portion 13d at the end 25d1 exposed on the side surface 3d. That is, in the present modification example, the internal conductor 25 is physically and electrically connected to one external conductor 13. Thereby, the internal conductor 25 is connected to one external conductor 13. That is, the internal conductor 25 includes the end 25d1 that is exposed to the side surface 3d and connected to one external conductor 13.

In the present modification example, the internal conductor 25 is also electrically connected to one external electrode 5 through the external conductors 11 and 13 and the internal electrode 7 connected to the external conductors 11 and 13. The one external electrode 5 is an external electrode to which the internal electrode 7 closest to the main surface 3a is electrically connected.

In the present modification example, the end 27a of the internal conductor 27 is located within the element body 3 and is not exposed to the surface of the element body 3. In the present modification example, the internal conductor 27 is not directly connected to the electrode portion 5e. That is, in the present modification example, the internal conductor 27 is not physically connected to the external electrode 5.

In the present modification example, the internal conductor 27 includes a connecting portion 27c and a connecting portion 27d. The connecting portion 27c is exposed to the side surface 3c. The connecting portion 27c includes an end 27c1 exposed to the side surface 3c. As shown in FIGS. 10 and 12, the connecting portion 27c is physically and electrically connected to the portion 11c at the end 27c1 exposed to the side surface 3c. That is, in the present modification example, the internal conductor 27 is physically and electrically connected to the other external conductor 11. Thereby, the internal conductor 27 is connected to the other external conductor 11. That is, the internal conductor 27 includes the end 27c1 that is exposed to the side surface 3c and connected to the other external conductor 11.

The connecting portion 27d is exposed to the side surface 3d. The connecting portion 27d is exposed to, for example, the side surface 3d at the same position at the position where the connecting portion 27c is exposed to the side surface 3c in the first direction D1. The connecting portion 27d includes an end 27d1 exposed to the side surface 3d. The connecting portion 27d is physically and electrically connected to the portion 13d at the end 27d1 exposed to the side surface 3d. That is, in the present modification example, the internal conductor 27 is physically and electrically connected to the other external conductor 13. Thereby, the internal conductor 27 is connected to the other external conductor 13. That is, the internal conductor 27 includes the end 27d1 that is exposed to the side surface 3d and connected to the other external conductor 13.

In the present modification example, the internal conductor 27 is also electrically connected to the other external electrode 5 through the external conductors 11 and 13 and the internal electrode 9 connected to the external conductors 11 and 13. The other external electrode 5 is an external electrode to which the internal electrode 7 closest to the main surface 3a is not electrically connected.

In the present modification example, the internal conductor 21 includes the end 21c1 that is exposed to the side surface 3c and connected to one external conductor 11, and the end 21d1 that is exposed to the side surface 3d and connected to one external conductor 13. The multilayer capacitor C1 controls the occurrence of cracks at the interface between the end 21c1 and the element body 3 on the side surface 3c, and controls the occurrence of cracks at the interface between the end 21d1 and the element body 3 on the side surface 3d.

The internal conductor 23 includes the end 23c1 that is exposed to the side surface 3c and connected to the other external conductor 11, and the end 23d1 that is exposed to the side surface 3d and connected to the other external conductor 13. The multilayer capacitor C1 controls the occurrence of cracks at the interface between the end 23c1 and the element body 3 on the side surface 3c, and controls the occurrence of cracks at the interface between the end 23d1 and the element body 3 on the side surface 3d.

The internal conductor 25 includes the end 25c1 that is exposed to the side surface 3c and connected to one external conductor 11, and the end 25d1 that is exposed to the side surface 3d and connected to one external conductor 13. The multilayer capacitor C1 controls the occurrence of cracks at the interface between the end 25c1 and the element body 3 on the side surface 3c, and controls the occurrence of cracks at the interface between the end 25d1 and the element body 3 on the side surface 3d.

The internal conductor 27 includes the end 27c1 that is exposed to the side surface 3c and connected to the other external conductor 11, and the end 27d1 that is exposed to the side surface 3d and connected to the other external conductor 13. The multilayer capacitor C1 controls the occurrence of cracks at the interface between the end 27c1 and the element body 3 on the side surface 3c, and controls the occurrence of cracks at the interface between the end 27d1 and the element body 3 on the side surface 3d.

As a result, the multilayer capacitor C1 controls the occurrence of cracks in the element body 3.

### Second example

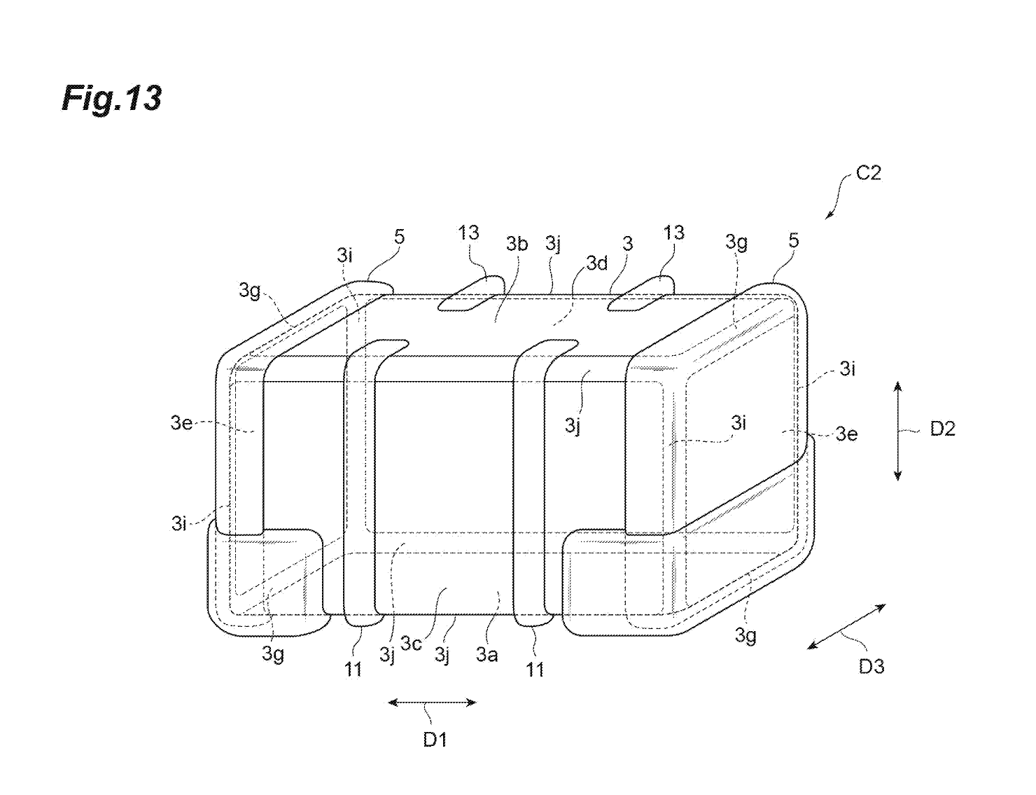

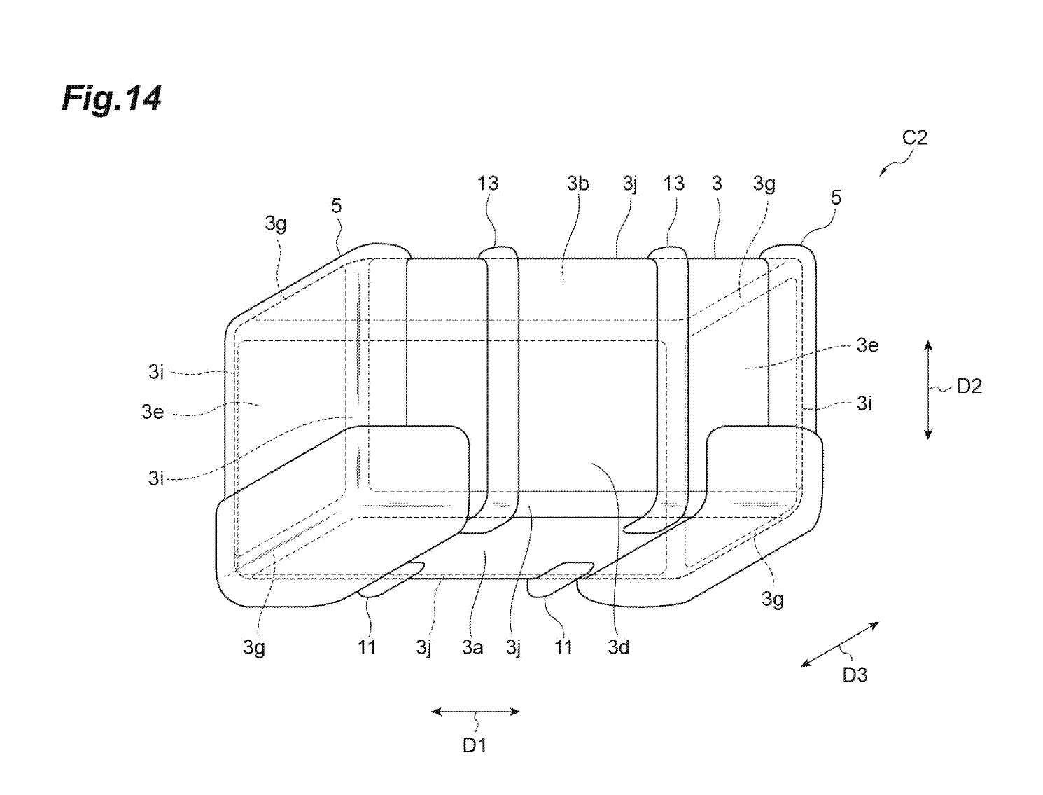

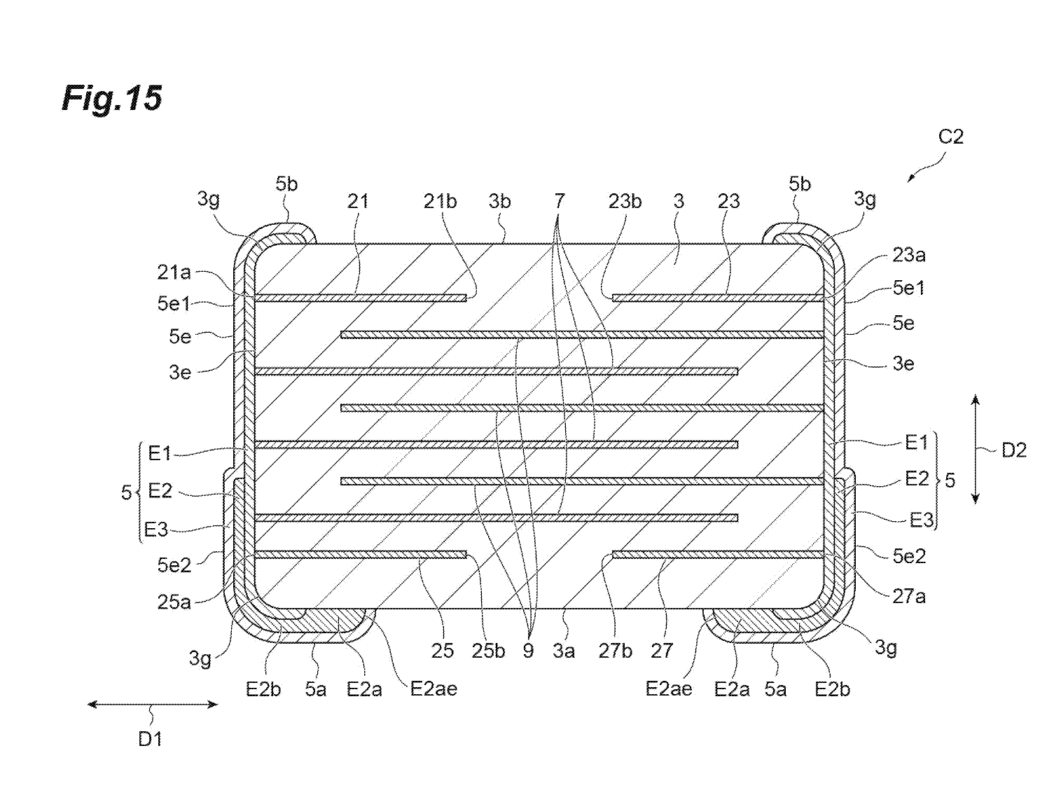

A configuration of a multilayer capacitor C2 according to a second example will be described with reference to FIGS. 13-17. FIGS. 13 and 14 are perspective views of a multilayer capacitor according to the second example. FIGS. 15, 16 and 17 are diagrams illustrating cross-sectional configurations of the multilayer capacitor according to the second example.

In the second example, the electronic component is, for example, a multilayer capacitor C2. The multilayer capacitor C2 is generally similar to or the same as the multilayer capacitor C1, but the multilayer capacitor C2 differs from the multilayer capacitor C1 in terms of the configurations of the plurality of external electrodes 5, the plurality of internal electrodes 7 and 9, and the internal conductors 21, 23, 25, and 27. Hereinafter, differences between the multilayer capacitor C1 and the multilayer capacitor C2 will be mainly described.

As shown in FIGS. 11-15, the multilayer capacitor C2 includes the element body 3, a plurality of external electrodes 5, a plurality of internal electrodes 7, a plurality of internal electrodes 9, a plurality of external conductors 11, a plurality of external conductors 13, and internal conductors 21, 23, 25, and 27. In the present example, the multilayer capacitor C2 includes a pair of external electrodes 5, and includes a pair of external conductors 11 and a pair of external conductors 13. In the multilayer capacitor C2, the main surface 3a opposes an electronic device. The main surface 3a is disposed to constitute a mounting surface. The main surface 3a includes a mounting surface. In the multilayer capacitor C2 as well, for example, in a configuration in which one side surface 3c includes a first side surface, the other side surface 3c may include a second side surface, the main surface 3a may include a third side surface, and the main surface 3b may include a fourth side surface.

In the multilayer capacitor C2 as well, each external electrode 5 includes a plurality of electrode portions 5a, 5b, 5c, 5d, and 5e, and includes a first electrode layer E1, a second electrode layer E2, and a third electrode layer E3. For example, as shown in FIGS. 15, 16 and 17 each of the electrode portions 5a, 5c, 5d, and 5e includes the first electrode layer E1, the second electrode layer E2, and the third electrode layer E3. The electrode portion 5b includes the first electrode layer E1 and the third electrode layer E3. That is, the electrode portion 5b does not include the second electrode layer E2.

The first electrode layer E1 of the electrode portion 5b is disposed on the main surface 3b and on the ridge portion 3g. The first electrode layer E1 of the electrode portion 5b covers a part of the main surface 3b and the entirety of the ridge portion 3g. The first electrode layer E1 of the electrode portion 5b is in contact with the part of the main surface 3b and the entirety of the ridge portion 3g. In the electrode portion 5b, the first electrode layer E1 is in direct contact with the element body 3. The part of the main surface 3b includes a partial region of the main surface 3b located close to the end surface 3e. The first electrode layer E1 of the electrode portion 5b is located on the main surface 3b. The first electrode layer E1 may not be formed on the main surface 3b. The first electrode layer E1 may not be disposed on the main surface 3b. The main surface 3b includes a region covered with the first electrode layer E1 and a region exposed from the first electrode layer E1.

The third electrode layer E3 of the electrode portion 5b is disposed on the first electrode layer E1. In the electrode portion 5b, the third electrode layer E3 covers the first electrode layer E1. In the electrode portion 5b, the third electrode layer E3 is in contact with the first electrode layer E1. In the electrode portion 5b, the third electrode layer E3 is in direct contact with the first electrode layer E1. The third electrode layer E3 of the electrode portion 5b is located on the main surface 3b. The electrode portion 5b does not include the second electrode layer E2. The main surface 3b is not covered with the second electrode layer E2.

The second electrode layer E2 of the electrode portion 5c is disposed on the first electrode layer E1 and on the side surface 3c. In the electrode portion 5c, the second electrode layer E2 covers a part of the first electrode layer E1 and a part of the side surface 3c. In the electrode portion 5c, the second electrode layer E2 disposed on the part of the first electrode layer E1 and the part of the side surface 3c. In the electrode portion 5c, the second electrode layer E2 is in direct contact with the part of the first electrode layer E1 and the part of the side surface 3c. The second electrode layer E2 of the electrode portion 5c is formed to cover the part of the first electrode layer E1 of the electrode portion 5c. The part of the side surface 3c includes, for example, a corner region of the side surface 3c located close to the main surface 3a and the end surface 3e. The side surface 3c includes a region covered with the second electrode layer E2 and a region exposed from the second electrode layer E2. The second electrode layer E2 of the electrode portion 5c includes a portion that directly covers the first electrode layer E1 and a portion that directly covers the part of the side surface 3c. In the electrode portion 5c, a portion that is included in the second electrode layer E2 and directly covers the first electrode layer E1 indirectly covers the side surface 3c. The first electrode layer E1 of the electrode portion 5c includes a portion covered with the second electrode layer E2 and a portion exposed from the second electrode layer E2. The second electrode layer E2 of the electrode portion 5c is located on the side surface 3c. The second electrode layer E2 of the electrode portion 5c positioned on the side surface 3c.

The third electrode layer E3 of the electrode portion 5c is disposed on the first electrode layer E1 and on the second electrode layer E2. In the electrode portion 5c, the third electrode layer E3 covers the entirety of the second electrode layer E2 and covers the entirety of the portion of the first electrode layer E1 that is exposed from the second electrode layer E2. In the electrode portion 5c, the third electrode layer E3 is in contact with the entirety of the second electrode layer E2, and is in contact with the entirety of the portion of the first electrode layer E1 that is exposed from the second electrode layer E2. In the electrode portion 5c, the third electrode layer E3 is in direct contact with the first electrode layer E1 and the second electrode layer E2. The third electrode layer E3 of the electrode portion 5c is located on the side surface 3c.

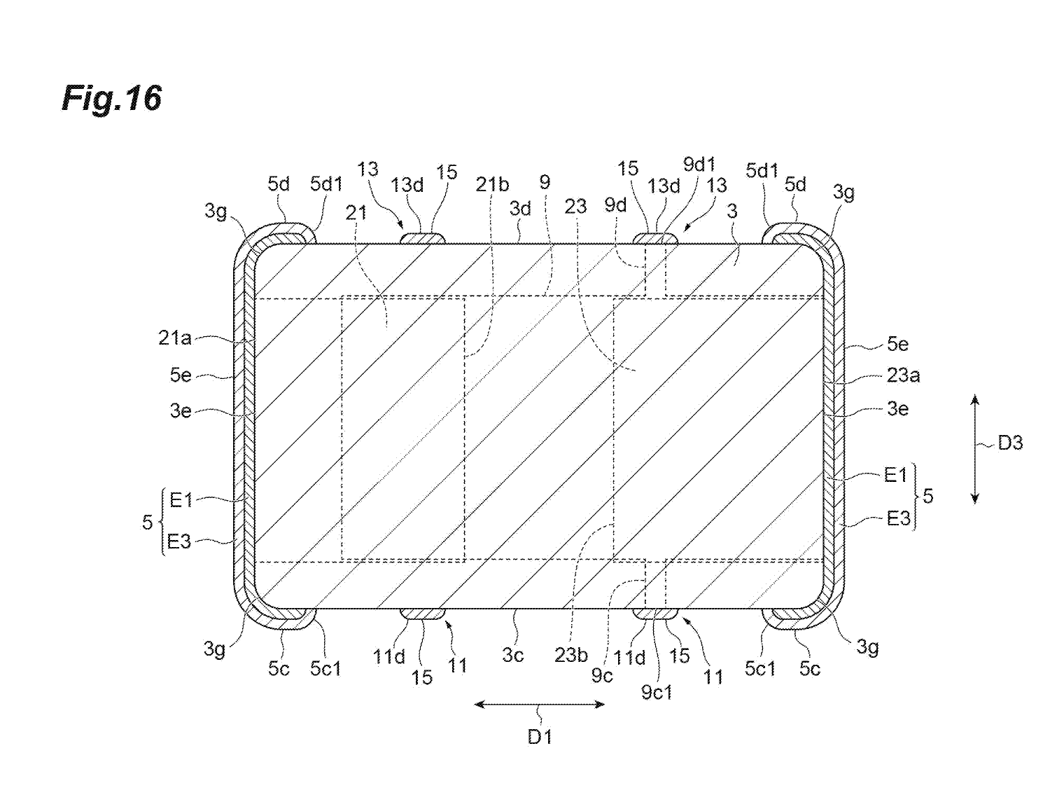

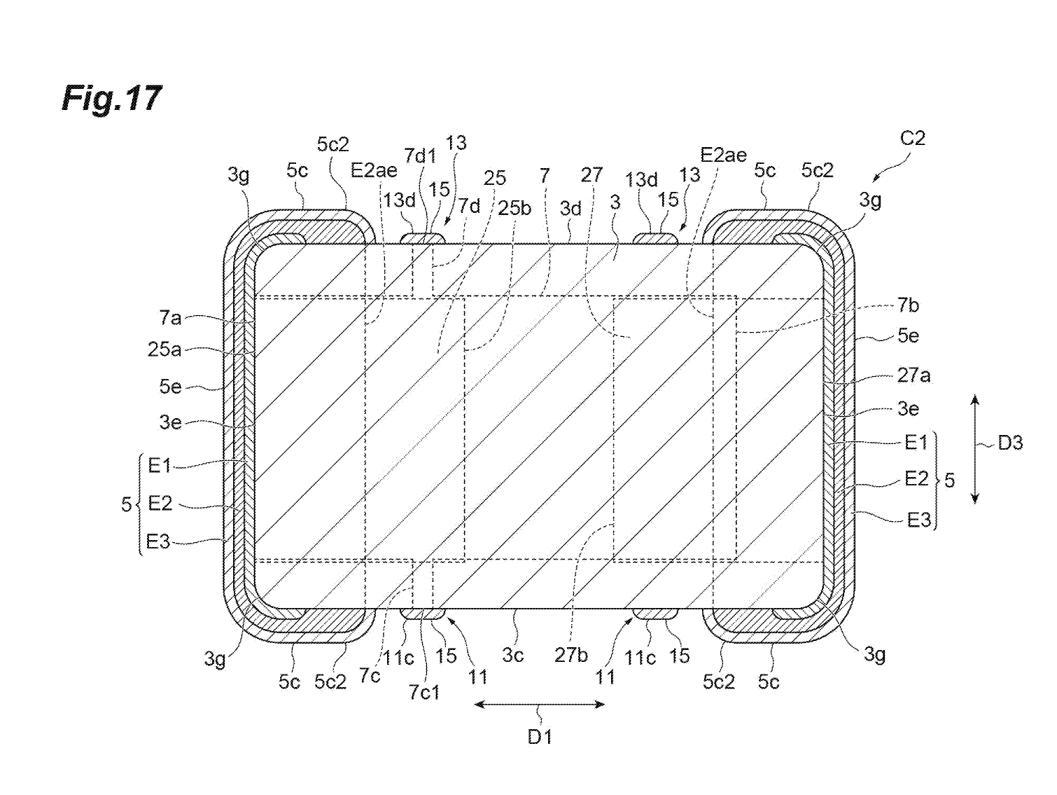

As shown in FIGS. 16 and 17, the electrode portion 5c includes a plurality of regions 5c1 and 5c2. In the present example, the electrode portion 5c includes only the two regions 5c1 and 5c2. The region 5c2 is located closer to the main surface 3a than the region 5c1. The region 5c1 includes the first electrode layer E1 and the third electrode layer E3. The region 5c1 does not include the second electrode layer E2. The region 5c2 includes the first electrode layer E1, the second electrode layer E2, and the third electrode layer E3. The region 5c1 includes a region where the first electrode layer E1 is exposed from the second electrode layer E2. The region 5c2 includes a region where the first electrode layer E1 is covered with the second electrode layer E2.

The second electrode layer E2 of the electrode portion 5d is disposed on the first electrode layer E1 and on the side surface 3d. In the electrode portion 5d, the second electrode layer E2 covers a part of the first electrode layer E1 and a part of the side surface 3d. In the electrode portion 5d, the second electrode layer E2 disposed on the part of the first electrode layer E1 and the part of the side surface 3d. In the electrode portion 5d, the second electrode layer E2 is in direct contact with the part of the first electrode layer E1 and the part of the side surface 3d. The second electrode layer E2 of the electrode portion 5d is formed to cover the art of the first electrode layer E1 of the electrode portion 5d. The part of the side surface 3d includes, for example, a corner region of the side surface 3d located close to the main surface 3a and the end surface 3e. The side surface 3d includes a region covered with the second electrode layer E2 and a region exposed from the second electrode layer E2. The second electrode layer E2 of the electrode portion 5d includes a portion that directly covers the first electrode layer E1 and a portion that directly covers the part of the side surface 3d. In the electrode portion 5d, a portion that is included in the second electrode layer E2 and directly covers the first electrode layer E1 indirectly covers the side surface 3d. The first electrode layer E1 of the electrode portion 5d includes a portion covered with the second electrode layer E2 and a portion exposed from the second electrode layer E2. The second electrode layer E2 of the electrode portion 5d is located on the side surface 3d. The second electrode layer E2 of the electrode portion 5d is positioned on the side surface 3d.

The third electrode layer E3 of the electrode portion 5d is disposed on the first electrode layer E1 and on the second electrode layer E2. In the electrode portion 5d, the third electrode layer E3 covers the entirety of the second electrode layer E2, and covers the entirety of the portion of the first electrode layer E1 that is exposed from the second electrode layer E2. In the electrode portion 5d, the third electrode layer E3 is in contact with the entirety of the second electrode layer E2, and is in contact with the entirety of the portion of the first electrode layer E1 that is exposed from the second electrode layer E2. In the electrode portion 5d, the third electrode layer E3 is in direct contact with the first electrode layer E1 and the second electrode layer E2. The third electrode layer E3 of the electrode portion 5d is located on the side surface 3d.

The electrode portion 5d includes a plurality of regions 5d1 and 5d2. In the present example, the electrode portion 5d includes only two regions 5d1 and 5d2. The region 5d2 is located closer to the main surface 3a than the region 5d1. The region 5d1 includes the first electrode layer E1 and the third electrode layer E3. The region 5d1 does not include the second electrode layer E2. The region 5d2 includes the first electrode layer E1, the second electrode layer E2, and the third electrode layer E3. The region 5d1 includes a region where the first electrode layer E1 is exposed from the second electrode layer E2. The region 5d2 includes a region where the first electrode layer E1 is covered with the second electrode layer E2.

The second electrode layer E2 of the electrode portion 5e is disposed on the first electrode layer E1. In the electrode portion 5e, the second electrode layer E2 covers a part of the first electrode layer E1. In the electrode portion 5e, the second electrode layer E2 is in direct contact with the part of the first electrode layer E1. The second electrode layer E2 of the electrode portion 5e is formed to cover the part of the first electrode layer E1 of the electrode portion 5e. A part of the end surface 3e includes, for example, a partial region of the end surface 3e that is located close to the main surface 3a. In the electrode portion 5e, the second electrode layer E2 indirectly covers a part of the end surface 3e so that the first electrode layer E1 is located between the second electrode layer E2 and the end surface 3e. In the electrode portion 5e, the second electrode layer E2 disposed on the part of the end surface 3e. The second electrode layer E2 of the electrode portion 5e positioned on the part of the end surface 3e. The first electrode layer E1 of the electrode portion 5e includes a portion covered with the second electrode layer E2 and a portion exposed from the second electrode layer E2.

The third electrode layer E3 of the electrode portion 5e is disposed on the first electrode layer E1 and on the second electrode layer E2. In the electrode portion 5e, the third electrode layer E3 covers the entirety of the second electrode layer E2, and covers the entirety of the portion of the first electrode layer E1 that is exposed from the second electrode layer E2. In the electrode portion 5e, the third electrode layer E3 is in contact with the entirety of the second electrode layer E2, and is in contact with the entirety of the portion of the first electrode layer E1 that is exposed from the second electrode layer E2. In the electrode portion 5e, the third electrode layer E3 is in direct contact with the first electrode layer E1 and the second electrode layer E2. The third electrode layer E3 of the electrode portion 5e is located on the end surface 3e.

As shown in FIG. 15, the electrode portion 5e includes a plurality of regions 5e1 and 5e2. In the present example, the electrode portion 5e includes only the two regions 5e1 and 5e2. The region 5e2 is located closer to the main surface 3a than the region 5e1. The region 5e1 includes the first electrode layer E1 and the third electrode layer E3. The region 5e1 does not include the second electrode layer E2. The region 5e2 includes the first electrode layer E1, the second electrode layer E2, and the third electrode layer E3. In the electrode portion 5e, the third electrode layer E3 is formed to cover the entirety of the end surface 3e when viewed from the first direction D1. In the present example, the third electrode layer E3 indirectly covers the entirety of the end surface 3e. The region 5e1 includes a region where the first electrode layer E1 is exposed from the second electrode layer E2. The region 5e2 includes a region where the first electrode layer E1 is covered with the second electrode layer E2.

In the present example, the internal electrode 7 and the internal electrode 9 are disposed at different positions in the second direction D2 similarly to the internal electrodes 7 and 9 included in the multilayer capacitor C1. That is, in the multilayer capacitor C2 as well, the internal electrode 7 and the internal electrode 9 are disposed at different layers within the element body 3. The internal electrode 7 and the internal electrode 9 oppose each other in the second direction D2.

In the multilayer capacitor C2 as well, the internal electrode 7 includes the end 7a and the end 7b, and the internal electrode 9 includes the end 9a and the end 9b. Each electrode portion 5e covers all corresponding ends of a plurality of ends 7a and 9a. Each electrode portion 5e is directly connected to the corresponding internal electrodes 7 and 9. Each external electrode 5 is electrically connected to the corresponding internal electrodes 7 and 9. In the present example as well, the plurality of internal electrodes 7 are physically and electrically connected to one external electrode 5. The plurality of internal electrodes 9 are physically and electrically connected to the other external electrode 5.

In the multilayer capacitor C2 as well, the internal electrode 7 includes a connecting portion 7c including an end 7c1, and a connecting portion 7d including an end 7d1.

The connecting portion 7c is physically and electrically connected to the portion 11c at the end 7c1 exposed to the side surface 3c. Thereby, the internal electrode 7 is connected to one external conductor 11.

The connecting portion 7d is physically and electrically connected to a portion 13c at the end 7d1 exposed to the side surface 3d. Thereby, the internal electrode 7 is connected to one external conductor 13.

The internal electrodes 7 are physically connected to a corresponding external conductor 11 and a corresponding external conductor 13 at a plurality of locations. Similarly to the multilayer capacitor C1 shown in FIG. 6, in the multilayer capacitor C2, all the internal electrodes 7 are physically connected to the corresponding external conductor 11 and the corresponding external conductor 13. However, not all the internal electrodes 7 need to be physically connected to the corresponding external conductor 11 and the corresponding external conductor 13. At least one internal electrode 7 of the plurality of internal electrodes 7 need only be physically connected to the corresponding external conductor 11 and the corresponding external conductor 13.

In the multilayer capacitor C2 as well, the internal electrode 9 includes a connecting portion 9c including an end 9c1, and a connecting portion 9d including an end 9d1.

The connecting portion 9c is physically and electrically connected to the portion 11c at the end 9c1 exposed to the side surface 3c. Thereby, the internal electrode 9 is connected to the other external conductor 11.

The connecting portion 9d is physically and electrically connected to the portion 13c at the end 9d1 exposed to the side surface 3d. Thereby, the internal electrode 9 is connected to the other external conductor 13.

The internal electrodes 9 are physically connected to a corresponding external conductor 11 and a corresponding external conductor 13 at a plurality of locations. Similarly to the multilayer capacitor C1 shown in FIG. 7, in the multilayer capacitor C2, all the internal electrodes 9 are physically connected to the corresponding external conductor 11 and the corresponding external conductor 13. However, not all the internal electrodes 9 need to be physically connected to the corresponding external conductor 11 and the corresponding external conductor 13. At least one internal electrode 9 of the plurality of internal electrodes 9 need only be physically connected to the corresponding external conductor 11 and the corresponding external conductor 13.

In the present example, the internal conductors 21 and 23 are disposed between the main surface 3b and the internal electrode 9 closest to the main surface 3b similarly to the internal conductors 21 and 23 included in the multilayer capacitor C1. The internal conductor 21 and the internal conductor 23 are disposed at the same position in the second direction D2 between the main surface 3b and the internal electrode 9 closest to the main surface 3b. The internal conductor 21 and the internal conductor 23 are disposed in the same layer within the element body 3. The internal conductor 21 and the internal conductor 23 are separated from each other in the first direction D1.

The internal conductor 21 includes an end 21a and an end 21b. In the present example, the end 21a is exposed to an end surface 3e of the pair of end surfaces 3e on which the end 9a of the internal electrode 9 closest to the main surface 3b is not exposed. The end 21b is located on the opposite side of the end 21a, and is not exposed to the surface of the element body 3. The electrode portion 5e entirely covers the end 21a. The electrode portion 5e is directly connected to the internal conductor 21. The electrode portion 5e is electrically connected to the internal conductor 21. In the present example, the internal conductor 21 is physically and electrically connected to one external electrode 5. The internal conductor 21 is also electrically connected to one external conductor 11 and one external conductor 13 through the one external electrode 5 and the internal electrode 7 connected to the external electrode 5.

The internal conductor 23 includes an end 23a and an end 23b. In the present example, the end 23a is exposed to an end surface 3e of the pair of end surfaces 3e on which the end 9a of the internal electrode 9 closest to the main surface 3b is exposed. The end 23b is located on the opposite side of the end 23a and is not exposed to the surface of the element body 3. The electrode portion 5e entirely covers the end 23a. The electrode portion 5e is directly connected to the internal conductor 23. The electrode portion 5e is electrically connected to the internal conductor 23. In the present example, the internal conductor 23 is physically and electrically connected to the other external electrode 5. The internal conductor 23 is also electrically connected to the other external conductor 11 and the other external conductor 13 through the other external electrode 5 and the internal electrode 9 connected to the external electrode 5.

In the present example, the internal conductors 25 and 27 are disposed between the main surface 3a and the internal electrode 7 closest to the main surface 3a similarly to the internal conductors 25 and 27 included in the multilayer capacitor C1. The internal conductor 25 and the internal conductor 27 are disposed at the same position in the second direction D2 between the main surface 3a and the internal electrode 7 closest to the main surface 3a. The internal conductor 25 and the internal conductor 27 are disposed in the same layer within the element body 3. The internal conductor 25 and the internal conductor 27 are separated from each other in the first direction D1.

The internal conductor 25 includes an end 25a and an end 25b. In the present example, the end 25a is exposed to an end surface 3e of the pair of end surfaces 3e on which the end 7a of the internal electrode 7 closest to the main surface 3a is exposed. The end 25b is located on the opposite side of the end 25a and is not exposed the surface of the element body 3. The electrode portion 5e entirely covers the end 25a. The electrode portion 5e is directly connected to the internal conductor 25. The electrode portion 5e is electrically connected to the internal conductor 25. In the present example, the internal conductor 25 is physically and electrically connected to one external electrode 5. The internal conductor 25 is also electrically connected to one external conductor 11 and one external conductor 13 through the one external electrode 5 and the internal electrode 7 connected to the external electrode 5.

The internal conductor 27 includes an end 27a and an end 27b. In the present example, the end 27a is exposed to an end surface 3e of the pair of end surfaces 3e on which the end 7a of the internal electrode 7 closest to the main surface 3a is not exposed. The end 27b is located on the opposite side of the end 27a and is not exposed to the surface of the element body 3. The electrode portion 5e entirely covers the end 27a. The electrode portion 5e is directly connected to the internal conductor 27. The electrode portion 5e is electrically connected to the internal conductor 27. In the present example, the internal conductor 27 is physically and electrically connected to the other external electrode 5. The internal conductor 27 is also electrically connected to the other external conductor 11 and the other external conductor 13 through the other external electrode 5 and the internal electrode 9 connected to the external electrode 5.

As shown in FIG. 17, in the present example as well, when viewed from the second direction D2, the internal conductor 27 overlaps the end E2ae of the layer portion E2a of the external electrode 5 that is not electrically connected to the internal electrode 7 closest to the main surface 3a and the end 7b of the internal electrode 7 closest to the main surface 3a.

In the multilayer capacitor C2 as well, the second electrode layer E2 included in the external electrode 5 and the conductor layer 15 included in the external conductor 11 adjacent to the external electrode 5 in the first direction D1 are electrically connected to each other. When the electric field acts on the second electrode layer E2, the electric field acts not only on the second electrode layer E2 but also the conductor layer 15 electrically connected to the second electrode layer E2. The electric field tends not to concentrate on the second electrode layer E2, and the conductor layer 15 reduces the electric field acting on the second electrode layer E2. Therefore, even when the electric field acts on the second electrode layer E2, the metal included in the second electrode layer E2 tends not to be ionized. Migration tends not to occur in the second electrode layer E2.

Migration is less prone to occur in the conductor layer 15 than in the second electrode layer E2. Therefore, even when an electric field acts on the conductor layer 15, migration tends not to occur in the conductor layer 15.

In the multilayer capacitor C2, one external conductor 11 is located between one external electrode 5 and the other external conductor 11 on the side surface 3c. The conductor layer 15 included in one external conductor 11 and the second electrode layer E2 included in one external electrode 5 are electrically connected to each other. Therefore, even when migration occurs in the second electrode layer E2 of the electrode portion 5c included in one external electrode 5, one external conductor 11 prevents the proceeding of migration. In the multilayer capacitor C2, the other external conductor 11 is located between the other external electrode 5 and one external conductor 11 on the side surface 3c. The conductor layer 15 included in the other external conductor 11 and the second electrode layer E2 included in the other external electrode 5 are electrically connected to each other. Therefore, even when migration occurs in the second electrode layer E2 of the electrode portion 5c included in the other external electrode 5, the other external conductor 11 prevents the proceeding of migration.

In the multilayer capacitor C2, the internal conductor 27 electrically connected to the other external electrode 5 and the other external conductor 11 is disposed between the main surface 3a and the internal electrode 7 closest to the main surface 3a on which the second electrode layer E2 is disposed. Therefore, the internal electrode 7 closest to the main surface 3a and the second electrode layer E2 of the electrode portion 5a included in one external electrode 5 tend not to oppose each other in the second direction D2. For the above reasons, in the multilayer capacitor C2, the internal conductor 27 prevents generation of the electric field between the second electrode layer E2 and the internal electrode 7 closest to the main surface 3a that are not electrically connected to each other.

As a result, the multilayer capacitor C2 controls the proceeding of migration.

In the multilayer capacitor C2, one external conductor 13 is located between one external electrode 5 and the other external conductor 13 on the side surface 3d. The conductor layer 15 included in one external conductor 13 and the second electrode layer E2 included in one external electrode 5 are electrically connected to each other. Therefore, even when migration occurs in the second electrode layer E2 of the electrode portion 5d included in one external electrode 5, one external conductor 13 prevents the proceeding of migration. In the multilayer capacitor C2, the other external conductor 13 is located between the other external electrode 5 and one external conductor 13 on the side surface 3c. The conductor layer 15 included in the other external conductor 13 and the second electrode layer E2 included in the other external electrode 5 are electrically connected to each other. Therefore, even when migration occurs in the second electrode layer E2 of the electrode portion 5d included in the other external electrode 5, the other external conductor 13 prevents the proceeding of migration.

In the multilayer capacitor C2, the internal conductor 27 electrically connected to the other external electrode 5 and the other external conductor 11 is disposed between the main surface 3a and the internal electrode 7 closest to the main surface 3a. Therefore, the internal electrode 7 closest to the main surface 3a and the second electrode layer E2 of the electrode portion 5a included in one external electrode 5 are not electrically connected to each other, but tend not to oppose each other in the second direction D2. For the above reasons, the internal conductor 27 prevents generation of the electric field between the second electrode layer E2 and the internal electrode 7 closest to the main surface 3a that are not electrically connected to each other.

As a result, the multilayer capacitor C2 further controls the proceeding of migration.

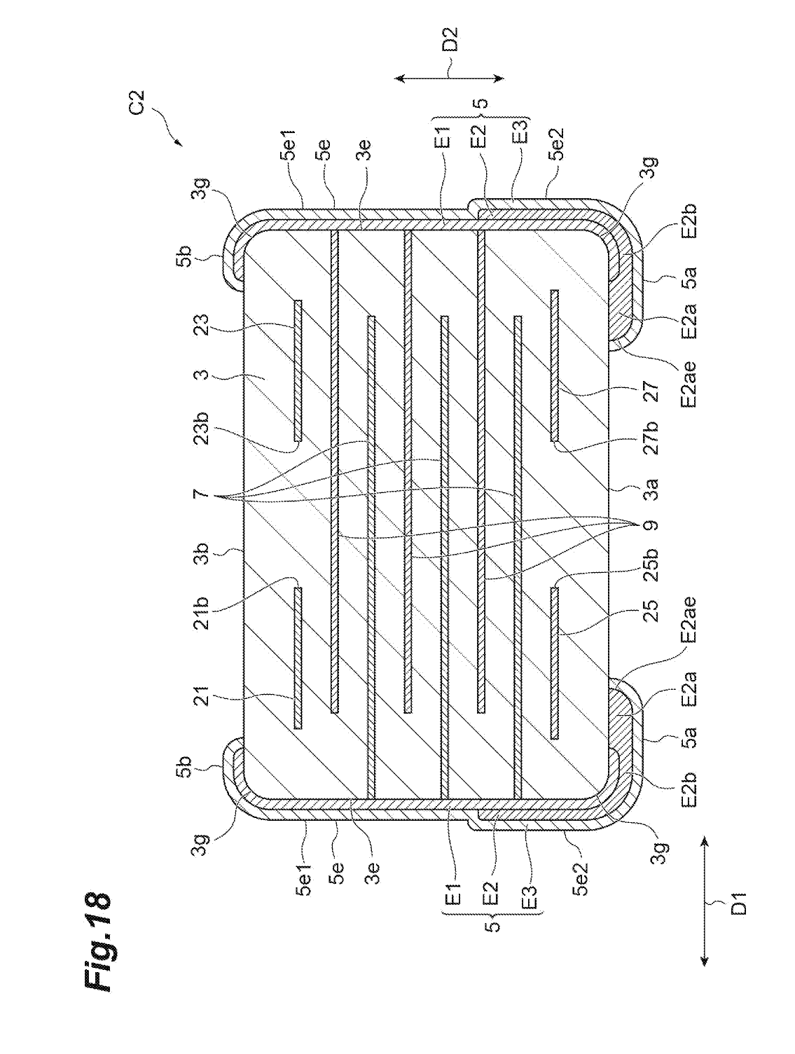

Next, a configuration of a multilayer capacitor C2 according to one modification example of the second example will be described with reference to FIGS. 18-20. FIGS. 18, 19 and 20 are diagrams illustrating cross-sectional configurations of a multilayer capacitor according to one modification example of the second example.

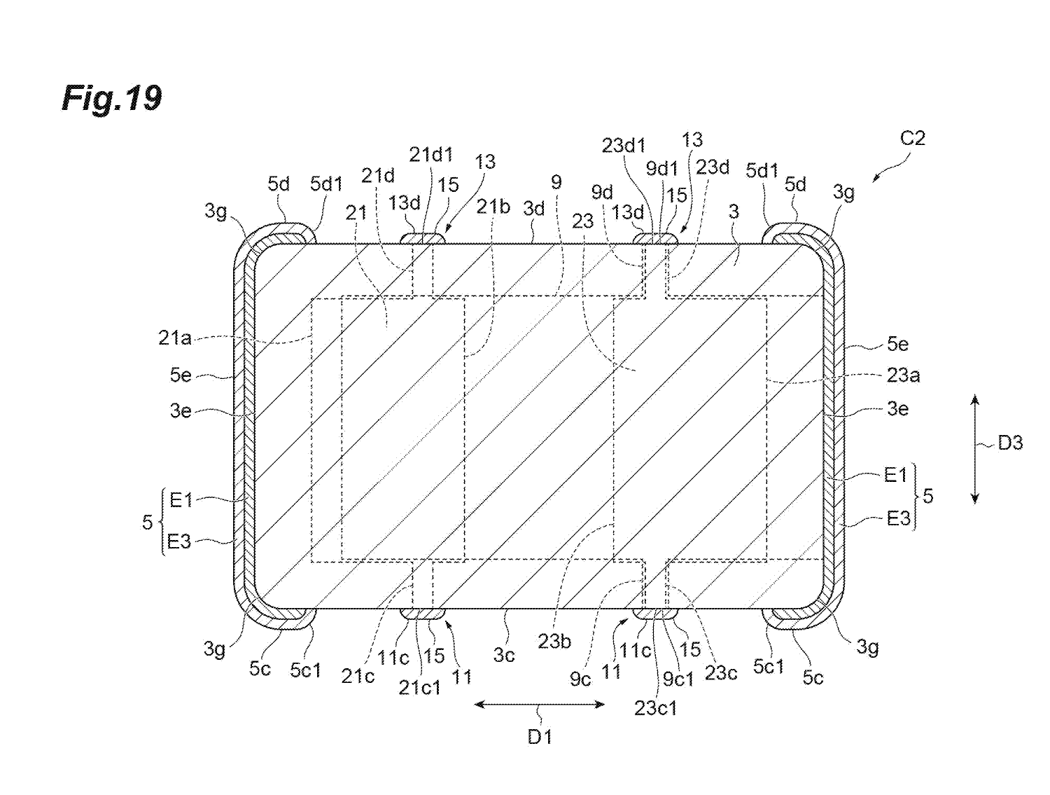

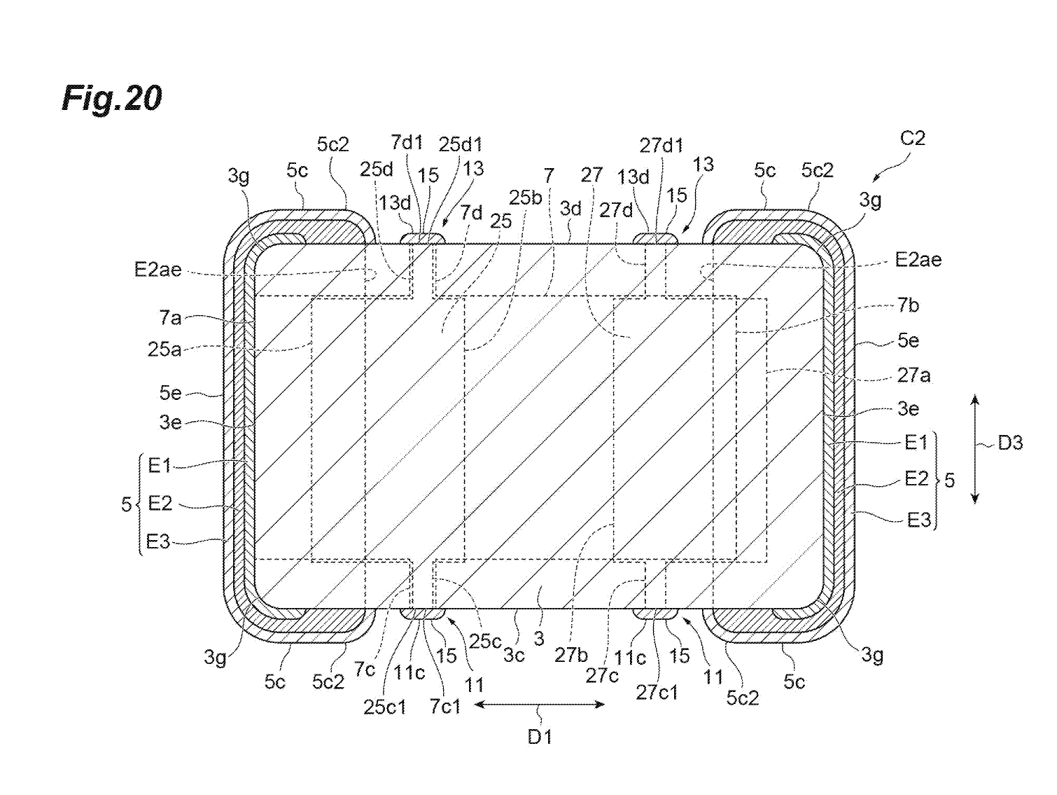

The multilayer capacitor C2 according to the present modification example is generally similar to or the same as the multilayer capacitor C2 according to the second example described above, but the present modification example differs from the second example described above in terms of the configurations of the internal conductors 21, 23, 25, and 27. Hereinafter, differences between the second example described above and the present modification example will be mainly described. In FIGS. 19 and 20, for the purpose of description, the internal electrodes 7 and 9 and the internal conductors 21, 23, 25, and 27 are intentionally shown shifted from one another in the third direction D3.

As shown in FIG. 18, in the present modification example, the end 21a of the internal conductor 21 is located within the element body 3 and is not exposed to the surface of the element body 3. In the present modification example, the internal conductor 21 is not directly connected to the electrode portion 5e. That is, in the present modification example, the internal conductor 21 is not physically connected to the external electrode 5.

As shown in FIG. 19, in the present modification example, the internal conductor 21 includes a connecting portion 21c including an end 21c1 and a connecting portion 21d including an end 21d1. The connecting portion 21c is physically and electrically connected to the portion 11c at the end 21c1 exposed to the side surface 3c. Thereby, the internal conductor 21 is connected to the external conductor 11. The connecting portion 21d is physically and electrically connected to the portion 13d at the end 21d1 exposed to the side surface 3d. Thereby, the internal conductor 21 is connected to the external conductor 13.

The end 23a of the internal conductor 23 is located within the element body 3 and is not exposed to the surface of the element body 3. In the present modification example, the internal conductor 23 is not directly connected to the electrode portion 5e. That is, in the present modification example, the internal conductor 23 is not physically connected to the external electrode 5.

The internal conductor 23 includes a connecting portion 23c including an end 23c1 and a connecting portion 23d including an end 23d1. The connecting portion 23c is physically and electrically connected to the portion 11c at the end 23c1 exposed to the side surface 3c. Thereby, the internal conductor 23 is connected to the external conductor 11. The connecting portion 23d is physically and electrically connected to the portion 13d at the end 23d1 exposed to the side surface 3d. Thereby, the internal conductor 23 is connected to the external conductor 13.

In the present modification example, the end 25a of the internal conductor 25 is located within the element body 3 and is not exposed to the surface of the element body 3. In the present modification example, the internal conductor 25 is not directly connected to the electrode portion 5e. That is, in the present modification example, the internal conductor 25 is not physically connected to the external electrode 5.

As shown in FIG. 20, in the present modification example, the internal conductor 25 includes a connecting portion 25c including an end 25c1 and a connecting portion 25d including an end 25d1. The connecting portion 25c is physically and electrically connected to the portion 11c at the end 25c1 exposed to the side surface 3c. Thereby, the internal conductor 25 is connected to one external conductor 11. The connecting portion 25d is physically and electrically connected to the portion 13d at the end 25d1 exposed to the side surface 3d. Thereby, the internal conductor 25 is connected to one external conductor 13.

The end 27a of the internal conductor 27 is located within the element body 3 and is not exposed to the surface of the element body 3. In the present modification example, the internal conductor 27 is not directly connected to the electrode portion 5e. That is, in the present modification example, the internal conductor 27 is not physically connected to the external electrode 5.

The internal conductor 27 includes a connecting portion 27c including an end 27c1 and a connecting portion 27d including an end 27d1. The connecting portion 27c is physically and electrically connected to the portion 11c at the end 27c1 exposed to the side surface 3c. Thereby, the internal conductor 27 is connected to the other external conductor 11. The connecting portion 27d is physically and electrically connected to the portion 13d at the end 27d1 exposed to the side surface 3d. Thereby, the internal conductor 27 is connected to the other external conductor 13.

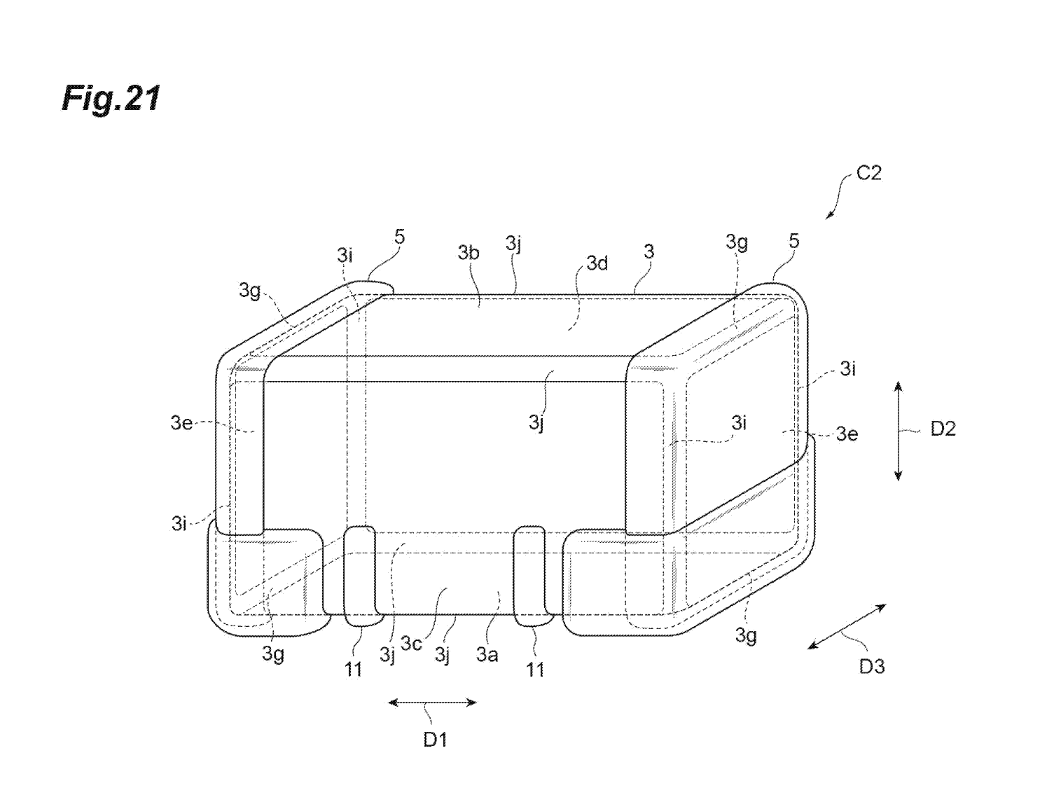

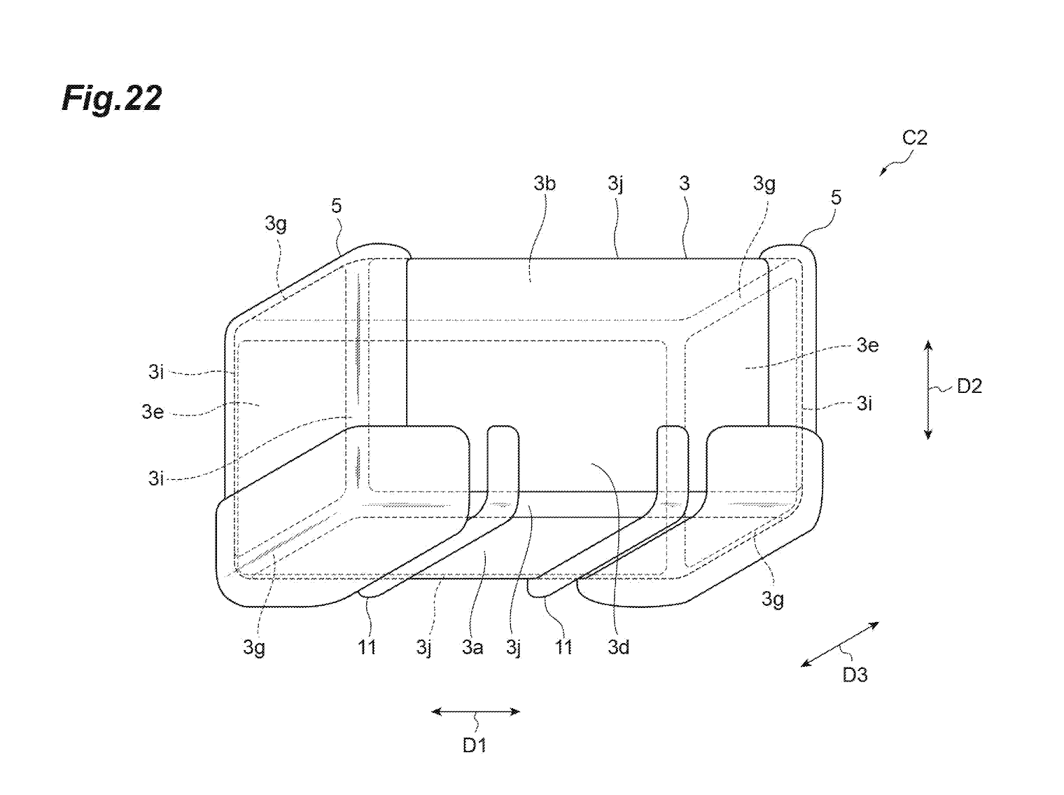

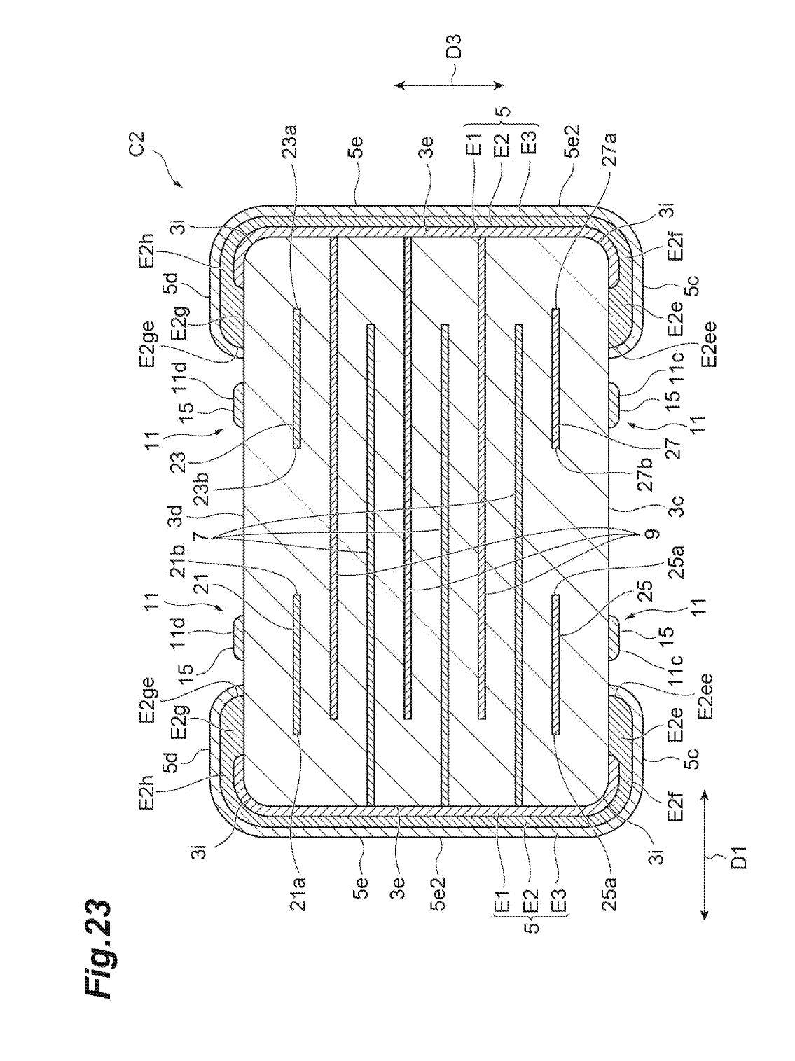

Next, a configuration of a multilayer capacitor C2 according to another modification example of the second example will be described with reference to FIGS. 21-27. FIGS. 21 and 22 are perspective views illustrating a multilayer capacitor according to another modification example of the second example. FIGS. 23, 24, 25, 26 and 27 are diagrams illustrating cross-sectional configurations of a multilayer capacitor according to another modification example of the second example.

The multilayer capacitor C2 according to the present modification example is generally similar to or the same as the multilayer capacitor C2 according to the second example described above, but the present modification example differs from the second example described above in terms of the configurations of the plurality of external electrodes 5, the plurality of internal electrodes 7 and 9, the plurality of external conductors 11, 13, and the internal conductors 21, 23, 25, and 27. Hereinafter, differences between the second example described above and the present modification example will be mainly described. In FIGS. 19 and 20, for the purpose of description, the internal electrodes 7 and 9 and the internal conductors 21, 23, 25, and 27 are intentionally shown shifted from one another in the third direction D3.

The second electrode layer E2 of the electrode portion 5c is disposed on the first electrode layer E1 and on the side surface 3c. In the present modification example, the second electrode layer E2 of the electrode portion 5c includes a layer portion E2e located on the side surface 3c and a layer portion E2f located on the first electrode layer E1. Each layer portion E2e includes an end E2ee. On the side surface 3c, the end E2ee of one layer portion E2e opposes the end E2ee of the other layer portion E2e in the first direction D1.

The second electrode layer E2 of the electrode portion 5d is disposed on the first electrode layer E1 and on the side surface 3d. In the present modification example, the second electrode layer E2 of the electrode portion 5d includes a layer portion E2g located on the side surface 3d and a layer portion E2h located on the first electrode layer E1. Each layer portion E2g includes an end E2ge. On the side surface 3c, the end E2ge of one layer portion E2g opposes the end E2ge of the other layer portion E2g in the first direction D1.

As shown in FIG. 23, in the present modification example, the internal electrode 7 and the internal electrode 9 are disposed at different positions in the third direction D3. The internal electrode 7 and the internal electrode 9 are disposed in different layers within the element body 3. The internal electrode 7 and the internal electrode 9 are disposed within the element body 3 to oppose each other in the third direction D3. The internal electrode 7 and the internal electrode 9 are alternately disposed within the element body 3 to oppose each other at an interval in the third direction D3. The plurality of internal electrodes 7 and the plurality of internal electrodes 9 are alternately lined up in the third direction D3. The plurality of internal electrodes 7 and 9 are disposed within the element body 3 to be lined up in the third direction D3.

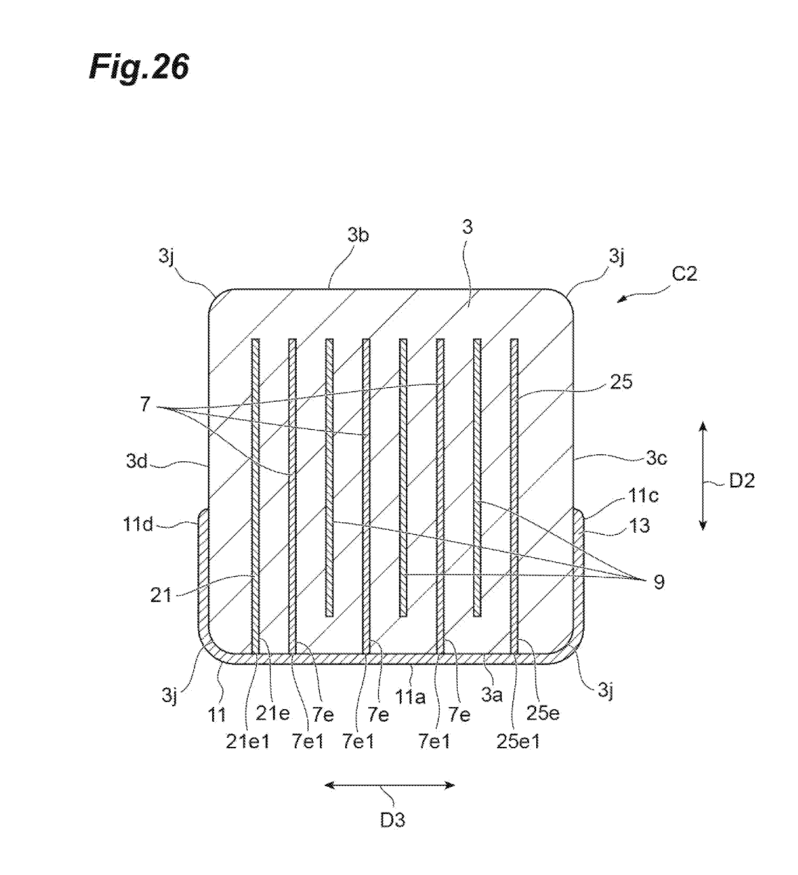

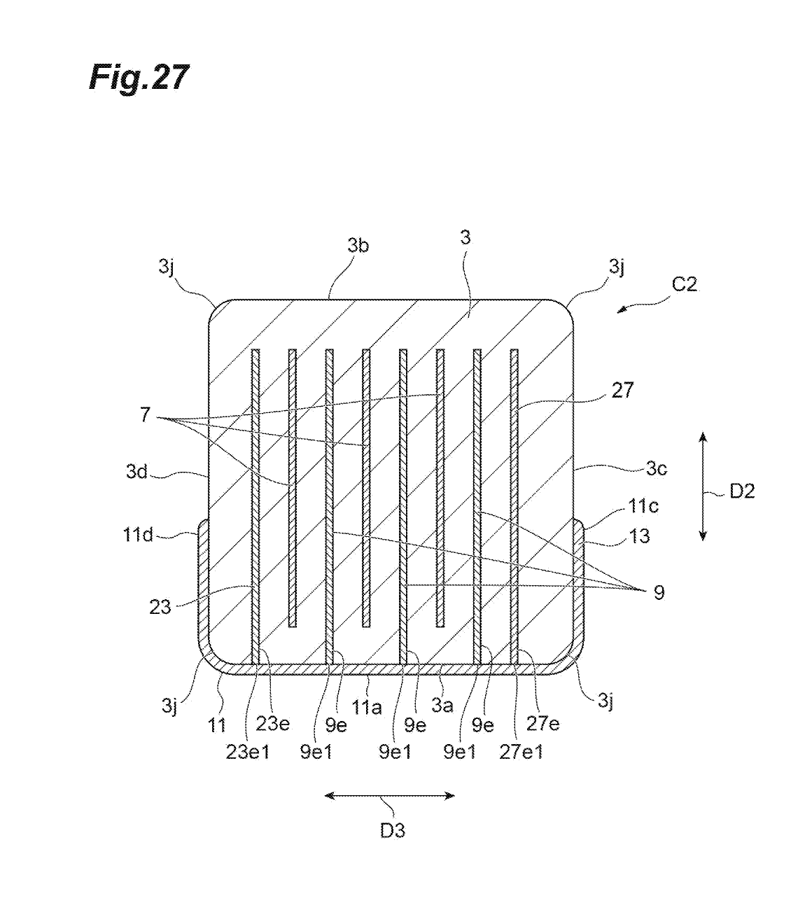

In the present modification example, the multilayer capacitor C2 does not include a plurality of external conductors 13. In the present modification example, the multilayer capacitor C2 includes only a pair of external conductors 11. Each external conductor 11 is disposed on the main surface 3a, on the side surface 3c, and on the side surface 3d. As shown in FIGS. 26 and 27, each external conductor 11 includes a portion 11a disposed on the main surface 3a, a portion 11c disposed on the side surface 3c, and a portion 11d disposed on the side surface 3d. Each external conductor 11 includes one portion 11a, one portion 11c, and one the portion 11d. In the present example, the portion 11a, the portion 11c, and the portion 11d are formed integrally with each other. Each external conductor 11 is also disposed on each ridge portion 3j. The portion 11a, the portion 11c, and the portion 11d are not only physically connected to each other, but also electrically connected to each other.

In the present modification example, for example, in a configuration in which the main surface 3a includes a first side surface, either the side surface 3c or the side surface 3d includes a second side surface.

The portion 11a is separated from the end edge of the electrode portion 5a. The portion 11a extends in the third direction D3 along the end edge of the electrode portion 5a.

The portion 11c is separated from the end edge of the region 5c2 of the electrode portion 5c. The portion 11c extends in the second direction D2 along the end edge of the region 5c2. The region 5c1 of the electrode portion 5c does not have the second electrode layer E2. Therefore, the portion 11c does not have to extend in the second direction D2 along the end edge of the region 5c1 of the electrode portion 5c. The portion 11c need only be provided at a position corresponding to the region 5c2, and does not have to be provided at a position corresponding to the region 5c1.

The portion 11d is separated from the end edge of the region 5d2 of the electrode portion 5d. The portion 11d extends in the second direction D2 along the end edge of the region 5d2. The region 5d1 of the electrode portion 5d does not have the second electrode layer E2. Therefore, the portion 11d does not have to extend in the second direction D2 along the end edge of the region 5d1 of the electrode portion 5d. The portion 11d need only be provided at a position corresponding to the region 5d2, and does not have to be provided at a position corresponding to the region 5d1.

The external conductor 11 may not be disposed on the side surface 3c, and may not be disposed on the side surface 3d. The external conductor 11 may not include the portion 11c, and may not include the portion 11d. That is, the external conductor 11 may be disposed only on the main surface 3a, and may include only the portion 11a.

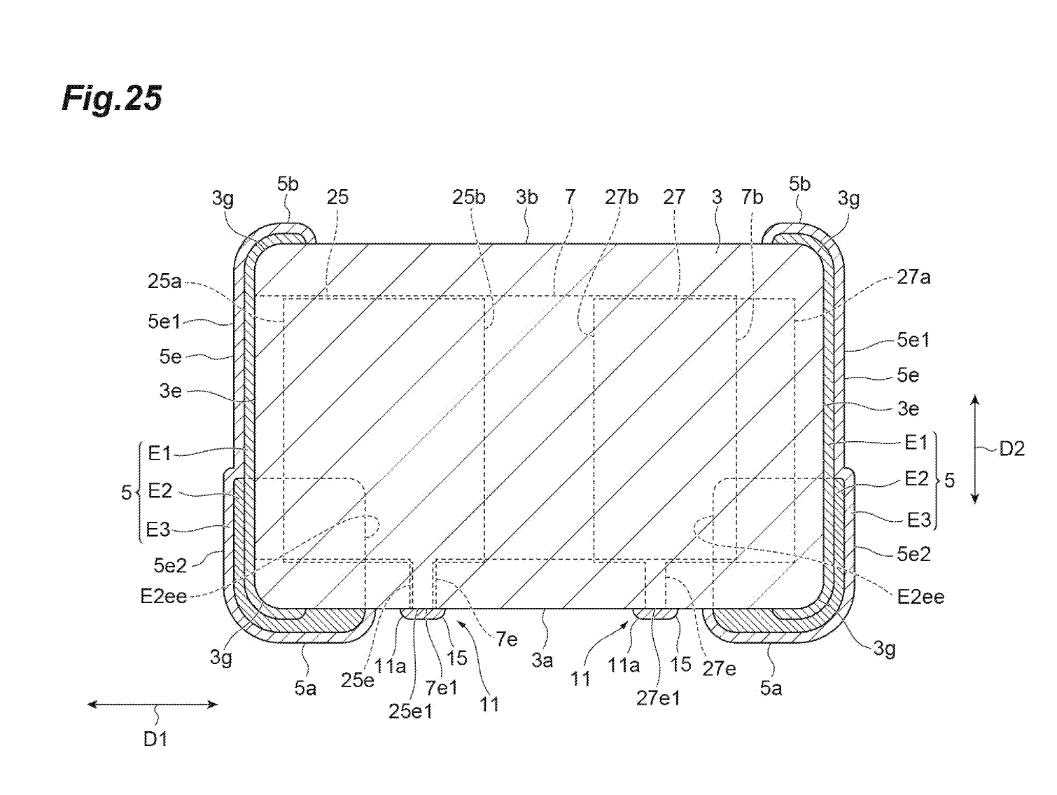

The internal electrode 7 includes a connecting portion 7e. In the present modification example, the internal electrode 7 includes only one connecting portion 7e. The connecting portion 7e is exposed to the main surface 3a. The connecting portion 7e includes an end 7e1 exposed to the main surface 3a. As shown in FIGS. 25 and 26, the connecting portion 7e is physically and electrically connected to the portion 11a at the end 7e1 exposed to the main surface 3a. Thereby, the internal electrode 7 is connected to the external conductor 11. That is, the internal electrode 7 includes the end 7e1 that is exposed to the main surface 3a and connected to the external conductor 11. The internal electrode 7 is not exposed to the main surface 3b.

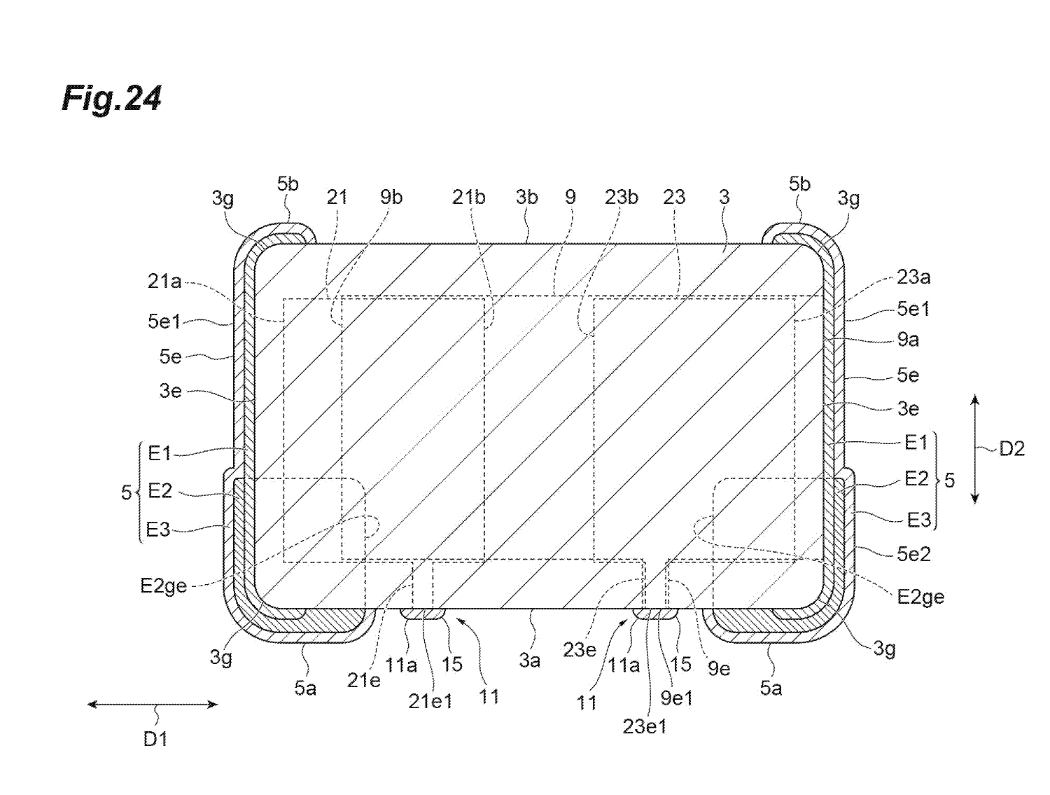

The internal electrode 9 includes a connecting portion 9e. In the present modification example, the internal electrode 9 includes only one connecting portion 9e. The connecting portion 9e is exposed to the main surface 3a. The connecting portion 9e includes an end 9e1 exposed to the main surface 3a. As shown in FIGS. 24 and 27, the connecting portion 9e is physically and electrically connected to the portion 11a at the end 9e1 exposed to the main surface 3a. Thereby, the internal electrode 9 is connected to the external conductor 11. That is, the internal electrode 9 includes the end 9e1 that is exposed to the main surface 3a and connected to the external conductor 11. The internal electrode 9 is not exposed to the main surface 3b.

In the present modification example, as shown in FIG. 23, the internal conductors 21 and 23 are disposed between the side surface 3d and the internal electrode 9 closest to the side surface 3d, and the internal conductors 25 and 27 are disposed between the side surface 3c and the internal electrode 7 closest to the side surface 3c.

In the present modification example, the internal conductor 21 and the internal conductor 23 are disposed at the same position in the third direction D3 between the side surface 3d and the internal electrode 9 closest to the side surface 3d. The internal conductor 21 and the internal conductor 23 are disposed in the same layer within the element body 3. The internal conductor 21 and the internal conductor 23 are separated from each other in the first direction D1. The internal conductor 21 and the internal conductor 23 oppose the internal electrode 9 closest to the side surface 3d in the third direction D3. The internal electrode 9 closest to the side surface 3d includes a portion facing the internal conductor 21 and a portion facing the internal conductor 23.

In the present modification example, the end 21a and the end 21b of the internal conductor 21 are located within the element body 3 and are not exposed to the surface of the element body 3. In the present modification example, the internal conductor 21 is not directly connected to the electrode portion 5e. That is, in the present modification example, the internal conductor 21 is not physically connected to the external electrode 5.

The internal conductor 21 includes a connecting portion 21e. In the present modification example, the internal conductor 21 includes only one connecting portion 21e. The connecting portion 21e is exposed to the main surface 3a. The connecting portion 21e includes an end 21e1 exposed to the main surface 3a. As shown in FIGS. 24 and 26, the connecting portion 21e is physically and electrically connected to the portion 11a at the end 21e1 exposed to the main surface 3a. Thereby, the internal conductor 21 is connected to one external conductor 11. That is, the internal conductor 21 includes the end 21e1 that is exposed to the main surface 3a and connected to one external conductor 11.

In the present modification example, the end 23a and the end 23b of the internal conductor 23 are located within the element body 3 and are not exposed to the surface of the element body 3. In the present modification example, the internal conductor 23 is not directly connected to the electrode portion 5e. That is, in the present modification example, the internal conductor 21 is not physically connected to the external electrode 5.

The internal conductor 23 includes a connecting portion 23e. In the present modification example, the internal conductor 23 includes only one connecting portion 23e. The connecting portion 23e is exposed to the main surface 3a. The connecting portion 23e includes an end 23e1 exposed to the main surface 3a. As shown in FIGS. 24 and 27, the connecting portion 23e is physically and electrically connected to the portion 11a at the end 23e1 exposed to the main surface 3a. Thereby, the internal conductor 23 is connected to the other external conductor 11. That is, the internal conductor 23 includes the end 23e1 that is exposed to the main surface 3a and connected to the other external conductor 11.

The internal conductor 25 and the internal conductor 27 are disposed at the same position in the third direction D3 between the side surface 3c and the internal electrode 7 closest to the side surface 3c. The internal conductor 25 and the internal conductor 27 are disposed in the same layer within the element body 3. The internal conductor 25 and the internal conductor 27 are separated from each other in the first direction D1. The internal conductor 25 and the internal conductor 27 oppose the internal electrode 7 closest to the side surface 3c in the third direction D3. The internal electrode 7 closest to the main surface 3a includes a portion opposing the internal conductor 25 and a portion opposing the internal conductor 27.

In the present modification example, the end 25a and the end 25b of the internal conductor 25 are located within the element body 3 and are not exposed to the surface of the element body 3. In the present modification example, the internal conductor 25 is not directly connected to the electrode portion 5e. That is, in the present modification example, the internal conductor 25 is not physically connected to the external electrode 5.

The internal conductor 25 includes a connecting portion 25e. In the present modification example, the internal conductor 25 includes only one connecting portion 25e. The connecting portion 25e is exposed to the main surface 3a. The connecting portion 25e includes an end 25e1 exposed on the main surface 3a. As shown in FIGS. 25 and 26, the connecting portion 25e is physically and electrically connected to the portion 11a at the end 25e1 exposed to the main surface 3a. Thereby, the internal conductor 25 is connected to one external conductor 11. That is, the internal conductor 25 includes the end 25e1 that is exposed to the main surface 3a and connected to one external conductor 11.

In the present modification example, the end 27a and the end 27b of the internal conductor 27 are located within the element body 3 and are not exposed to the surface of the element body 3. In the present modification example, the internal conductor 27 is not directly connected to the electrode portion 5e. That is, in the present modification example, the internal conductor 27 is not physically connected to the external electrode 5.

The internal conductor 27 includes a connecting portion 27e. In the present modification example, the internal conductor 27 includes only one connecting portion 27e. The connecting portion 27e is exposed to the main surface 3a. The connecting portion 27e includes an end 27e1 exposed to the main surface 3a. As shown in FIGS. 25 and 27, the connecting portion 27e is physically and electrically connected to the portion 11a at the end 27e1 exposed to the main surface 3a. Thereby, the internal conductor 27 is connected to the other external conductor 11. That is, the internal conductor 27 includes the end 27e1 that is exposed to the main surface 3a and connected to the other external conductor 11.

When viewed from the third direction D3, the internal conductor 21 overlaps the external electrode 5 that is not electrically connected to the internal electrode 9 closest to the side surface 3d, and the internal electrode 9 closest to the side surface 3d. As shown in FIG. 24, in the present modification example, when viewed from the third direction D3, the internal conductor 21 overlaps the end E2ge of the layer portion E2g of the external electrode 5 that is not electrically connected to the internal electrode 9 closest to the side surface 3d, and the end 9b of the internal electrode 9 closest to the side surface 3d. When viewed from the third direction D3, the end 21b of the internal conductor 21 is located closer to the end surface 3e on which the end 9a is exposed than the end E2ge and the end 9b. When viewed from the third direction D3, the end 9b of the internal electrode 9 closest to the side surface 3d is located closer to the end surface 3e on which the end 9a is not exposed than the end E2ge of the layer portion E2g of the external electrode 5 that is not electrically connected to the internal electrode 9.

When viewed from the third direction D3, the internal conductor 27 overlaps the external electrode 5 that is not electrically connected to the internal electrode 7 closest to the side surface 3c, and the internal electrode 7 closest to the side surface 3c. As shown in FIG. 25, in the present modification example, when viewed from the third direction D3, the internal conductor 27 overlaps the end E2ee of the layer portion E2e of the external electrode 5 that is not electrically connected to the internal electrode 7 closest to the side surface 3c, and the end 7b of the internal electrode 7 closest to the side surface 3c. When viewed from the third direction D3, the end 27b of the internal conductor 27 is located closer to the end surface 3e on which the end 7a is exposed than the end E2ee and the end 7b. When viewed from the third direction D3, the end 7b of the internal electrode 7 closest to the side surface 3c is located closer to the end surface 3e on which the end 7a is not exposed than the end E2ee of the layer portion E2e of the external electrode 5 that is not electrically connected to the internal electrode 7.

In the multilayer capacitor C2 according to the present modification example, the internal conductor 21 electrically connected to one external electrode 5 and one external conductor 11 is disposed between the side surface 3d and the internal electrode 9 closest to the side surface 3d. Therefore, the internal electrode 9 closest to the side surface 3d and the second electrode layer E2 of the electrode portion 5b included in the other external electrode 5 are not electrically connected to each other, but tend not to oppose each other in the third direction D3. For the above reasons, the internal conductor 21 prevents generation of the electric field between the second electrode layer E2 and the internal electrode 9 closest to the side surface 3d that are not electrically connected to each other.

The internal conductor 27 electrically connected to the other external electrode 5 and the other external conductor 11 is disposed between the side surface 3c and the internal electrode 7 closest to the side surface 3c. Therefore, the internal electrode 7 closest to the side surface 3c and the second electrode layer E2 of the electrode portion 5a included in one external electrode 5 are not electrically connected to each other, but tend not to oppose each other in the third direction D3. For the above reasons, the internal conductor 27 prevents generation of the electric field between the second electrode layer E2 and the internal electrode 7 closest to the side surface 3c that are not electrically connected to each other.

In the multilayer capacitor C2 according to the present modification example, when viewed from the third direction D3, the internal conductor 21 overlaps the end E2ge of the layer portion E2g of the external electrode 5 that is not electrically connected to the internal electrode 9 closest to the side surface 3d, and the end 9b of the internal electrode 9 closest to the side surface 3d.

In the multilayer capacitor C2 according to the present modification example, the internal electrode 9 closest to the side surface 3d and the second electrode layer E2 of the electrode portion 5b included in one external electrode 5 to which the internal electrode 9 closest to the side surface 3d is not electrically connected further tend not to oppose each other in the third direction D3. For the above reasons, the internal conductor 21 further prevents generation of the electric field between the second electrode layer E2 and the internal electrode 9 closest to the side surface 3d that are not electrically connected to each other. As a result, the multilayer capacitor C2 according to the present modification example further controls the proceeding of migration.

In the multilayer capacitor C2 according to the present modification example, when viewed from the third direction D3, the internal conductor 27 overlaps the end E2ee of the layer portion E2e of the external electrode 5 that is not electrically connected to the internal electrode 7 closest to the side surface 3c, and the end 7b of the internal electrode 7 closest to the side surface 3c.

In the multilayer capacitor C2 according to the present modification example, the internal electrode 7 closest to the side surface 3c and the second electrode layer E2 of the electrode portion 5b included in the other external electrode 5 to which the internal electrode 7 closest to the side surface 3c is not electrically connected further tend not to oppose each other in the third direction D3. For the above reasons, the internal conductor 27 further prevents generation of the electric field between the second electrode layer E2 and the internal electrode 7 closest to the side surface 3c that are not electrically connected to each other. As a result, the multilayer capacitor C2 according to the present modification example further controls the proceeding of migration.

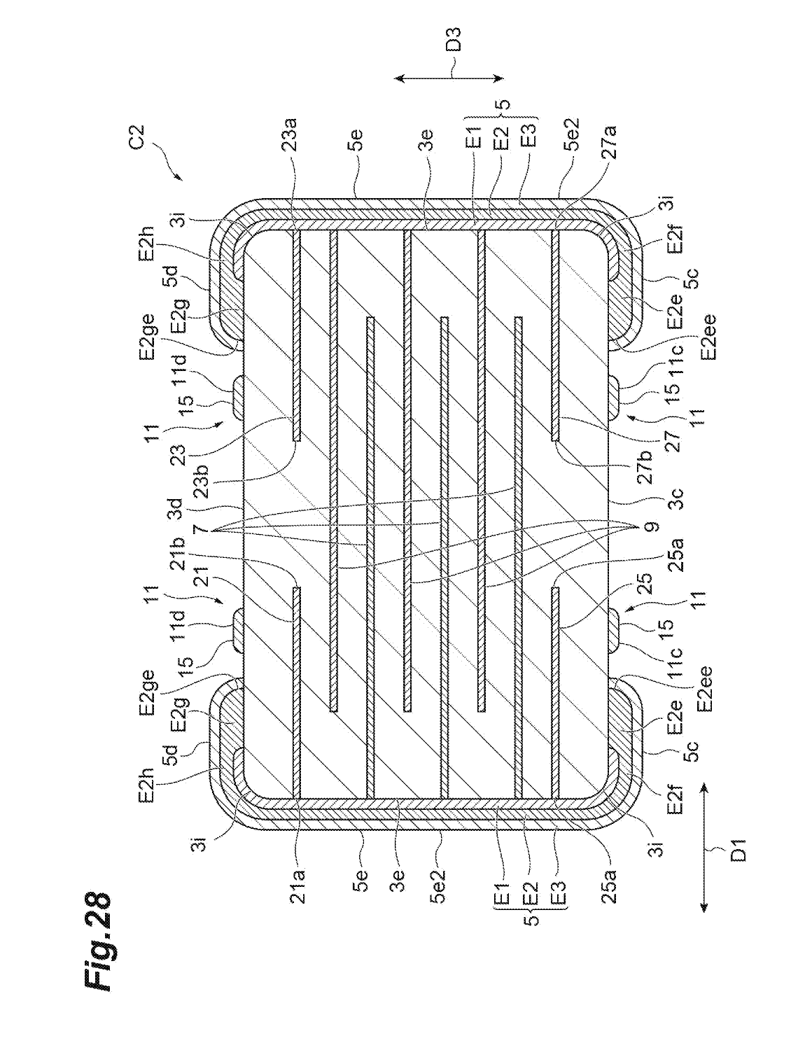

Next, a configuration of a multilayer capacitor C2 according to still another modification example of the second example will be described with reference to FIGS. 28-32. FIGS. 28, 29, 30, 31 and 32 are diagrams illustrating cross-sectional configurations of a multilayer capacitor according to still another modification example of the second example.

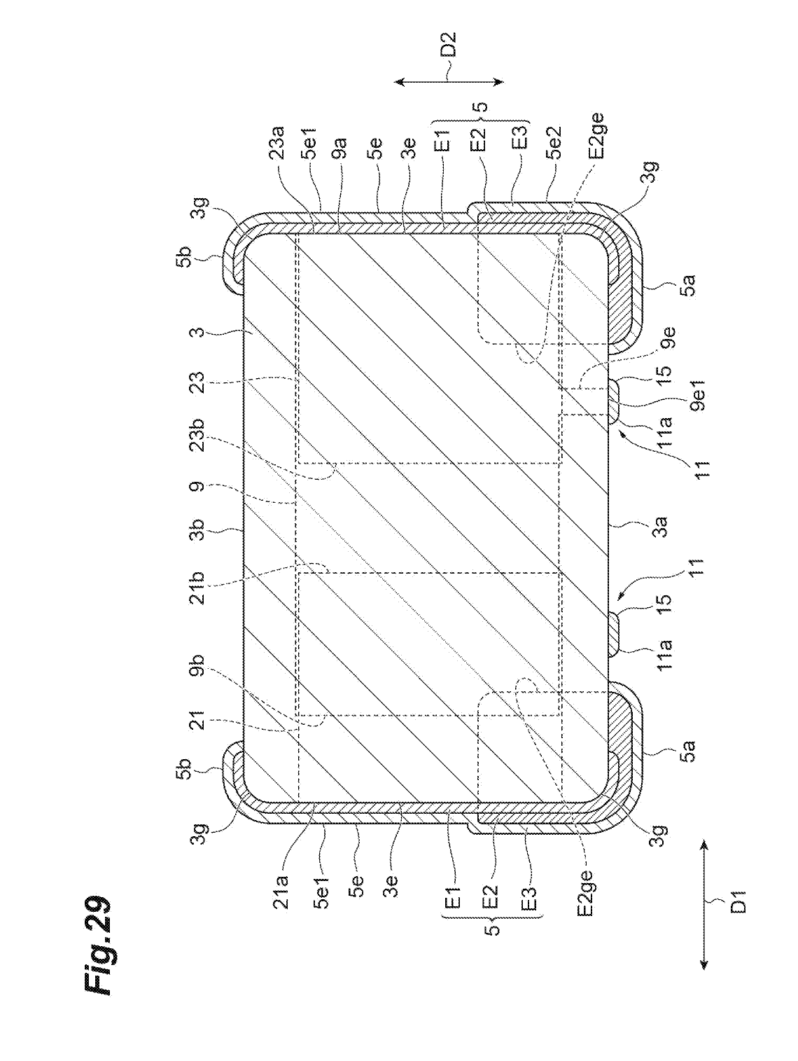

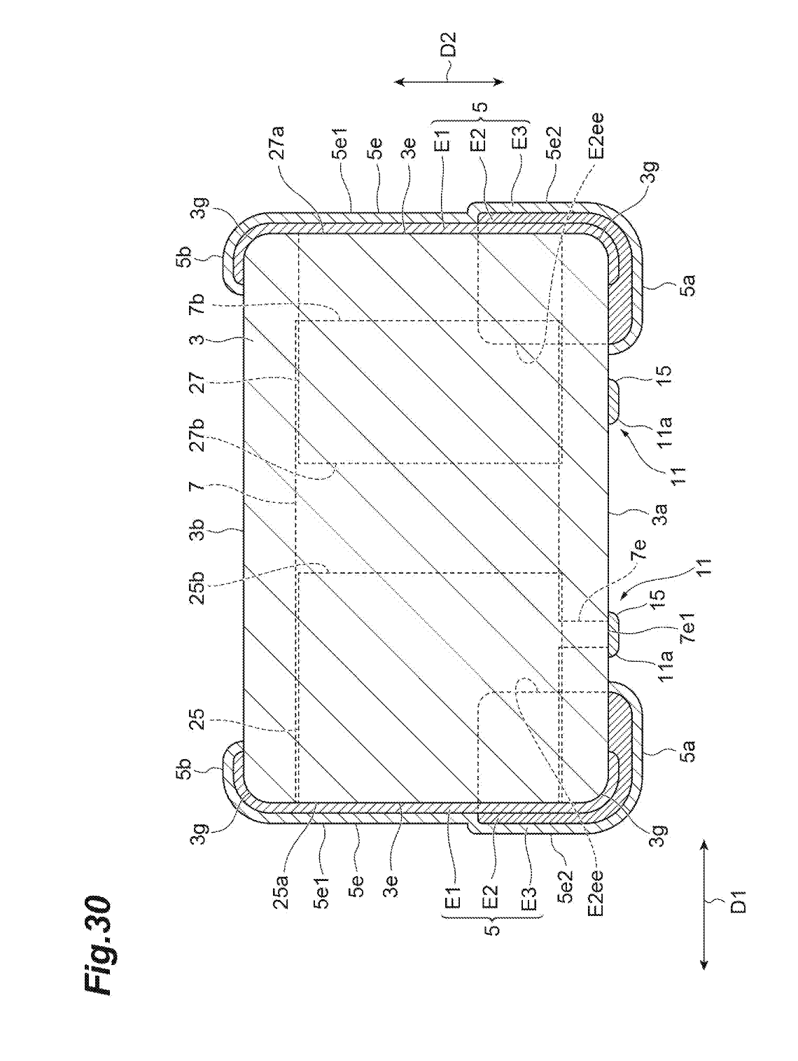

The multilayer capacitor C2 according to the present modification example is generally similar to or the same as the multilayer capacitor C2 according to the other modification example of the second example described above, but the present modification example differs from the other modification example of the second example described above in terms of the configurations of the internal conductors 21, 23, 25, and 27. Hereinafter, differences between the other modification example of the second example described above and the present modification example will be mainly described. In FIGS. 29 and 30, for the purpose of description, the internal electrodes 7 and 9 and the internal conductors 21, 23, 25, and 27 are intentionally shown shifted from one another in the second direction D2.

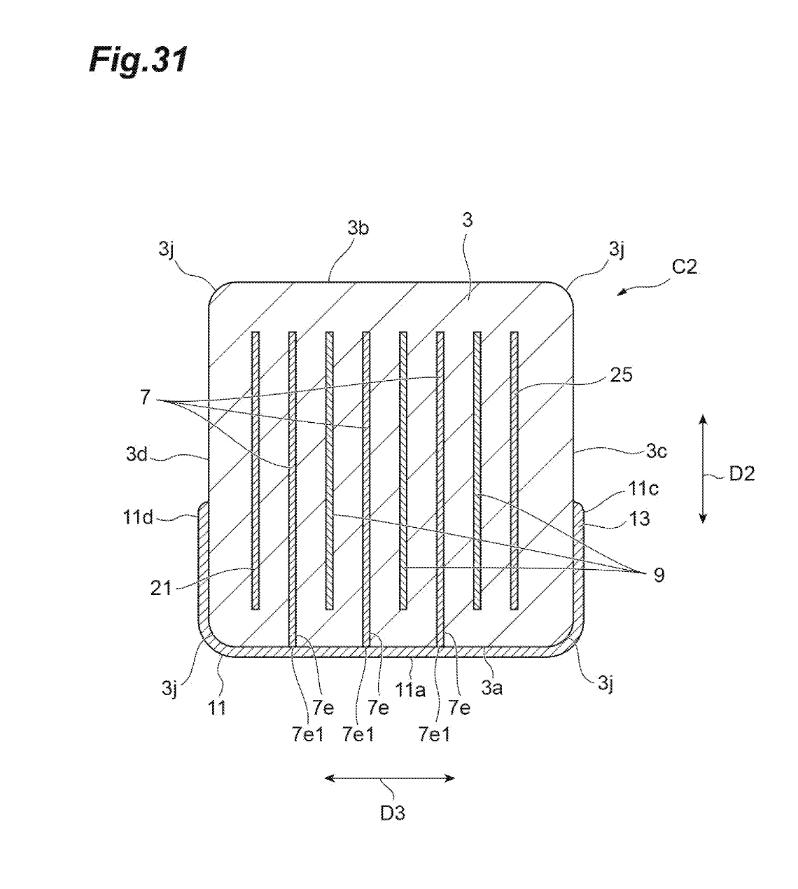

As shown in FIGS. 29 and 31, in the present modification example, the internal conductor 21 does not include the connecting portion 21e. In the present modification example, the internal conductor 21 is not exposed to the main surface 3a. The internal conductor 21 is not directly connected to the portion 11a. That is, in the present modification example, the internal conductor 21 is not physically connected to the external conductor 11.

As shown in FIGS. 28 and 29, in the present modification example, the end 21a of the internal conductor 21 is exposed to an end surface 3e of the pair of end surfaces 3e where the end 9a of the internal electrode 9 closest to the side surface 3d is not exposed. The end 21b of the internal conductor 21 is not exposed to the surface of the element body 3. In the present modification example, the electrode portion 5e entirely covers the end 21a. The electrode portion 5e is directly connected to the internal conductor 21. That is, in the present modification example, the internal conductor 21 is physically and electrically connected to one external electrode 5. The internal conductor 21 is also electrically connected to one external conductor 11 through the one external electrode 5 and the internal electrode 7 connected to the external electrode 5.

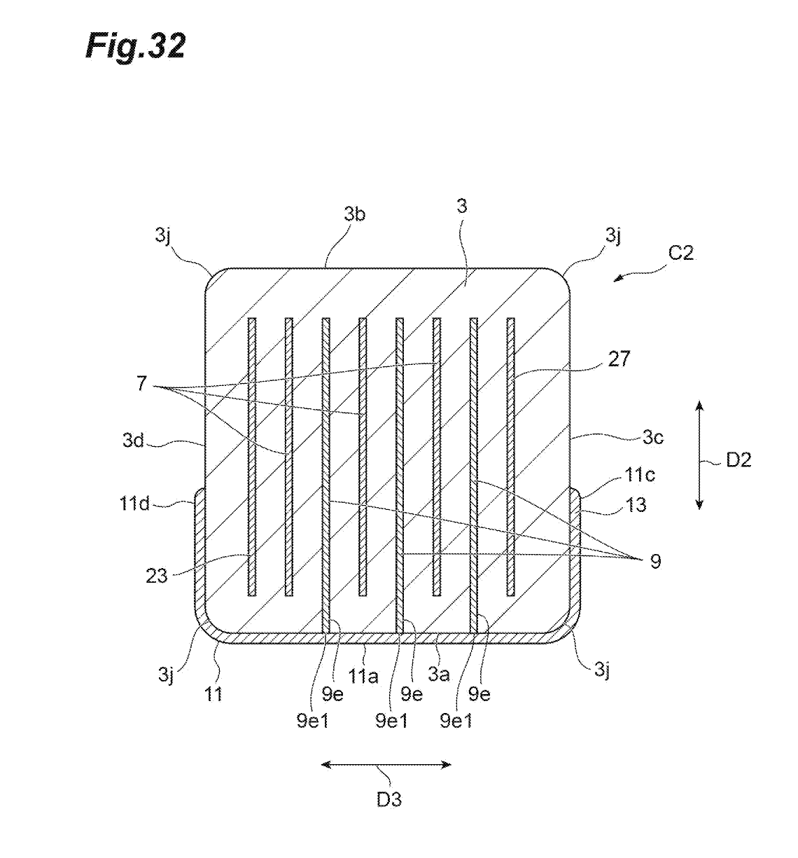

As shown in FIGS. 29 and 32, in the present modification example, the internal conductor 23 does not include the connecting portion 23e. In the present modification example, the internal conductor 23 is not exposed to the main surface 3a. The internal conductor 23 is not directly connected to the portion 11a. That is, in the present modification example, the internal conductor 23 is not physically connected to the external conductor 11.

As shown in FIGS. 28 and 29, the end 23a of the internal conductor 23 is exposed to an end surface 3e of the pair of end surfaces 3e where the end 9a of the internal electrode 9 closest to the side surface 3d is exposed. The end 23b of the internal conductor 23 is not exposed to the surface of the element body 3. The electrode portion 5e entirely covers the end 23a. The electrode portion 5e is directly connected to the internal conductor 23. That is, in the present modification example, the internal conductor 23 is physically and electrically connected to the other external electrode 5. The internal conductor 23 is also electrically connected to the other external conductor 11 through the other external electrode 5 and the internal electrode 9 connected to the external electrode 5.

As shown in FIGS. 30 and 31, in the present modification example, the internal conductor 25 does not include the connecting portion 25e. In the present modification example, the internal conductor 25 is not exposed to the main surface 3a. The internal conductor 25 is not directly connected to the portion 11a. That is, in the present modification example, the internal conductor 25 is not physically connected to the external conductor 11.

As shown in FIGS. 28 and 30, the end 25a of the internal conductor 25 is exposed to an end surface 3e of the pair of end surfaces 3e where the end 7a of the internal electrode 7 closest to the side surface 3c is exposed. The end 25b of the internal conductor 25 is not exposed to the surface of the element body 3. The electrode portion 5e entirely covers the end 25a. The electrode portion 5e is directly connected to the internal conductor 25. That is, in the present modification example, the internal conductor 25 is physically and electrically connected to one external electrode 5. The internal conductor 25 is also electrically connected to one external conductor 11 through the one external electrode 5 and the internal electrode 7 connected to the external electrode 5.

As shown in FIGS. 30 and 32, in the present modification example, the internal conductor 27 does not include the connecting portion 27e. In the present modification example, the internal conductor 27 is not exposed on the main surface 3a. The internal conductor 27 is not directly connected to the portion 11a. That is, in the present modification example, the internal conductor 27 is not physically connected to the external conductor 11.

As shown in FIGS. 28 and 30, the end 27a of the internal conductor 27 is exposed to an end surface 3e of the pair of end surfaces 3e where the end 7a of the internal electrode 7 closest to the side surface 3c is not exposed. The end 27b of the internal conductor 27 is not exposed to the surface of the element body 3. The electrode portion 5e entirely covers the end 27a. The electrode portion 5e is directly connected to the internal conductor 27. That is, in the present modification example, the internal conductor 27 is physically and electrically connected to the other external electrode 5. The internal conductor 27 is also electrically connected to the other external conductor 11 through the other external electrode 5 and the internal electrode 9 connected to the external electrode 5.

In the multilayer capacitor C2 of the present modification example, the internal conductor 21 includes the end 21a that is exposed to one end surface 3e and connected to one external electrode 5.

In the multilayer capacitor C2 according to the present modification example, the internal electrode 9 that is electrically connected to the other external electrode 5 and closest to the side surface 3d, and the second electrode layer E2 of the electrode portion 5d included in one external electrode 5 that is not electrically connected to the internal electrode 9 closest to the side surface 3d tend not to oppose each other in the third direction D3. For the above reasons, the internal conductor 21 further prevents generation of the electric field between the second electrode layer E2 and the internal electrode 9 closest to the side surface 3d that are not electrically connected to each other. As a result, the multilayer capacitor C2 according to the present modification example further controls the proceeding of migration.

In the multilayer capacitor C2 according to the present modification example, the internal conductor 27 includes the end 27a that is exposed to the other end surface 3e and connected to the other external electrode 5.

In the multilayer capacitor C2 according to the present modification example, the internal electrode 7 that is electrically connected to one external electrode 5 and closest to the side surface 3c, and the second electrode layer E2 of the electrode portion 5c included in the other external electrode 5 that is not electrically connected to the internal electrode 7 closest to the side surface 3c tend not to oppose each other in the third direction D3. For the above reasons, the internal conductor 27 further prevents generation of the electric field between the second electrode layer E2 and the internal electrode 7 closest to the side surface 3c that are not electrically connected to each other. As a result, the multilayer capacitor C2 according to the present modification example further controls the proceeding of migration.

Hereinbefore, although the example s and modification examples of the present disclosure have been described, the present disclosure is not necessarily limited to the example s and modification examples described above, and various changes are possible without departing from the spirit of the present disclosure.

In the present examples and modification examples, the internal electrode closest to the main surface 3b or the side surface 3d is the internal electrode 9, but the internal electrode closest to the main surface 3b or the side surface 3d is not limited to the internal electrode 9. That is, the internal electrode closest to the main surface 3b or the side surface 3d may be the internal electrode 7. In a configuration where the internal electrode closest to the main surface 3b or the side surface 3d is the internal electrode 7, the internal conductor 21 is connected to the same external electrode 5 as the adjacent internal electrode 7. Therefore, in this configuration, the internal conductor 21 tend not to contribute to the formation of capacitance.

Even in the configuration in which the internal electrode closest to the main surface 3b is the internal electrode 7, the internal conductor 23 to which the internal electrode 7 is not electrically connected and that is electrically connected to the other external electrode 5 and the other external conductor 11 is disposed between the internal electrode 7 and the main surface 3b. Therefore, the internal electrode 7 closest to the main surface 3b and the second electrode layer E2 of the electrode portion 5b included in the other external electrode 5 are not electrically connected to each other, but tend not to oppose each other in the second direction D2. For the above reasons, even in the configuration in which the internal electrode closest to the main surface 3b is the internal electrode 7, the internal conductor 23 prevents generation of the electric field between the second electrode layer E2 and the internal electrode 7 closest to the main surface 3b that are not electrically connected to each other.

Even in the configuration in which the internal electrode closest to the side surface 3d is the internal electrode 7, the internal conductor 23 to which the internal electrode 7 is not electrically connected and that is electrically connected to the other external electrode 5 and the other external conductor 11 is disposed between the internal electrode 7 and the side surface 3d. Therefore, the internal electrode 7 closest to the side surface 3d and the second electrode layer E2 of the electrode portion 5b included in the other external electrode 5 are not electrically connected to each other, but tend not to oppose each other in the second direction D2. For the above reasons, even in the configuration in which the internal electrode closest to the side surface 3d is the internal electrode 7, the internal conductor 23 prevents generation of the electric field between the second electrode layer E2 and the internal electrode 7 closest to the side surface 3d that are not electrically connected to each other.

In the present examples and modifications example, the internal electrode closest to the main surface 3a or the side surface 3c is the internal electrode 7, but the internal electrode closest to the main surface 3a or the side surface 3c is not limited to the internal electrode 7. That is, the internal electrode closest to the main surface 3a or the side surface 3c may be the internal electrode 9. In a configuration where the internal electrode closest to the main surface 3a or the side surface 3c is the internal electrode 9, the internal conductor 27 is connected to the same external electrode 5 as the adjacent internal electrode 9. Therefore, in this configuration, the internal conductor 27 tends not to contribute to the formation of capacitance.

Even in the configuration in which the internal electrode closest to the main surface 3a is the internal electrode 9, the internal conductor 25 to which the internal electrode 9 is not electrically connected and that is electrically connected to one external electrode 5 and one external conductor 11 is disposed between the internal electrode 9 and the main surface 3a. Therefore, the internal electrode 9 closest to the main surface 3a and the second electrode layer E2 of the electrode portion 5b included in one external electrode 5 are not electrically connected to each other, but tend not to oppose each other in the second direction D2. For the above reasons, even in the configuration in which the internal electrode closest to the main surface 3a is the internal electrode 9, the internal conductor 25 prevents generation of the electric field between the second electrode layer E2 and the internal electrode 9 closest to the main surface 3a that are not electrically connected to each other.

Even in the configuration where the internal electrode closest to the side surface 3c is the internal electrode 9, the internal conductor 25 to which the internal electrode 9 is not electrically connected and that is electrically connected to one external electrode 5 and one external conductor 11 is disposed between the internal electrode 9 and the side surface 3c. Therefore, the internal electrode 9 closest to the side surface 3c and the second electrode layer E2 of the electrode portion 5b included in one external electrode 5 are not electrically connected to each other, but tend not to oppose each other in the second direction D2. For the above reasons, even in the configuration in which the internal electrode closest to the side surface 3c is the internal electrode 9, the internal conductor 25 prevents generation of the electric field between the second electrode layer E2 and the internal electrode 9 closest to the side surface 3c that are not electrically connected to each other.

In the present examples and modification examples, the electronic component includes multilayer capacitor. However, applicable electronic components are not limited to multilayer capacitors. The applicable electronic component includes, for example, multilayer electronic components such as multilayer inductors, multilayer varistors, multilayer piezoelectric actuators, multilayer thermistors, multilayer solid-state battery components, and multilayer composite components, or electronic components other than multilayer electronic components.

What is claimed is:

1. An electronic component comprising:
an element body including a first end surface and a second end surface opposing each other, and a first side surface and a second side surface coupling the first end surface and the second end surface and being adjacent to each other;
a first external electrode and a second external electrode each including an electrode layer in which migration is relatively prone to occur, the first external electrode being disposed on the first end surface, the first side surface, and the second side surface, the second external electrode being disposed on the second end surface, the first side surface, and the second side surface;
a first external conductor and a second external conductor separated from each other on the first side surface in a direction in which the first end surface and the second end surface oppose each other and separated from the first external electrode and the second external electrode, the first external conductor and the second external conductor each including a conductor layer in which migration is less prone to occur than in the electrode layer;
a plurality of internal electrodes disposed in the element body to oppose each other in a direction orthogonal to the second side surface and each including an end exposed on a corresponding end surface of the first end surface and the second end surface, the plurality of internal electrodes being each connected to a corresponding external electrode of the first external electrode and the second external electrode at the end included in each of the plurality of internal electrodes; and
a first internal conductor and a second internal conductor disposed in the element body between the second side surface and an internal electrode that is closest to the second side surface among the plurality of internal electrodes, and are separated from each other in the direction in which the first end surface and the second end surface oppose each other,
wherein the first external conductor is located between the first external electrode and the second external conductor and is electrically connected to the first external electrode,
the second external conductor is located between the second external electrode and the first external conductor and is electrically connected to the second external electrode,
the first internal conductor is located closer to the first end surface than the second internal conductor and is electrically connected to the first external electrode and the first external conductor, and
the second internal conductor is located closer to the second end surface than the first internal conductor and is electrically connected to the second external electrode and the second external conductor.

2. The electronic component according to claim 1, wherein
an internal electrode that is connected to the first external electrode among the plurality of internal electrodes includes an end that is exposed to the first side surface and connected to the first external conductor,
an internal electrode that is connected to the second external electrode among the plurality of internal electrodes includes an end that is exposed to the first side surface and connected to the second external conductor,
the first internal conductor includes an end that is exposed to the first end surface and connected to the first external electrode, and
the second internal conductor includes an end that is exposed to the second end surface and connected to the second external electrode.

3. The electronic component according to claim 1, wherein
an internal electrode that is connected to the first external electrode among the plurality of internal electrodes includes an end that is exposed to the first side surface and connected to the first external conductor,
an internal electrode that is connected to the second external electrode among the plurality of internal electrodes includes an end that is exposed to the first side surface and connected to the second external conductor,
the first internal conductor includes an end that is exposed to the first side surface and connected to the first external conductor, and
the second internal conductor includes an end that is exposed to the first side surface and connected to the second external conductor.

4. The electronic component according to claim 1, wherein
the electrode layer includes a layer portion located on the second side surface, and
when viewed from the direction orthogonal to the second side surface, an internal conductor of the first internal conductor and the second internal conductor that is not electrically connected to the internal electrode closest to the second side surface overlaps an end of the layer portion of an external electrode of the first external electrode and the second external electrode that is not electrically connected to the internal electrode closest to the second side surface, and an end of the internal electrode closest to the second side surface.

5. The electronic component according to claim 1, wherein
an electrode layer of the first external electrode is disposed on a part of the first end surface and on a part of each of the first side surface and the second side surface,
an electrode layer of the second external electrode is disposed on a part of the second end surface and on a part of each of the first side surface and the second side surface, and
the second side surface includes a mounting surface.

6. The electronic component according to claim 1, wherein
an electrode layer of the first external electrode is disposed on a part of the first end surface and on a part of each of the first side surface and the second side surface,
an electrode layer of the second external electrode is disposed on a part of the second end surface and on a part of each of the first side surface and the second side surface, and
the first side surface includes a mounting surface.

7. The electronic component according to claim 1, wherein
the element body further includes a third side surface opposing the first side surface and a fourth side surface opposing the second side surface,
each of the first external electrode and the second external electrode is disposed on the third side surface and the fourth side surface as well,
the electronic component further includes
a third external conductor and a fourth external conductor separated from each other on the third side surface in the direction in which the first end surface and the second end surface oppose each other and separated from the first external electrode and the second external electrode, the third external conductor and a fourth external conductor each including a conductor layer in which migration is less prone to occur than in the electrode layer, and
a third internal conductor and a fourth internal conductor that are disposed in the element body between the fourth side surface and an internal electrode that is closest to the fourth side surface among the plurality of internal electrodes, and are separated from each other in the direction in which the first end surface and the second end surface oppose each other,
the third external conductor is separated from the first external conductor on the second side surface and the fourth side surface, is located between the first external electrode and the fourth external conductor, and is electrically connected to the first external electrode,
the fourth external conductor is separated from the second external conductor on the second side surface and the fourth side surface, is located between the second external electrode and the third external conductor, and is electrically connected to the second external electrode,
the third internal conductor is located closer to the first end surface than the fourth internal conductor and is electrically connected to the first external electrode and the third external conductor, and
the fourth internal conductor is located closer to the second end surface than the third internal conductor and is electrically connected to the second external electrode and the fourth external conductor.

8. The electronic component according to claim 7, wherein
an internal electrode that is connected to the first external electrode among the plurality of internal electrodes includes an end that is exposed to the first side surface and connected to the first external conductor, and an end that is exposed to the third side surface and connected to the third external conductor,
an internal electrode that is connected to the second external electrode among the plurality of internal electrodes includes an end that is exposed to the first side surface and connected to the second external conductor, and an end that is exposed to the third side surface and connected to the fourth external conductor,
each of the first internal conductor and the third internal conductor includes an end that is exposed to the first end surface and connected to the first external electrode, and
each of the second internal conductor and the fourth internal conductor includes an end that is exposed to the second end surface and connected to the second external electrode.

9. The electronic component according to claim 7, wherein
an internal electrode that is connected to the first external electrode among the plurality of internal electrodes includes an end that is exposed to the first side surface and connected to the first external conductor, and an end that is exposed to the third side surface and connected to the third external conductor,
an internal electrode that is connected to the second external electrode among the plurality of internal electrodes includes an end that is exposed to the first side surface and connected to the second external conductor, and an end that is exposed to the third side surface and connected to the fourth external conductor,
each of the first internal conductor and the third internal conductor includes an end that is exposed to the first side surface and connected to the first external conductor, and an end that is exposed to the third side surface and connected to the third external conductor, and
each of the second internal conductor and the fourth internal conductor includes an end that is exposed to the first side surface and connected to the second external conductor, and an end that is exposed to the third side surface and connected to the fourth external conductor.

10. The electronic component according to claim 7, wherein
the electrode layer includes a first layer portion located on the second side surface and a second layer portion located on the fourth side surface,
when viewed from the direction orthogonal to the second side surface, an internal conductor of the first internal conductor and the second internal conductor that is not electrically connected to the internal electrode closest to the second side surface overlaps an end of the first layer portion of an external electrode of the first external electrode and the second external electrode that is not electrically connected to the internal electrode closest to the second side surface, and an end of the internal electrode closest to the second side surface, and
when viewed from the direction orthogonal to the fourth side surface, an internal conductor of the third internal conductor and the fourth internal conductor that is not electrically connected to the internal electrode closest to the fourth side surface overlaps an end of the second layer portion of an external electrode of the first external electrode and the second external electrode that is not electrically connected to the internal electrode closest to the fourth side surface, and an end of the internal electrode closest to the fourth side surface.

11. The electronic component according to claim 1, wherein
the electrode layer includes a conductive resin layer including a plurality of silver particles, and
the conductor layer includes a metal layer in which migration is less prone to occur than in silver.
